(19) United States
(12) Patent Application Publication
(10) Pub. No.: US 2008/0038453 A1
(43) Pub. Date: Feb. 14, 2008

(54) Method for modifying surface of plastic member, method for forming metal film, and method for producing plastic member

(75) Inventors: Atsushi Yusa, Ibaraki-shi (JP); Yoshiyuki Nomura, Ibaraki-shi (JP)

Correspondence Address: OLIFF & BERRIDGE, PLC, P.O. BOX 320850, ALEXANDRIA, VA, 22320-4850, US

(73) Assignee: HITACHI MAXELL, LTD., IBARAKI-SHI (JP)

(21) Appl. No.: 11/882,835

(22) Filed: Aug. 6, 2007

(30) Foreign Application Priority Data
Aug. 14, 2006 (JP) 2006-220998
Jul. 6, 2007 (JP) 2007-178936

(51) Int. Cl. B05D 3/12

(52) U.S. Cl. 427/155; 427/322; 427/399; 427/401

(57) ABSTRACT

A surface modification method is provided, which includes permeating a permeative substance into a surface of a plastic member by using a pressurized fluid, and dissolving the permeative substance with a solvent to remove the permeative substance from the surface of the plastic member. Accordingly, the surface modification method for modifying the surface of the plastic member is provided, which uses the pressurized fluid and which makes it possible to form a metal film having a satisfactory surface roughness and having a high adhesion force.

### BACKGROUND OF THE INVENTION

1. Field of the Invention

The present invention relates to a method for modifying a surface of a plastic member using a pressurized fluid, a method for forming a metal film, and a method for producing a plastic member.

2. Description of the Related Art

At present, the electroless plating method is widely utilized as a means for forming a metal conductive film on a surface of a part of an electronic device or the like constructed of a plastic molded article. The process, which ranges from the molding to the electroless plating to be applied to the plastic molded article, differs to some extent depending on, for example, the material of the molded article. However, in general, the process includes steps of molding a resin, degreasing the molded article, performing the etching, performing the neutralization and wetting, applying a catalyst, activating the catalyst, and performing the electroless plating. The steps are performed in this order.

In the etching to be performed in the conventional electroless plating process as described above, a surface of the plastic molded article is physically roughened by using, for example, a chromic acid solution or an alkali metal hydroxide solution. The adhesion performance is secured between the molded article and the plating film by the anchoring effect on the roughened plastic surface. However, such an etching solution requires the aftertreatment such as the neutralization, thus becoming a factor for increasing the cost. Further, the etching solution is highly toxic. Therefore, a problem arises such that the handling thereof is complicated.

An electroless plating method for a plastic member (polymer member), which uses carbon dioxide in the supercritical state (hereinafter referred to as “supercritical carbon dioxide” as well), has been hitherto suggested, for example, in “Latest Application Technique for Supercritical Fluid” (written by Teruo HORI, NTS Publication, pp. 250-255 (2004)) as a method for forming a metal film on a surface of the plastic member, other than those based on the conventional electroless plating method. According to the method described in “Latest Application Technique for Supercritical Fluid”, an organic metal complex is injected (permeated or impregnated) into the surface of the plastic member by dissolving the organic metal complex in the supercritical carbon dioxide and bringing the supercritical carbon dioxide into contact with various types of polymer members. Subsequently, metallic fine particles are deposited on the surface of the polymer member by reducing the organic metal complex by performing, for example, the heating treatment and/or the chemical reducing treatment for the polymer member which is impregnated with the organic metal complex. Accordingly, the entire surface of the polymer member can be subjected to the electroless plating. According to this process, it is approved that the electroless plating process can be realized for the resin, in which it is unnecessary to perform any treatment for the waste liquid, and the surface roughness is satisfactory.

For example, a plating pretreatment process, which uses a photocatalyst, is suggested in Japanese Patent Application Laid-open No. 2005-85900 as a process for suppressing the surface roughening of a plastic member and obtaining a satisfactory anchoring effect. In Japanese Patent Application Laid-open No. 2005-85900, titanium oxide is used as the photocatalyst with which the surface of the plastic member is coated to perform the ultraviolet radiation so that fine irregularities (projections and recesses, concave and convex portions) are formed on the surface of the plastic member. Subsequently, a plating film is formed on the formed irregularity surface.

For example, Japanese Patent Application Laid-open No. 2001-215701 suggests a method for providing a porous resin composition by using the supercritical carbon dioxide. In Japanese Patent Application Laid-open No. 2001-215701, a porous polyamic acid resin is formed by removing a dispersible compound from a polyamic acid resin as a precursor for polyimide and a photosensitive resin composition containing the dispersible compound which is dispersible therein. In Japanese Patent Application Laid-open No. 2001-215701, a conductive layer is formed on the porous polyamic acid resin. However, in Japanese Patent Application Laid-open No. 2001-215701, the resin material is limited to the polyimide resin. In addition, Japanese Patent Application Laid-open No. 2001-215701 does not disclose any physical shape on the outermost surface of the resin, and there is no description about the adhesion performance between the resin and the conductive layer.

### SUMMARY OF THE INVENTION

As a result of diligent investigations performed by the inventors, of the present invention, about the surface modification process using the supercritical carbon dioxide as described in “Latest Application Technique for Supercritical Fluid” described above, it has been revealed that the following problem arises. Any process for physically roughening the surface of the plastic member is not performed in the surface modification process using the supercritical carbon dioxide. Therefore, the smoothness of the surface is satisfactory, but the anchoring effect is not obtained at the interface between the plating film and the plastic member. When the plating film is formed on the surface of the plastic member in accordance with the method of “Latest Application Technique for Supercritical Fluid”, the adhesion performance is secured for the plating film by the impregnated organic metal complex. Therefore, the adhesion performance of the plating film is affected, for example, by the reducibility of the organic metal complex and the density and the coagulation state of the metallic fine particles on the surface of the plastic member resulting therefrom. It has been revealed that it is difficult to control all of the conditions by the method of “Latest Application Technique for Supercritical Fluid”.

On the other hand, when the photocatalyst process, which uses titanium oxide as described in Japanese Patent Application Laid-open No. 2001-215701, is used in order to roughen the surface of the plastic member, it is necessary that the ultraviolet light is radiated onto the surface of the plastic member to cause the photocatalytic reaction. Therefore, it is considered that this process can be applied to the molded article having the two-dimensional shape (for example, film-like form). However, it is considered that it is difficult to uniformly radiate the ultraviolet light to the surface of the molded article having a complicated three-dimensional shape. The reaction time of the photocatalyst is also long, i.e., about several tens of minutes. Therefore, it is feared that the long reaction time may cause any problem when the process is industrially applied.

The present invention has been made in order to solve the problems as described above. An object of the present invention is to provide a method for modifying a surface of a plastic member which makes it possible to form a metal film having a satisfactory surface roughness and having a high adhesion force, a method for forming a metal film, and a method for producing a plastic member.

As described above, the electroless plating method has been hitherto known as a method for inexpensively forming a metal film on a surface of the plastic member (polymer member). However, in the case of this method, it is necessary that the surface of the polymer member is roughened by the etching, for example, with chromic acid. The polymer, which is roughened with such an etching solution, is limited to certain resins including, for example, ABS. In order that the electroless plating can be applied to other materials including, for example, polycarbonate which are hardly roughed with the etching solution as described above, resin materials of the plating grade, which are mixed with ABS and/or elastomer, are commercially available. However, such resin materials of the plating grade do not sufficiently satisfy the requirements for the heat resistance and the reflection performance.

In view of the above, another object of the present invention is to provide a method for modifying a surface of a plastic member and a method for forming a metal film which make it possible to form a plating film having a high adhesion force and having a satisfactory surface roughness with respect to various types of plastics. Still another object of the present invention is to provide a plastic member in which fine irregularities are formed on a surface thereof and the surface roughness is satisfactory with respect to various types of plastics.

According to a first aspect of the present invention, there is provided a surface modification method for modifying a surface of a plastic member, comprising: permeating a permeative substance into the surface of the plastic member by using a pressurized fluid; and bringing a solvent into contact with the plastic member so that the permeative substance is dissolved in the solvent to remove the permeative substance from the surface of the plastic member.

In the surface modification method of the present invention, at first, the permeative substance is permeated into the surface of the plastic member by using the pressurized fluid (Step S1 shown in FIG. 22). For example, the surface of the plastic member is swelled, for example, by bringing the pressurized fluid in which the permeative substance is dissolved into contact with the surface of the plastic member. The permeative substance is permeated into the surface of the plastic member together with the pressurized fluid. After that, for example, the plastic member is washed or cleaned with the solvent in which the permeative substance is dissolvable, and thus the permeative substance is removed from the surface of the plastic member (Step S2 shown in FIG. 22). The permeative substance is permeated into the vicinity of the surface of the plastic member in a cluster form of several tens to several hundreds of nm. Therefore, fine or minute pores of an order of submicron to nanometer are formed on the surface of the plastic member from which the permeative substance has been removed, by the removing treatment (washing treatment) with the solvent. That is, it is possible to form fine irregularities (concave and convex portions) of the order of submicron to nanometer on the surface of the plastic member. When the surface modification method of the present invention is used, fine irregularities can be formed on the surfaces of various types of plastic members.

The term “pressurized fluid” referred to in this specification means a fluid which is pressurized. However, it is enough that the pressure of the pressurized fluid is such a pressure that the permeative substance is sufficiently dissolved. The “pressurized fluid” referred to herein includes not only a fluid which is pressurized to not less than the critical point (supercritical state) but also a fluid which is pressurized at a pressure lower than the critical point. The “pressurized fluid” preferably refers to a fluid which is pressurized to not less than 5 MPa. That is, the “pressurized fluid” referred to in this specification has the meaning to include not only the supercritical fluid but also the pressurized liquid fluid (liquid) and the pressurized inert gas.

When the metal film is formed, for example, by the electroless plating on the surface of the plastic member obtained by the surface modification method of the present invention, the metal film, which is excellent in the adhesion performance, can be formed, for example, owing to the scale merit brought about by the expansion of the surface area and the anchoring effect brought about by the fine irregularities formed on the surface of the plastic member. The irregularities, which are formed on the surface of the plastic member by the surface modification method of the present invention, have the size of the order of submicron to nanometer as described above. Therefore, when the metal film is formed on the surface of the plastic member obtained by the surface modification method of the present invention, it is possible to form the metal film which is extremely excellent in the smoothness (surface roughening is suppressed). It is possible to form the metal film which is excellent in the electric characteristic. When the ratio of the content of the fine pores formed at the surface of the plastic member is adjusted, it is also possible to control the electric characteristic of the plastic member including, for example, the dielectric constant and the dielectric loss tangent and the optical characteristic including, for example, the realization of the low refractive index.

In the surface modification method of the present invention, the permeation of the permeative substance into the surface of the plastic member by using the pressurized fluid may include dissolving the permeative substance in the pressurized fluid; and bringing the pressurized fluid in which the permeative substance is dissolved into contact with the plastic member to permeate the permeative substance into the surface of the plastic member.

In the surface modification method of the present invention, the permeation of the permeative substance into the surface of the plastic member by using the pressurized fluid may include coating, on the surface of the plastic member, a solution in which the permeative substance is dissolved; and bringing the pressurized fluid into contact with the plastic member, on which the permeative substance is coated, to permeate the permeative substance into the surface of the plastic member.

In the surface modification method of the present invention, the plastic member may have a recess; and when the permeative substance is permeated into the surface of the plastic member, the pressurized fluid may be made to remain in the recess by closing an opening defined on the surface of the plastic member by the recess in a state in which the pressurized fluid is brought into contact with the plastic member to permeate the permeative substance into a surface defining the recess of the plastic member.

According to the surface modification method for the plastic member having the recess on the surface, the fine irregularities can be formed on the surface which defines the recess of the plastic member, and it is possible to selectively change the physical shape of the surface which defines the recess. Therefore, when the metal film is formed, for example, by the electroless plating on the plastic member produced by the surface modification method, the anchoring effect of the nanometer order can be selectively obtained on only the surface defining the recess of the plastic member. The metal film, which is excellent in the adhesion performance and the smoothness, can be formed on only the surface defining the recess.

In the surface modification method of the present invention, the surface modification method may be a surface modification method using an injection molding machine provided with a mold and a heating cylinder which injects a melted resin of the plastic member into the mold, and the permeation of the permeative substance into the surface of the plastic member by using the pressurized fluid may include introducing the pressurized fluid in which the permeative substance is dissolved into a flow front portion of the melted resin in the heating cylinder, and injecting and charging the melted resin into a cavity of the mold.

In the surface modification method using the injection molding machine, the pressurized fluid, in which the permeative substance is dissolved, is introduced into the flow front portion of the melted resin in the heating cylinder. Therefore, when the melted resin in the heating cylinder is injected into the mold, then the melted resin at the flow front portion, into which the permeative substance is permeated, is firstly injected, and then the melted resin, in which the permeative substance is not permeated substantially, is injected and charged into the mold. When the melted resin at the flow front portion, in which the permeative substance is permeated, is injected, the melted resin at the flow front portion makes contact with the mold to form the surface layer (skin layer) while being pulled by the mold surface in accordance with the fountain flow phenomenon (fountain effect) of the flowing resin in the mold. Therefore, when the surface modification method is used, it is possible to obtain the plastic molded article constructed of the skin layer in which the permeative substance is dispersed and the core layer in which the permeative substance is scarcely dispersed. In the case of the surface modification method using the injection molding machine as described above, it is possible to simultaneously perform the molding step and the surface modification step. Therefore, when this method is used, the permeative substance can be uniformly or homogeneously dispersed and arranged in only the surfaces of various types of plastic molded articles, provided that the permeative substance has a solubility in the pressurized fluid to some extent. That is, the surface modification method using the injection molding machine is applicable to the surface modification techniques for various types of plastic members.

In the surface modification method of the present invention, a concave/convex pattern may be formed on a surface, of the mold, on a side of the cavity; the melted resin may be injected and charged into the cavity of the mold to form the plastic member which has a recess on the surface and in which the permeative substance is permeated into a surface of the recess; and when the permeative substance is dissolved in the solvent to remove the permeative substance from the surface of the plastic member, the solvent may be brought into contact with only the surface of the recess to remove the permeative substance which is permeated into the recess.

In the surface modification method of the present invention, the surface modification method may be a surface modification method using an extrusion molding machine; and the permeation of the permeative substance into the surface of the plastic member by using the pressurized fluid may include bringing the pressurized fluid in which the permeative substance is dissolved into contact with a melted resin of the plastic member in the extrusion molding machine to permeate the permeative substance into the melted resin, and extrusion-molding the melted resin.

Also in the surface modification method using the extrusion molding machine as described above, the pressurized fluid, in which the permeative substance is dissolved, is injected into the melted resin in the extrusion molding machine. Therefore, the modification treatment is performed simultaneously with the molding step. Accordingly, it is possible to modify the surfaces of various types of plastic members. Therefore, the surface modification method, which uses the extrusion molding machine, is also applicable to the surface modification techniques for various types of plastic members. When the surface modification method, which uses the extrusion molding machine as described above, is used, it is also possible to continuously produce a film-like plastic molded article subjected to the surface modification. An injection position or place, at which the permeative substance is injected in the extrusion molding machine, may be provided at any arbitrary position, provided that the position is disposed within an area ranging from the heating cylinder to the extrusion die.

In the surface modification method of the present invention, the pressurized fluid may have a pressure in a range of 5 to 25 MPa. The solubility of the permeative substance in the pressurized fluid is increased as the pressure is increased. If the pressure is not more than 5 MPa, then the solubility of the permeative substance is extremely lowered, and the permeation effect of the permeative substance to be permeated into the surface of the plastic member does not appear. If the pressure is high, i.e., not less than 25 MPa, then the permeability of the pressurized fluid with respect to the plastic member is raised, and it is feared that the foaming of the plastic member might be hardly controlled.

In the surface modification method of the present invention, the pressurized fluid may be carbon dioxide. When carbon dioxide is used as the pressurized fluid in the surface modification method of the present invention, supercritical carbon dioxide, subcritical carbon dioxide, liquid carbon dioxide, or gas carbon dioxide may be used as the pressurized fluid. However, the present invention is not limited thereto. Any pressurized fluid may be used provided that the pressurized fluid is a medium in which the permeative substance is dissolved to some extent. For example, air, water, butane, pentane, and methanol may be used as the pressurized fluid. Especially preferred pressurized fluid for dissolving the permeative substance is supercritical carbon dioxide which has the solubility with respect to the organic material equivalent to that of hexane, which causes no environmental pollution, and which has the high affinity for the plastic member. A small amount of organic solvent such as ethanol may be mixed as an entrainer in order to improve the solubility of the permeative substance with respect to the pressurized fluid.

In the surface modification method of the present invention, the plastic member may be formed of one of a thermoplastic resin, a thermosetting resin, and a photo-curable resin. As described above, the surface modification method of the present invention is applicable to various types of plastic members. Those usable as the thermoplastic resin may include, for example, polycarbonate, polymethyl methacrylate, polyetherimide, polymethylpentene, amorphous polyolefin, polytetrafluoroethylene, liquid crystal polymer, styrene-based resin, polymethylpentene, polyacetal, and cycloolefin polymer. Those usable as the thermosetting resin and the photo-curable resin may include, for example, epoxy rein, phenol resin, acrylic resin, silicon resin, polyimide resin, and urethane resin. Those usable as the plastic member may include those obtained by mixing a plurality of materials as described above, polymer alloys containing them as main components, and those obtained by blending various fillers thereto.

In the surface modification method of the present invention, the permeative substance may be a water-soluble polymer or a water-soluble monomer. Specifically, polyalkyl glycol may be used as the permeative substance. More preferably, polyethylene glycol may be used. However, the present invention is not limited thereto. Any arbitrary material, which is water-soluble and which exhibits the solubility to some extent with respect to the pressurized fluid, may be used as the permeative substance. For example, it is also allowable to use polypropylene glycol, polybutylene glycol, polyvinyl alcohol, polyvinylpyrrolidone, ε-caprolactam, and polyol ester. It is also allowable to use, as the permeative substance, surfactants including, for example, block copolymer of polyethylene oxide-polypropylene oxide and glycerol fatty acid ester.

In the surface modification method of the present invention, the permeative substance may have a molecular weight in a range of 50 to 2,000. If a material having a molecular weight of not less than 2,000 is used, then the solubility in the pressurized fluid is lowered, and the permeation effect of the permeative substance into the surface of the plastic member is lowered. If the material having a molecular weight of not less than 2,000 is used as the permeative substance, there is such a tendency that the flatness of the plastic member surface tends to be deteriorated. In particular, any stress arises when the permeative substance is extracted (removed) from the plastic member, and cracks tend to appear on the surface of the plastic member. Other than the above, when the compatibility with the plastic resin is taken into consideration, the range of the molecular weight of the permeative substance is desirably the range described above.

In the surface modification method of the present invention, the permeative substance may include a first permeative substance and a second permeative substance, and the first permeative substance may be removed when the permeative substance is removed from the surface of the plastic member.

According to a second aspect of the present invention, there is provided a method for forming a metal film on a surface of a plastic member, comprising: preparing a plastic member in which a permeative substance is impregnated into a surface thereof; bringing a solvent into contact with the plastic member so that the permeative substance is dissolved in the solvent to remove the permeative substance from the surface of the plastic member; and forming the metal film on the surface of the plastic member from which the permeative substance is removed.

In the method for forming the metal film of the present invention, the surface of the plastic member is modified by the surface modification method of the present invention as described above (Steps S1′ and S2′ shown in FIG. 23), and then the metal film is formed, for example, by the electroless plating on the surface of the plastic member (Step S3 shown in FIG. 23). Therefore, the metal film, which is excellent in the smoothness and the adhesion performance, can be formed, for example, owing to the scale merit brought about by the expansion of the surface area and the anchoring effect brought about by the fine irregularities of the order of submicron to nanometer formed on the surface of the plastic member. As described above, when the surface modification method of the present invention is used, the fine irregularities can be formed on the surfaces of various types of plastic members. Therefore, the metal film, which is excellent in the smoothness and the adhesion performance, can be formed on the surfaces of various types of plastic members by the method for forming the metal film of the present invention.

In the method for forming the metal film of the present invention, the formation of the metal film on the surface of the plastic member from which the permeative substance is removed may include applying plating catalyst cores to the surface of the plastic member from which the permeative substance is removed; and forming, by an electroless plating method, the metal film on the surface of the plastic member to which the plating catalyst cores are applied.

In the method for forming the metal film of the present invention, the preparation of the plastic member in which the permeative substance is impregnated into the surface thereof may include dissolving the permeative substance in a pressurized fluid; and bringing the pressurized fluid into contact with the plastic member to permeate the permeative substance into the surface of the plastic member.

In the method for forming the metal film of the present invention, the preparation of the plastic member in which the permeative substance is impregnated into the surface thereof may include coating, on the surface of the plastic member, a solution in which the permeative substance is dissolved; and bringing a pressurized fluid into contact with the plastic member, on which the permeative substance is coated, to permeate the permeative substance into the surface of the plastic member.

In the method for forming the metal film of the present invention, the plastic member may have a recess, and the pressurized fluid is made to remain in the recess by closing an opening defined on the surface of the plastic member by the recess in a state in which the pressurized fluid is brought into contact with the plastic member when the permeative substance is permeated into the surface of the plastic member so that the permeative substance is permeated into the surface which defines the recess of the plastic member.

In the method for forming the metal film of the present invention, the method for forming the metal film may be a method for forming the metal film using an injection molding machine provided with a mold and a heating cylinder which injects a melted resin of the plastic member into the mold; and the preparation of the plastic member in which the permeative substance is impregnated into the surface thereof may include bringing the pressurized fluid in which the permeative substance is dissolved into contact with a flow front portion of a melted resin in the injection molding machine to permeate the permeative substance into the melted resin, and injecting and charging the melted resin into the mold to mold the resin.

In the method for forming the metal film of the present invention, a concave/convex pattern may be formed on a surface, of the mold, on a side of a cavity of the mold; the melted resin may be injected and charged into the cavity of the mold to form the plastic member which has a recess on the surface and in which the permeative substance is permeated into a surface of the recess; and when the permeative substance is dissolved in the solvent to remove the permeative substance from the surface of the plastic member, the solvent may be brought into contact with only the surface of the recess to remove the permeative substance which is permeated into the recess.

In the method for forming the metal film of the present invention, the method for forming the metal film may be a method for forming the metal film using an extrusion molding machine; and the preparation of the plastic member in which the permeative substance is impregnated into the surface thereof may include bringing the pressurized fluid in which the permeative substance is dissolved into contact with a melted resin of the plastic member in the extrusion molding machine to permeate the permeative substance into the melted resin, and extrusion-molding the melted resin.

In the method for forming the metal film of the present invention, the pressurized fluid may have a pressure in a range of 5 to 25 MPa. Further, in the method for forming the metal film of the present invention, the pressurized fluid may be carbon dioxide.

In the method for forming the metal film of the present invention, the plastic member, in which the permeative substance is impregnated into the surface thereof, may be manufactured by using an injection molding machine provided with a mold; and the preparation of the plastic member in which the permeative substance is impregnated into the surface thereof may include preparing a plastic sheet in which the permeative substance is impregnated into a surface thereof, holding the plastic sheet in the mold of the injection molding machine, and injecting and charging a melted resin in the injection molding machine into the mold, in which the plastic sheet is held or retained, to mold the plastic member. That is, in the method for forming the metal film of the present invention, the plastic member, in which the permeative substance is impregnated into the surface thereof, may be prepared by the insert molding.

In the method for forming the metal film using the insert molding, the insert molding is performed by using the plastic sheet, in which the permeative substance is permeated into the surface thereof, obtained by the surface modification method of the present invention to mold a plastic molded article in which the plastic sheet and the plastic base material injected during the insert molding are integrated into one body. In this method, the permeation amount and the permeation depth of the permeative substance of the plastic molded article after the insert molding can be controlled by controlling, for example, the film thickness of the plastic sheet in which the permeative substance is impregnated.

In the method for forming the metal film of the present invention, the plastic sheet may be manufactured by using an extrusion molding machine; and the preparation of the plastic sheet in which the permeative substance is impregnated into the surface thereof may include bringing a pressurized fluid in which the permeative substance is dissolved into contact with a melted resin in the extrusion molding machine to permeate the permeative substance into the melted resin, and extrusion-molding the melted resin to mold the plastic sheet.

In the method for forming the metal film of the present invention, the preparation of the plastic sheet in which the permeative substance is impregnated into the surface thereof may include preparing a plastic film; preparing a mixture solution containing the permeative substance and a plastic resin; and coating the mixture solution on the plastic film to form, on the plastic film, a resin film in which the permeative substance is dispersed. When the plastic sheet is manufactured by using this method, then the layer (film), in which the permeative substance is dispersed, can be made thinner, and it is easier to adjust, for example, the distribution and the permeation amount of the permeative substance. Therefore, it is possible to stably produce the plastic member.

In the method for forming the metal film of the present invention, the plastic member, in which the permeative substance is impregnated into the surface thereof, may be manufactured by using an injection molding machine provided with a mold; and the preparation of the plastic member in which the permeative substance is impregnated into the surface thereof may include: preparing a plastic film; preparing a first mixture solution containing metallic fine particles and a first plastic resin; preparing a second mixture solution containing the permeative substance and a second plastic resin; coating the first mixture solution on the plastic film to form on the plastic film a first resin film in which the metallic fine particles are dispersed; coating the second mixture solution on the first resin film to form on the first resin film a second resin film in which the permeative substance is dispersed; holding, in the mold of the injection molding machine, the plastic film in which the first and second resin films are formed; and injecting and charging a melted resin in the injection molding machine into the mold, in which the plastic film is held, to mold the plastic member.

In the method for forming the metal film of the present invention, the preparation of the plastic member in which the permeative substance is impregnated into the surface thereof may include: preparing a plastic film; preparing a mixture solution containing the permeative substance, metallic fine particles, and a plastic resin; and coating the mixture solution on the plastic film to form on the plastic film a resin film in which the permeative substance and the metallic fine particles are dispersed;

the method for forming the metal film may be a method for forming the metal film using an injection molding machine provided with a mold; and

the method for forming the metal film may further include, after removing the permeative substance, holding, in the mold of the injection molding machine, the plastic film on which the resin film is formed; and injecting and charging a melted resin in the injection molding machine into the mold, in which the plastic film is held, to mold the plastic member is molded.

In the method for forming the metal film of the present invention, the method for forming the metal film may be a method for forming the metal film using an injection molding machine provided with a mold and first and second heating cylinders which inject a melted resin of the plastic member into the mold; and

the preparation of the plastic member in which the permeative substance is impregnated into the surface thereof may include: preparing a first plastic resin which contains the permeative substance and a second plastic resin which does not contain the permeative substance; plasticizing and melting the first plastic resin in the first heating cylinder; plasticizing and melting the second plastic resin in the second heating cylinder; injecting the melted first plastic resin into the mold; and after injecting the first plastic resin, injecting and charging the melted second plastic resin into the mold to mold the plastic member. That is, in the method for forming the metal film of the present invention, the plastic member, in which the permeative substance is impregnated into the surface thereof, may be prepared by the sandwich molding.

In the method for forming the metal film of the present invention, the plastic member may be formed of one of a thermoplastic resin, a thermosetting resin, and a photo-curable resin.

In the method for forming the metal film of the present invention, the permeative substance may be a water-soluble polymer or a water-soluble monomer. In the method for forming the metal film of the present invention, in particular, the permeative substance may be polyethylene glycol. In the method for forming the metal film of the present invention, the permeative substance may have a molecular weight in a range of 50 to 2,000.

In the method for forming the metal film of the present invention, the permeative substance may include a first permeative substance and a second permeative substance; and the first permeative substance may be removed when the permeative substance is removed from the surface of the plastic member. In this procedure, the first permeative substance may be a water-soluble polymer or a water-soluble monomer. The first permeative substance may have a molecular weight in a range of 50 to 2,000.

According to a third aspect of the present invention, there is provided a method for producing a plastic member, comprising: preparing a plastic member in which a permeative substance is impregnated into a surface thereof; and bringing a solvent into contact with the plastic member so that the permeative substance is dissolved in the solvent to remove the permeative substance from the surface of the plastic member. In the method for producing the plastic member of the present invention, a plastic member, which has fine pores (fine irregularities or fine concave and convex portions) on the surface thereof and which is excellent in the smoothness, can be manufactured more easily with various types of plastics.

According to the surface modification method of the present invention, the fine irregularities of the order of submicron to nanometer can be formed on the surface of the plastic member by using the pressurized fluid with respect to various types of plastic members. Therefore, for example, when the surface modification method of the present invention is used as the pretreatment process for the electroless plating, it is possible to provide the clean pretreatment process for the electroless plating with a low cost.

According to the method for forming the metal film of the present invention, the metal film is formed, for example, by the electroless plating on the surface of the plastic member obtained by the surface modification method of the present invention. Therefore, the metal film, which is excellent in the adhesion performance, can be formed, for example, owing to the scale merit brought about by the expansion of the surface area and the anchoring effect brought about by the fine irregularities of the size of the order of submicron to nanometer formed on the surface of the plastic member. The metal film, in which the smoothness is extremely excellent (surface roughening is suppressed), can be formed, because the irregularities, which are formed on the surface of the plastic member, have the size of the order of submicron to nanometer. According to the method for forming the metal film of the present invention, the surface of the plastic member can be roughened without using any harmful etchant (etching solution) unlike the conventional plating method. Therefore, it is possible to provide the clean method for forming the metal film in which the cost is low.

According to the method for producing the plastic member of the present invention, it is possible to easily manufacture the plastic member in which the fine pores (fine irregularities) are provided on the surface and the smoothness is excellent, with respect to various types of plastics. Further, it is also possible to control the electric characteristic of the plastic member including, for example, the dielectric constant and the dielectric loss tangent and the optical characteristic including, for example, the realization of the low refractive index, by adjusting the ratio of the content of the fine pores formed on the surface of the plastic member.

### BRIEF DESCRIPTION OF THE DRAWINGS

FIG. 1 shows a schematic arrangement view illustrating a surface modification apparatus used in a first embodiment.

FIGS. 2A and 2B show AFM observation images of a surface of a molded plastic member, wherein FIG. 2A shows an AFM observation image before removing the permeative substance, and FIG. 2B shows an AFM observation image after removing the permeative substance.

FIG. 3 shows a flow chart illustrating a procedure of a surface modification method and a method for forming a metal film of the first embodiment.

FIG. 4 shows a schematic arrangement view illustrating a surface modification apparatus used in a fifth embodiment.

FIG. 5 shows a magnified sectional view illustrating an area surrounded by broken lines A shown in FIG. 4.

FIG. 6 shows a flow chart illustrating a procedure of a surface modification method and a method for forming a metal film of the fifth embodiment.

FIG. 7 shows a schematic arrangement view illustrating a surface modification apparatus used in a sixth embodiment.

FIG. 8 shows a magnified sectional view illustrating an area surrounded by broken lines A shown in FIG. 7.

FIG. 9 shows a magnified sectional view illustrating the area surrounded by the broken lines A shown in FIG. 7.

FIG. 10 shows a magnified sectional view illustrating the area surrounded by the broken lines A shown in FIG. 7.

FIG. 11 shows a flow chart illustrating a procedure of a surface modification method and a method for forming a metal film of the sixth embodiment.

FIG. 12 shows a schematic arrangement view illustrating a molding apparatus used in a seventh embodiment.

FIGS. 13A and 13B show situations upon the injection charging of the melted resin, wherein FIG. 13A shows a situation upon the initial charging, and FIG. 13B shows a situation upon the completion of the charging.

FIG. 14 shows a flow chart illustrating a procedure of a surface modification method and a method for forming a metal film of the seventh embodiment.

FIG. 15 shows a flow chart illustrating a procedure of a surface modification method and a method for forming a metal film of a ninth embodiment.

FIG. 16 shows a schematic arrangement view illustrating a molding apparatus used in a tenth embodiment.

FIG. 17 illustrates a method of the insert molding, which depicts a situation before injecting the melted resin.

FIG. 18 illustrates the method of the insert molding, which depicts a situation after injecting the melted resin.

FIG. 19 shows a schematic sectional view illustrating a plastic molded article manufactured in the tenth embodiment.

FIG. 20 shows a flow chart illustrating a procedure of a surface modification method and a method for forming a metal film of the tenth embodiment.

FIG. 21 shows a flow chart illustrating a procedure of a surface modification method and a method for forming a metal film of an eleventh embodiment.

FIG. 22 shows a flow chart illustrating a procedure of the surface modification method of the present invention.

FIG. 23 shows a flow chart illustrating a procedure of the method for forming the metal film of the present invention.

FIG. 24 shows a flow chart illustrating a procedure of a surface modification method and a method for forming a metal film of a twelfth embodiment.

FIG. 25 shows a schematic arrangement view illustrating an extraction apparatus used in the twelfth embodiment.

FIG. 26 shows a schematic sectional view illustrating a plastic member manufactured in the twelfth embodiment.

FIG. 27 shows a flow chart illustrating a procedure of a surface modification method and a method for forming a metal film of a thirteenth embodiment.

FIG. 28 shows a schematic sectional view illustrating a plastic member manufactured in the thirteenth embodiment.

FIG. 29 shows a flow chart illustrating a procedure of a surface modification method and a method for forming a metal film of a fifteenth embodiment.

### DESCRIPTION OF THE PREFERRED EMBODIMENTS

An explanation will be specifically made below with reference to the drawings about embodiments of the surface modification method, the method for forming the metal film, and the method for producing the plastic member according to the present invention. However, the following embodiments are preferred specified embodiments of the present invention, to which the present invention is not limited.

### First Embodiment

In the first embodiment, an example will be explained, wherein carbon dioxide (pressurized fluid) in the supercritical state, in which a permeative substance is dissolved, is brought into contact with the surface of a plastic member made of a thermoplastic resin to permeate the permeative substance into the plastic member, and then the permeative substance is removed from the plastic member to perform the surface modification. In the first embodiment, an example will be also explained, in which a plating film (metal film) is formed on the surface of the plastic member subjected to the surface modification. In this embodiment, polyethylene glycol (molecular weight: 200) was used as the permeative substance, and a polycarbonate substrate was used as the plastic member.

### Modification Apparatus

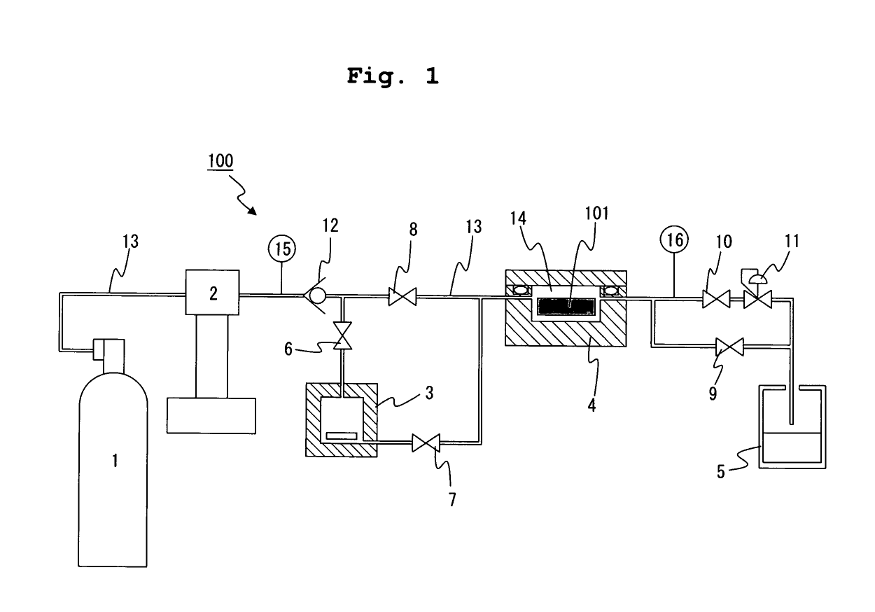

FIG. 1 shows a schematic arrangement view of an apparatus used to modify the surface of the plastic member of this embodiment. As shown in FIG. 1, a modification apparatus 100 is mainly constructed of a liquid carbon dioxide bomb 1, a syringe pump 2 (260D produced by ISCO) which generates carbon dioxide in the supercritical state (hereinafter referred to as “supercritical carbon dioxide” as well), a dissolving tank 3 in which the permeative substance is dissolved in the supercritical carbon dioxide, a high pressure container 4 which accommodates a plastic member 101, a recovery tank 5 which recovers the gas discharged, for example, from the high pressure container 4, and a piping 13 which connects these constitutive components. As shown in FIG. 1, the piping 13 is provided with manual needle valves 6 to 10 which control the flow of the pressurized fluid in the modification apparatus 100, a pressure-holding valve 11, and a check valve 12 at predetermined positions.

The high pressure container 4, which is used in this embodiment, is a high pressure container in which the temperature can be regulated by a cartridge heater (not shown), and can be cooled with cooling water allowed to flow through a cooling circuit (not shown). In this embodiment, a space 14, in which the plastic member 101 is installed in the high pressure container 4, has a volume of 1 ml.

### Surface Modification Method

Next, an explanation will be made with reference to FIGS. 1 to 3 about a surface modification method for the plastic member of this embodiment. The surface modification method of this embodiment will be explained below as starting from the state in which all of the valves shown in FIG. 1 are closed respectively.

At first, as shown in FIG. 1, the plastic member 101 (polycarbonate substrate), to which the surface modification was to be applied, was installed inside the high pressure container 4 which was temperature-regulated to have a predetermined temperature (120° C.). Subsequently, polyethylene glycol as the permeative substance was charged into the dissolving tank 3 having an internal volume of 10 ml. In this embodiment, the charge amount of polyethylene glycol was 1 ml. The solubility of polyethylene glycol is low. Therefore, a carrier (Wet Support produced by ISCO) was used in order to increase the contact area of the supercritical carbon dioxide.

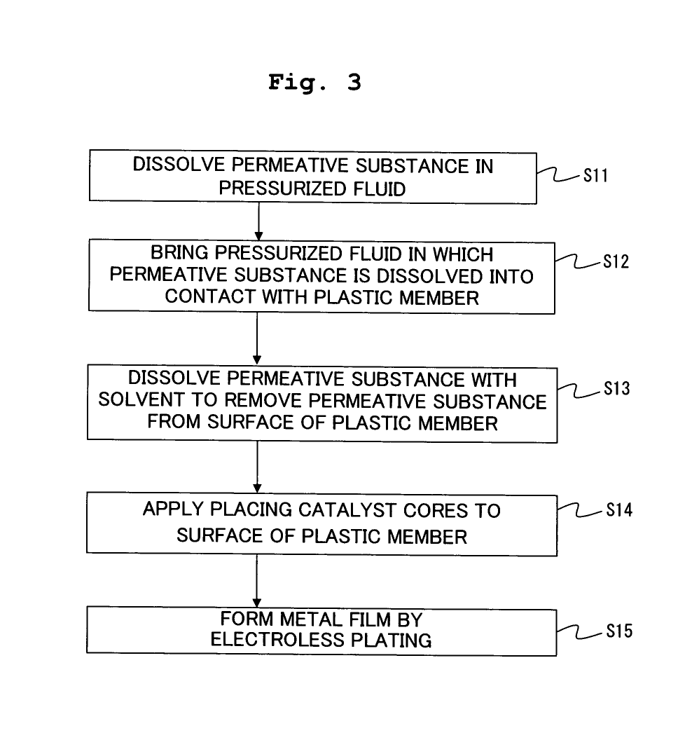

Subsequently, the liquid carbon dioxide was supplied from the liquid carbon dioxide bomb 1 to the syringe pump 2, and the liquid carbon dioxide was pressurized. The pressure was raised so that a pressure gauge 15 indicated 15 MPa. Accordingly, the supercritical carbon dioxide was generated. Subsequently, the manual needle valve 6 was opened, and the supercritical carbon dioxide was introduced into the dissolving tank 3 via the check valve 12. The pressure in the dissolving tank 3 was raised to 15 MPa, and the permeative substance was dissolved in the supercritical carbon dioxide (Step S11 shown in FIG. 3). After the pressure was raised, the needle valve 6 was closed again.

Subsequently, the needle valve 8 was opened and the supercritical carbon dioxide, in which the permeative substance was not dissolved and the pressure was the same as the pump pressure (15 MPa), was introduced from the syringe pump 2 into the high pressure container 4. The pressure in the high pressure container 4 was raised to 15 MPa. In this situation, those ranging to the manual needle valves 9, 10 are filled via the high pressure container 4 with the supercritical carbon dioxide in which no permeative substance was dissolved. 15 MPa was indicated by a pressure gauge 16. In this embodiment, as shown in FIG. 1, the pressure-holding valve 11, which was previously regulated so that the primary side pressure was 15 MPa, was provided on the discharge side of the high pressure container 4 so that the supercritical carbon dioxide was allowed to flow at a constant pressure. Subsequently, the needle valve 8 was closed, and the pressure of the space 14 in the high pressure container 4 was retained at 15 MPa. When the pressure in the high pressure container 4 is previously raised to 15 MPa, the supercritical carbon dioxide, in which the permeative substance is dissolved, can be introduced into the high pressure container 4 without causing any pressure loss.

Subsequently, the supercritical carbon dioxide, in which the permeative substance was dissolved, was introduced from the dissolving tank 3 into the high pressure container 4. The supercritical carbon dioxide, in which the permeative substance was dissolved, was allowed to make contact with the plastic member 101 (Step S12 shown in FIG. 3). Specifically, the supercritical carbon dioxide was introduced as follows. At first, the manual needle valves 6, 7 were opened, the syringe pump 2 was switched from the pressure control to the flow rate control, and the supercritical carbon dioxide, in the dissolving tank 3, in which the permeative substance was dissolved, was introduced into the high pressure container 4. The flow rate of the pump was set to 10 ml/min. Further, the manual needle valve 10 was opened, and the supercritical carbon dioxide was allowed to flow (discharged) to the recovery tank 5 for 1 minute. In accordance with the operation as described above, the interior of the high pressure container 4 and a flow passage (for example, the piping) communicated with the high pressure container 4 were substituted with the supercritical carbon dioxide in which the permeative substance was dissolved, in the state in which the pressure was retained to be constant. After that, the needle valves 6, 7 were closed.

Subsequently, the needle valve 8 was opened, and the supercritical carbon dioxide, in which the permeative substance was not dissolved, was introduced from the syringe pump 2 into a flow passage (for example, the piping) communicated with the high pressure container 4. The supercritical carbon dioxide was allowed to flow for 10 seconds at a flow rate of 10 ml/min. The supercritical carbon dioxide, which was charged to the piping or the like and in which the permeative substance was dissolved, was transported to a desired position (forcibly introduced into the high pressure container 4). Accordingly, the dissolved concentration of the permeative substance in the supercritical carbon dioxide can be distributed at high concentrations in the vicinity of the surface of the plastic member 101 installed in the high pressure container 4. The pressure was retained for 10 minutes in this state to permeate the permeative substance into the surface of the plastic member 101.

Subsequently, the power source of the heater of the high pressure container 4 was turned off. The cooling water was allowed to flow, and the high pressure container 4 was cooled to 40° C. When the internal pressure of the high pressure container 4 is lowered during the cooling, it is feared that foams may appear at the interior and the surface of the plastic member 101. Therefore, it is desirable that the external pressure is retained during the cooling. After that, the manual needle valve 8 was closed, and the valve 9 was simultaneously opened. The high pressure container 4 was open to the atmospheric air while recovering the permeative substance and the carbon dioxide to the recovery tank 5. After that, the plastic member 101, in which the permeative substance was permeated into the surface thereof, was taken out from the high pressure container 4.

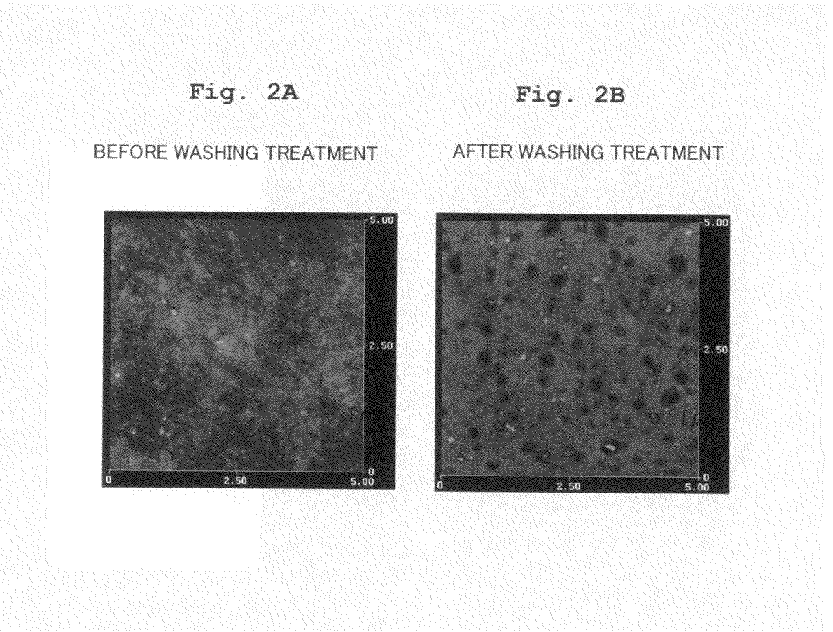

Subsequently, the plastic member 101, in which the polyethylene glycol (permeative substance) was impregnated into the surface, was immersed in pure water to perform the ultrasonic washing for 1 hour so that the polyethylene glycol was removed from the plastic member 101 (Step S13 shown in FIG. 3). As a result of this process, the polyethylene glycol, which has been permeated into the surface of the plastic member 101, is disengaged or separated, and fine pores are formed at portions from which the polyethylene glycol is disengaged. That is, the fine pores (fine irregularities, fine concave and convex portions) were formed on the surface of the plastic member 101 (physical shape of the surface was changed) by the washing treatment as described above. These situations are shown in FIGS. 2A and 2B. FIG. 2A shows an AFM (Atomic Force Microscope) observation image of the surface of the plastic member 101 before the washing treatment, and FIG. 2B shows an AFM observation image of the surface of the plastic member 101 after the washing treatment. As clarified from FIGS. 2A and 2B, it has been revealed that a large number of fine pores of about 100 to 300 nm are formed on the surface of the plastic member 101 after the washing treatment in this embodiment. In this embodiment, the surface modification was performed for the plastic member 101 as described above to obtain the plastic member 101 in which the fine irregularities (fine pores) were formed on the surface.

### Method for Forming Plating Film

Subsequently, an electroless plating film was formed on the plastic member 101 manufactured as described above in which the fine irregularities were formed on the surface. Specifically, the electroless plating film was formed as follows. At first, the plastic member 101 was degreased by using a known conditioner (OPC-370 produced by Okuno Chemical Industries Co., Ltd.). Subsequently, a catalyst (OPC-80 catalyst produced by Okuno Chemical Industries Co., Ltd.) was applied to the plastic member 101 (Step S14 shown in FIG. 3), and then the catalyst was activated by using an activating agent (OPC-500 accelerator MX produced by Okuno Chemical Industries Co., Ltd.). Subsequently, the electroless copper plating was applied (Step S15 shown in FIG. 3). OPC-750 electroless copper produced by Okuno Chemical Industries Co., Ltd. was used for the plating solution. As a result, no blister was formed on the plating film formed on the plastic member 101, and the adhesion strength based on the tape exfoliation test was satisfactory as well.

### Second Embodiment

In the second embodiment, an explanation will be made about an example wherein the permeative substance is permeated into the plastic member such that the supercritical carbon dioxide (pressurized fluid), in which the permeative substance is dissolved, is brought into contact with the surface of the plastic member made of a thermosetting resin, and then the permeative substance is removed from the plastic member to perform the surface modification. In the second embodiment, an explanation will be also made about an example in which the plating film (metal film) is formed on the surface of the plastic member subjected to the surface modification. In this embodiment, polyethylene glycol (molecular weight: 200) was used as the permeative substance, and a polyimide substrate was used as the plastic member.

In this embodiment, the surface modification was performed for the plastic member by using the modification apparatus shown in FIG. 1 in the same manner as in the first embodiment. The surface modification method for the plastic member and the method for forming the metal film in this embodiment were performed in the same manner as in the first embodiment except that the temperature of the high pressure container 4 shown in FIG. 1 was 80° C.

As a result, a large number of fine pores were formed in the same manner as in the first embodiment on the surface of the plastic member after removing the permeative substance by the washing treatment. The plating film, which was formed by the electroless plating on the plastic member, had no blister. The adhesion strength based on the tape exfoliation test was also satisfactory as described later on.

### Third Embodiment

In the third embodiment, an explanation will be made about an example wherein the permeative substance is permeated into the plastic member such that the supercritical carbon dioxide (pressurized fluid), in which the permeative substance is dissolved, is brought into contact with the surface of the plastic member made of a photo-curable resin, and then the permeative substance is removed from the plastic member to perform the surface modification. In the third embodiment, an explanation will be also made about an example in which the plating film (metal film) is formed on the surface of the plastic member subjected to the surface modification. In this embodiment, polyethylene glycol (molecular weight: 200) was used as the permeative substance, and an ultraviolet-curable type resin substrate including an epoxy resin material and a curing agent was used as the plastic member.

In this embodiment, the surface modification was performed for the plastic member by using the modification apparatus shown in FIG. 1 in the same manner as in the first embodiment. The surface modification method for the plastic member and the method for forming the metal film in this embodiment were performed in the same manner as in the first embodiment except that the temperature of the high pressure container 4 shown in FIG. 1 was 150° C.

As a result, a large number of fine pores were formed in the same manner as in the first embodiment on the surface of the plastic member after removing the permeative substance by the washing treatment. The plating film, which was formed by the electroless plating on the plastic member, had no blister. The adhesion strength based on the tape exfoliation test was also satisfactory as described later on.

### Fourth Embodiment

In the fourth embodiment, an explanation will be made about an example wherein the permeative substance is permeated into the plastic member such that the supercritical carbon dioxide (pressurized fluid), in which the permeative substance is dissolved, is brought into contact with the surface of the plastic member made of a thermoplastic resin, the permeative substance permeated into the surface of the plastic member is thereafter removed to perform the surface modification, and the plating film (metal film) is formed by the electroless plating on the surface of the plastic member subjected to the surface modification . However, in this embodiment, polyethylene glycol (molecular weight: 2,000) was used as the permeative substance, and a polycarbonate substrate was used as the plastic member.

In this embodiment, the surface modification was performed for the plastic member and the electroless plating film was formed in accordance with the same method as that of the first embodiment except that the polyethylene glycol (molecular weight: 2,000) was used as the permeative substance.

As a result, a large number of fine pores were formed in the same manner as in the first embodiment on the surface of the plastic member after removing the permeative substance by the washing treatment. The plating film, which was formed on the plastic member, had no blister. The adhesion strength based on the tape exfoliation test was also satisfactory as described below.

### Tape exfoliation test and measurement of surface roughness

The tape exfoliation test was carried out for the plating films obtained by the surface modification methods and the methods for forming the plating films of the first to fourth embodiments described above to evaluate the adhesion performance of the plating films. Specifically, on the plastic member on which the plating film was formed, a latticed pattern was formed to provide one hundred equal divisions at intervals of 1 mm. The tape exfoliation test was performed for the respective divided plastic substrates (100 pieces of divided plastic substrates). The electroless plating characteristic was evaluated in accordance with the number of sheets on which the plating film was exfoliated. An adhesive tape (No. 405) produced by NICHIBAN was used as the tape. Obtained results are shown in Table 1. In Table 1, the evaluation criteria are as follows.

++: number of exfoliated sheets was not more than 9;

+: number of exfoliated sheets was not less than 10 and not more than 29;

±: number of exfoliated sheets was not less than 30 and not more than 59;

−: number of exfoliated sheets was not less than 60, or no plating film was formed.

The surface roughness was measured for the plating films formed on the surfaces of the plastic members in the first to fourth embodiments by using a stylus-type surface roughness measuring apparatus (produced by KLA-Tencor). Obtained results are also shown in Table 1. In the measurement of the surface roughness, the arithmetic mean deviation of the profile (Ra) and the ten-point height of irregularities (Rz) were measured for the respective plastic substrates.

TABLE 1

| | |
|---|---|
| Tape | Surface roughness |

| | exfoliation test | Ra (nm) | Rz (nm) |
|---|---|---|---|
| First embodiment | ++ | 28.3 | 104.1 |
| Second embodiment | ++ | 35.9 | 157.1 |
| Third embodiment | ++ | 22.5 | 125.9 |
| Fourth embodiment | ++ | 58.7 | 288.6 |

As clarified from the results of the tape exfoliation test shown in Table 1, the evaluation of “++” was awarded for all of the plating films formed in the first to fourth embodiments. It was revealed that the sufficiently satisfactory adhesion strength was obtained, probably for the following reason. That is, it is considered that the anchoring effect or the like is enhanced owing to the fact that the permeative substance impregnated into the surface of the plastic member is washed and removed, and thus the fine irregularities are formed on the surface of the plastic member.

Further, the following fact has been revealed in relation to the surface roughnesses of the plating films formed on the surfaces of the plastic members in the first to fourth embodiments. That is, the arithmetic mean deviation of the profile (Ra) is in an order of several tens of nm, and the ten-point height of irregularities (Rz) is in an order of several hundreds of nm. When it is intended to roughen the surface by any conventional etching treatment, the surface roughness of the plastic member is in an order of several μm to several tens of μm. Taking this fact into consideration, it is appreciated that the surface roughening is suppressed and the satisfactory smoothness is obtained in accordance with the method for forming the plating film of the present invention as compared with the conventional electroless plating method. When the surface roughness of the metal film is large, for example, the reflectance and the electric characteristic (for example, the resistance) of the metal film are deteriorated. However, in the case of the method for forming the plating film of the present invention, the surface roughness of the substrate can be made extremely small. Therefore, the method for forming the plating film of the present invention is preferred, for example, as the method for forming the metal film, for example, for the reflector for which the high reflectance is required and the metal film, for example, for the antenna and the high frequency electric circuit for which the satisfactory electric characteristic is required.

### Fifth Embodiment

In the fifth embodiment, an explanation will be made about an exemplary method directed to a plastic member made of a thermoplastic resin having a recess on the surface thereof in which only the recess is subjected to the surface modification by using the pressurized fluid to form the plating film (metal film). In this embodiment, a cycloolefin resin (Zeonex) was used as the material for forming the plastic member, and the plastic member, which had a through-hole and a recess on the surface thereof, was manufactured by the known injection molding. In this embodiment, a recess pattern having a width of 50 μm and a depth of 50 μm and a through-hole having a diameter of φ 200 μm and a height of 1.0 mm (aspect ratio: 1.0/0.2=5.0) were formed on the surface of the plastic member. In this embodiment, polyethylene glycol (molecular weight: 200) was used as the permeative substance, and the supercritical carbon dioxide was used as the pressurized fluid.

### Modification Apparatus

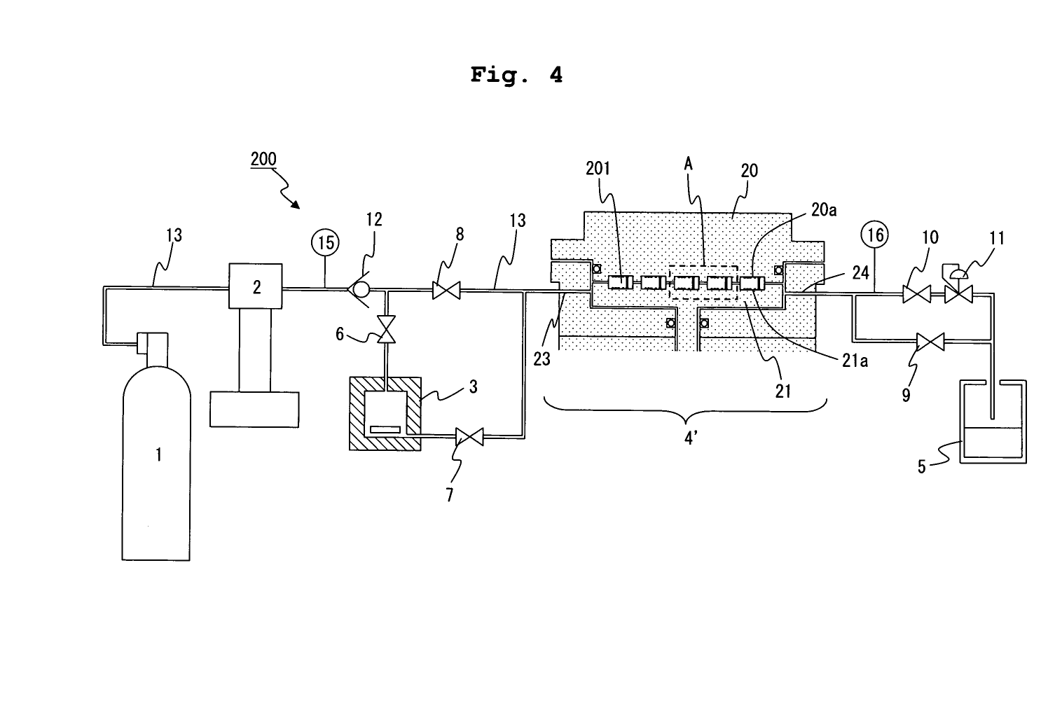

FIG. 4 shows a schematic arrangement view of an apparatus used to modify the surface of the plastic member of this embodiment. As shown in FIG. 4, the modification apparatus 200 is mainly constructed of a liquid carbon dioxide bomb 1, a syringe pump 2 (260D produced by ISCO) which generates the supercritical carbon dioxide, a dissolving tank 3 in which the permeative substance (polyethylene glycol) is dissolved in the supercritical carbon dioxide, a mold 4′ which is capable of accommodating a plurality of plastic members 201, a recovery tank 5 which recovers the gas discharged, for example, from the mold 4′, and a piping 13 which connects the constitutive components. As shown in FIG. 4, the piping 13 is provided with manual needle valves 6 to 10 which control the flow of the pressurized fluid in the modification apparatus 200, a pressure-holding valve 11, and a check valve 12 at predetermined positions. That is, in the modification apparatus 200 of this embodiment, the mold 4′ was used in place of the high pressure container 4 of the modification apparatus 100 used in the first embodiment.

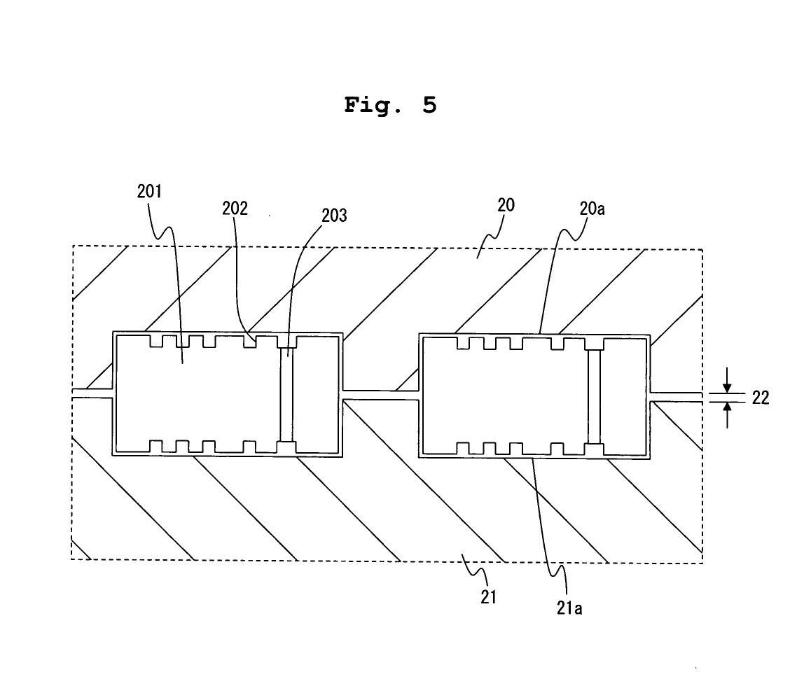

As shown in FIGS. 4 and 5, the mold 4′ is mainly constructed of a movable mold 20 and a fixed mold 21, and is opened/closed by a clamping apparatus (press piston, not shown). FIG. 5 shows a magnified view illustrating an area surrounded by broken lines A shown in FIG. 4. The press piston is movable in accordance with the position control performed by an electric servo motor (not shown). The mold 4′ has such a structure that the temperature can be regulated by an unillustrated cartridge heater. Further, the mold 4′ of this embodiment can be cooled with cooling water allowed to flow through an unillustrated cooling circuit.

As shown in FIGS. 4 and 5, the mold 4′ of this embodiment has such a structure that a plurality of plastic members 201 are interposed (sandwiched) and held between the movable mold 20 and the fixed mold 21. As shown in FIGS. 4 and 5, a plurality of recesses 20a, each of which imitates the contour of the upper half of the plastic member 201, are formed on a surface, of the movable mold 20, on the side of the fixed mold 21. A plurality of recesses 21a, each of which imitates the contour of the lower half of the plastic member 201, are formed on a surface, of the fixed mold 21, on the side of the movable mold 20. The recesses 20a of the movable mold 20 and the recesses 21a of the fixed mold 21 are arranged at the mutually opposing or facing positions. That is, in this structure, a plurality of spaces (hereinafter referred to as “cavities” as well), each of which has approximately the same dimension and the same shape as the contour dimension and the shape of the plastic member 201, are formed by the recesses 20a of the movable mold 20 and the recesses 21a of the fixed mold 21 at the interface between the fixed mold 21 and the movable mold 20 when the movable mold 20 and the fixed mold 21 are closed. Therefore, when the plastic members 201 are installed at the interface between the movable mold 20 and the fixed mold 21 and the mold is closed, a state is given, in which the openings of recesses 202 and through-holes 203 formed on the surfaces of the plastic members 201 (openings defined on the surfaces of the plastic members 201 by the recesses and the through-holes) are closed by the mold.

As shown in FIG. 4, the mold 4′ is formed with an introducing port 23 through which the supercritical carbon dioxide is to be introduced into the space defined between the movable mold 20 and the fixed mold 21 and a discharge port 24 through which the supercritical carbon dioxide is discharged from the mold 4′. In this embodiment, the initial mold opening amount 22 of the press piston was 1 mm (see FIG. 5).

### Surface Modification Method

An explanation will be made with reference to FIGS. 4 to 6 about the surface modification method for the plastic member in the fifth embodiment. The surface modification method of this embodiment will be explained below as starting from the state in which all of the valves shown in FIG. 4 are closed respectively.

At first, the plastic member 201 was manufactured in accordance with the known injection molding. The UV light was radiated for 1 minute onto the plastic member 201 with a low pressure mercury lamp having a wavelength of 185 nm. Accordingly, the surface of the plastic member 201 was subjected to the hydrophilic or water-attracting treatment to enhance the affinity between the plastic member 201 and the polyethylene glycol as the permeative substance. Subsequently, as shown in FIG. 4, the plurality of plastic members 201 were installed in the mold 4′ temperature-regulated to have a predetermined temperature (120° C.).

Subsequently, the polyethylene glycol as the permeative substance was charged into the dissolving tank 3 having an internal volume of 10 ml. In this embodiment, the charge amount of the polyethylene glycol was 1 ml. The solubility of polyethylene glycol with respect to carbon dioxide is low. Therefore, a carrier (Wet Support produced by ISCO) was used in order to increase the contact area of the supercritical carbon dioxide.

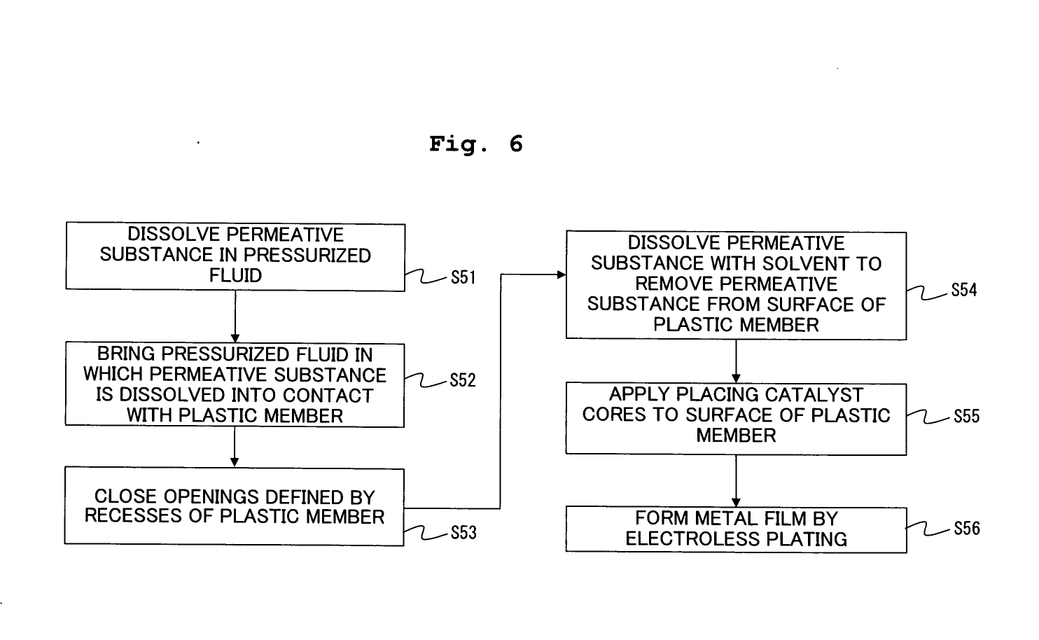

Subsequently, the liquid carbon dioxide was supplied from the liquid carbon dioxide bomb 1 to the syringe pump 2, and the liquid carbon dioxide was pressurized. The pressure was raised so that a pressure gauge 15 indicated 15 MPa to generate the supercritical carbon dioxide. Subsequently, the manual needle valve 6 was opened, and the supercritical carbon dioxide was introduced into the dissolving tank 3 via the check valve 12. The pressure in the dissolving tank 3 was raised to 15 MPa, and the permeative substance was dissolved in the supercritical carbon dioxide (Step S51 shown in FIG. 6). After the pressure was raised, the needle valve 6 was closed again.

Subsequently, the needle valve 8 was opened. The supercritical carbon dioxide, in which the permeative substance was not dissolved and the pressure was the same as the pump pressure (15 MPa), was introduced from the syringe pump 2 into the cavity of the mold 4′. The pressure in the mold 4′ was raised to 15 MPa. In this situation, those ranging to the manual needle valves 9, 10 are filled via the mold 4′ with the supercritical carbon dioxide in which no permeative substance was dissolved 15 MPa was indicated by a pressure gauge 16. In this embodiment, as shown in FIG. 4, the pressure-holding valve 11, which was previously regulated so that the primary side pressure was 15 MPa, was provided on the discharge side of the mold 4′ so that the supercritical carbon dioxide was allowed to flow at a constant pressure. Subsequently, the needle valve 8 was closed, and the pressure of the cavity in the mold 4′ was retained at 15 MPa. When the pressure in the mold 4′ is previously raised to 15 MPa as described above, the supercritical carbon dioxide, in which the permeative substance is dissolved, can be introduced into the mold 4′ without causing any pressure loss.

Subsequently, the supercritical carbon dioxide, in which the permeative substance was dissolved, was introduced from the dissolving tank 3 into the mold 4′. The supercritical carbon dioxide, in which the permeative substance was dissolved, was brought into contact with the plastic member 201 (Step S52 shown in FIG. 6). Specifically, the supercritical carbon dioxide, in which the permeative substance was dissolved, was introduced as follows. At first, the manual needle valves 6, 7 were opened, the syringe pump 2 was switched from the pressure control to the flow rate control, and the supercritical carbon dioxide, in the dissolving tank 3, in which the permeative substance was dissolved, was introduced into the mold 4′. The flow rate of the pump was set to 10 ml/min. Further, the manual needle valve 10 was opened, and the supercritical carbon dioxide was allowed to flow (discharged) to the recovery tank 5 for 1 minute. In accordance with the operation as described above, the interior of the mold 4′ and a flow passage (for example, the piping) communicated with the mold 4′ were substituted with the supercritical carbon dioxide in which the permeative substance was dissolved, in the state in which the pressure was retained to be constant. After that, the needle valves 6, 7 were closed.

Subsequently, the needle valve 8 was opened, and the supercritical carbon dioxide, in which the permeative substance was not dissolved, was introduced from the syringe pump 2 into a flow passage (for example, the piping) communicated with the mold 4′. The supercritical carbon dioxide was allowed to flow for 10 seconds at a flow rate of 10 ml/min. The supercritical carbon dioxide, which was charged to the piping or the like and in which the permeative substance was dissolved, was transported to a desired position (forcibly introduced into the mold 4′). Accordingly, the dissolved concentration of the permeative substance in the supercritical carbon dioxide can be distributed at high concentrations in the vicinity of the surface of the plastic member 201 installed in the mold 4′.

Subsequently, the mold 4′ was closed in the state in which the supercritical carbon dioxide was brought into contact with the plastic member 201. The openings of the recesses 202 and the through-holes 203 of the plastic members 201 were closed, and the supercritical carbon dioxide, in which the permeative substance was dissolved, was allowed to remain in only the recesses 202 and the through-holes 203 (Step S53 shown in FIG. 6). Specifically, the mold 4′ was closed by pressing the plastic members 201 by moving the press piston upwardly. The supercritical carbon dioxide, in which the permeative substance was dissolved, was selectively allowed to make contact with only surfaces defining the recesses 202 and the through-holes 203, respectively, of the plastic members 201. In this situation, the permeative substance is permeated, together with the supercritical carbon dioxide, into the surfaces which define the recesses 202 and the through-holes 203 of each of the plastic members 201. In this embodiment, this state was retained for 10 minutes to permeate the permeative substance into the surfaces which define the recesses 202 and the through-holes 203 of each of the plastic members 201. When this method is used, the permeative substance can be permeated uniformly at a high concentration into only the surfaces defining the recesses 202 and the through-holes 203 of each of the plastic members 201.

In this embodiment, the steps (steps from Step S52 to Step S53 shown in FIG. 6) are performed in a short period of time (5 to 10 seconds in this embodiment) after the supercritical carbon dioxide, in which the permeative substance is dissolved, is introduced into the mold 4′ and until the mold 4′ is closed to close the openings of the recesses 202 and the through-holes 203 of the plastic members 201. Therefore, the permeative substance is hardly permeated into the surface of each of the plastic members 201, which are different from the surfaces defining the recesses 202 and the through-holes 203 of the plastic members 201. However, when the period of time is long after the supercritical carbon dioxide, in which the permeative substance is dissolved, is introduced into the mold 4′ and until the mold 4′ is closed, it is feared that the permeative substance, which is dissolved in the supercritical carbon dioxide, may be also permeated at a high concentration into the surface different from the surfaces defining the recesses 202 and the through-holes 203 of the plastic member 201. Therefore, it is preferable that the steps, which are performed after the supercritical carbon dioxide in which the permeative substance is dissolved and until the mold 4′ is closed is introduced into the mold 4′, are performed in a period of time which is as short as possible.

Subsequently, the power source of the heater of the mold 4′ was turned off. The cooling water was allowed to flow, and the mold 4′ was cooled to 40° C. When the internal pressure of the mold 4′ is lowered during the cooling, it is feared that foams may appear at the interior and the surface of the plastic member 201. Therefore, it is desirable that the external pressure is retained during the cooling. After that, the manual needle valve 8 was closed, and the valve 9 was simultaneously opened. The mold 4′ was open to the atmospheric air while recovering the permeative substance and the carbon dioxide to the recovery tank 5. Subsequently, the plastic members 201 were taken out from the mold 4′.

Subsequently, the polyethylene glycol was removed from the plastic member 201 in which the polyethylene glycol was impregnated into the surfaces of the recesses 202 and the through-hole 203, by the method as described above (Step S54 shown in FIG. 6). Specifically, each of the plastic members 201, in which the polyethylene glycol was impregnated into the surface, was immersed in pure water to perform the ultrasonic washing for 1 hour. As a result of the washing treatment, the polyethylene glycol, which has been permeated into the surfaces of the recesses 202 and the through-hole 203 of the plastic member 201, is disengaged to form the fine irregularities on the surfaces of the recesses 202 and the through-hole 203 of the plastic member 201. That is, the physical shape of the surface was selectively changed at only the surfaces of the recesses 202 and the through-hole 203 of the plastic member 201 by the washing treatment. In this embodiment, the surface of the plastic member 201 was modified as described above to obtain the plastic member 201 in which only the surfaces defining the recesses 202 and the through-hole 203 were modified.

### Method for Forming Plating Film

Subsequently, the electroless plating was applied in the same manner as in the first embodiment to the plastic member 201 manufactured by the surface modification method as described above to form the plating film on the surface of the plastic member 201 (Steps S55 and S56 shown in FIG. 6). As a result, in this embodiment, the metal film was formed on only the surfaces defining the recesses 202 and the through-hole 203 of the plastic member 201. The plating film formed in this embodiment had no blister in the same manner as the plating films formed in the first to fourth embodiments. The adhesion strength based on the tape exfoliation test was satisfactory as well.

The surface roughness was measured for the plating film formed in this embodiment by using a stylus-type surface roughness measuring apparatus (produced by KLA-Tencor). As a result, the arithmetic mean deviation of the profile (Ra) was 21.0 nm, and the ten-point height of irregularities (Rz) was 149.3 nm. The values were extremely smaller than those of the plating film (Ra≈several μm to several tens μm) formed by the conventional plating method (method to perform the etching treatment). The satisfactory surface roughness (satisfactory smoothness) was obtained. That is, in this embodiment, the plastic molded article was successfully obtained, in which the electroless plating film having the high adhesion performance and the high smoothness was formed on the surface.

### Sixth Embodiment

In the sixth embodiment, an explanation will be made about an exemplary method directed to a plastic member made of a thermoplastic resin having a recess and a through-hole on the surface thereof in the same manner as in the fifth embodiment, wherein only the recess and the through-holes are subjected to the surface modification to form the plating film (metal film). However, in this embodiment, an explanation will be made about an example wherein a solution containing the permeative substance is coated on the surface of the plastic member, and then the permeative substance is dissolved in the supercritical carbon dioxide by bringing the supercritical carbon dioxide (pressurized fluid) into contact therewith so that the permeative substance is permeated into the surface of the plastic member together with the supercritical carbon dioxide.

In this embodiment, a cycloolefin resin (Zeonex) was used as the material for forming the plastic member, and the plastic member, which had a through-hole and a recess on the surface thereof, was manufactured by the known injection molding. In this embodiment, a recess pattern having a width of 50 μm and a depth of 50 μm and a through-hole having a diameter of φ 200 μm and a height of 1.0 mm (aspect ratio: 1.0/0.2=5.0) were formed on the surface of the plastic member. In this embodiment, polyethylene glycol (molecular weight: 600) was used as the permeative substance.

### Modification apparatus

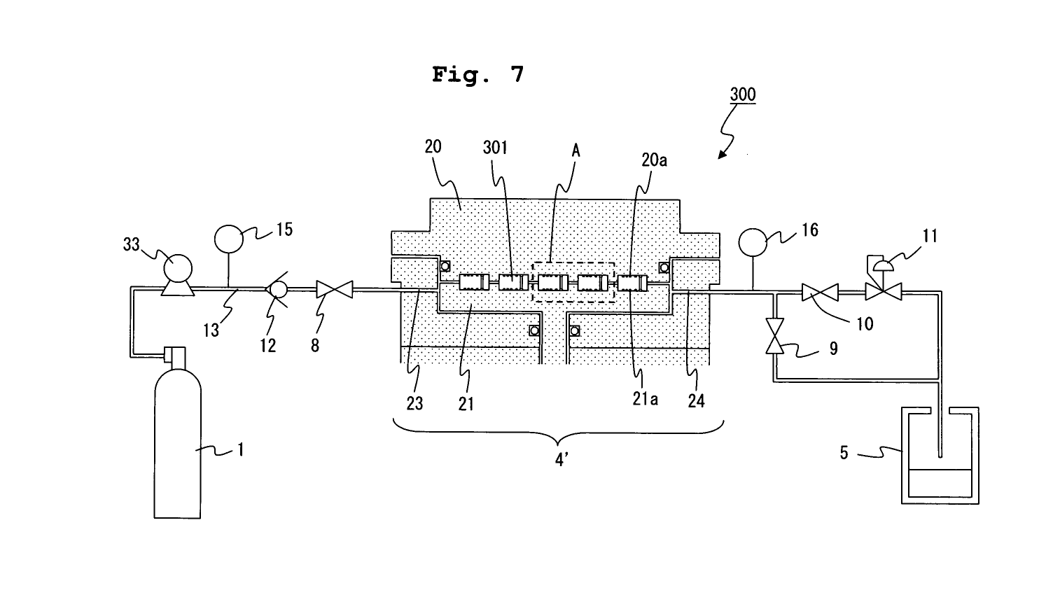

FIG. 7 is a schematic arrangement view of a modification apparatus used to modify the surface of the plastic member in this embodiment. As shown in FIG. 7, a modification apparatus 300 of this embodiment is mainly constructed of a liquid carbon dioxide bomb 1, a high pressure pump 33 which generates the supercritical carbon dioxide, a mold 4′ which accommodates a plastic member 301, a recovery tank 5 which recovers the gas discharged, for example, from the mold 4′, and a piping 13 which connects these constitutive components. As shown in FIG. 7, the piping 13 is provided with manual needle valves 8 to 10 which control the flow of the pressurized fluid in the modification apparatus 300, a pressure-holding valve 11, and a check valve 12 at predetermined positions.

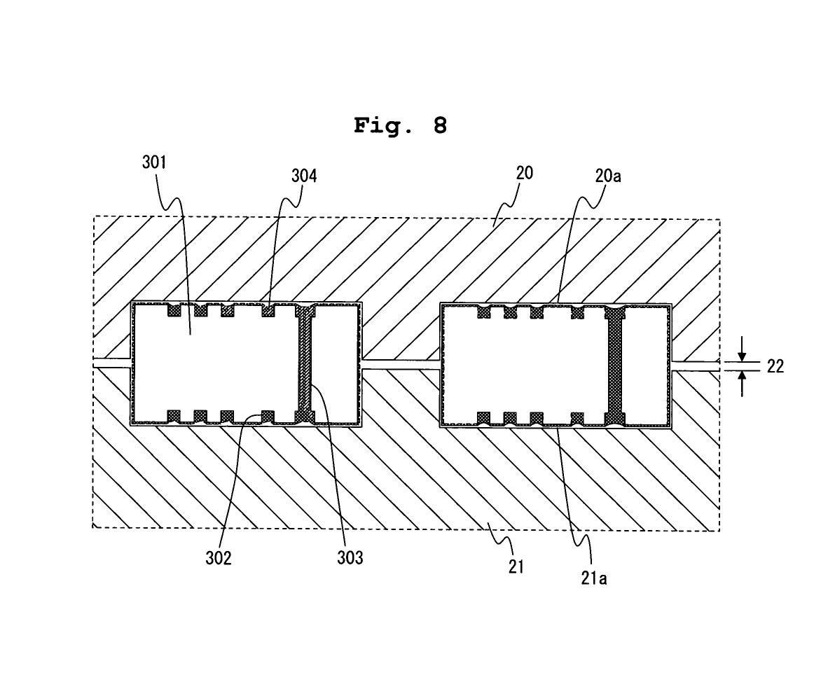

As clarified from FIG. 7, in the modification apparatus 300 used in this embodiment, the high pressure pump 33 was used in place of the syringe pump 2 of the modification apparatus 200 used in the fifth embodiment (see FIG. 4). The modification apparatus 300 used in this embodiment was constructed such that the dissolving tank 3 of the modification apparatus 200 of the fifth embodiment was not provided. The mold 4′ used in the modification apparatus 300 of this embodiment has the same structure as that of the fifth embodiment. The initial mold opening amount 22 of the press piston was 1 mm (see FIG. 8 described later on).

### Surface Modification Method

An explanation will be made with reference to FIGS. 7 to 11 about the surface modification method for the plastic member in this embodiment. The surface modification method of this embodiment will be explained below as starting from the state in which all of the valves shown in FIG. 7 are closed respectively.

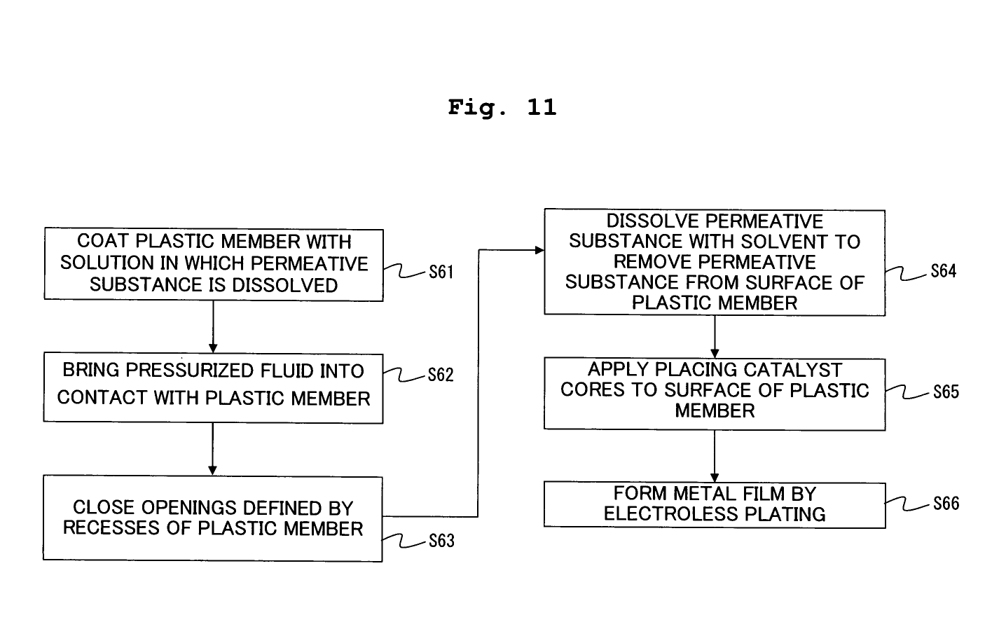

At first, the UV light was radiated for 1 minute onto the plastic member 301 with a low pressure mercury lamp having a wavelength of 185 nm. Accordingly, the surface of the plastic member 301 was subjected to the hydrophilic or water-attracting treatment to enhance the affinity between the plastic member 301 and the polyethylene glycol as the permeative substance. Subsequently, the polyethylene glycol (molecular weight: 600) was heated to 60° C. so that the polyethylene glycol was in a solution state. The surface of the plastic member 301 (plastic) was coated with the solution (304 shown in FIG. 8) (Step S61 shown in FIG. 11). The polyethylene glycol (molecular weight: 600) used in this embodiment is the semi-solid substance at room temperature, and is the liquid substance at high temperatures.

Subsequently, as shown in FIGS. 7 and 8, the plastic member 301, which had the surface coated with the solution 304 of the permeative substance, was installed in the mold 4′ temperature-regulated to have a predetermined temperature (120° C.). Subsequently, the liquid carbon dioxide was supplied from the liquid carbon dioxide bomb 1 to the high pressure pump 33 so that the liquid carbon dioxide was pressurized. The pressure was raised so that the pressure gauge 15 indicated 15 MPa to generate the supercritical carbon dioxide. Subsequently, the manual needle valves 8, 10 were opened, and thus the supercritical carbon dioxide at 15 MPa was introduced via the check valve 12 into the mold 4′ and the piping so that the supercritical carbon dioxide was brought into contact with the plastic member 301 (Step S62 shown in FIG. 11). In this procedure, it is desirable that the pressure-holding valve 11, in which the pressure on the primary side is regulated to 15 MPa as in this embodiment, is previously provided on the discharge side of the mold 4′ so that the supercritical carbon dioxide is allowed to flow at the constant pressure.

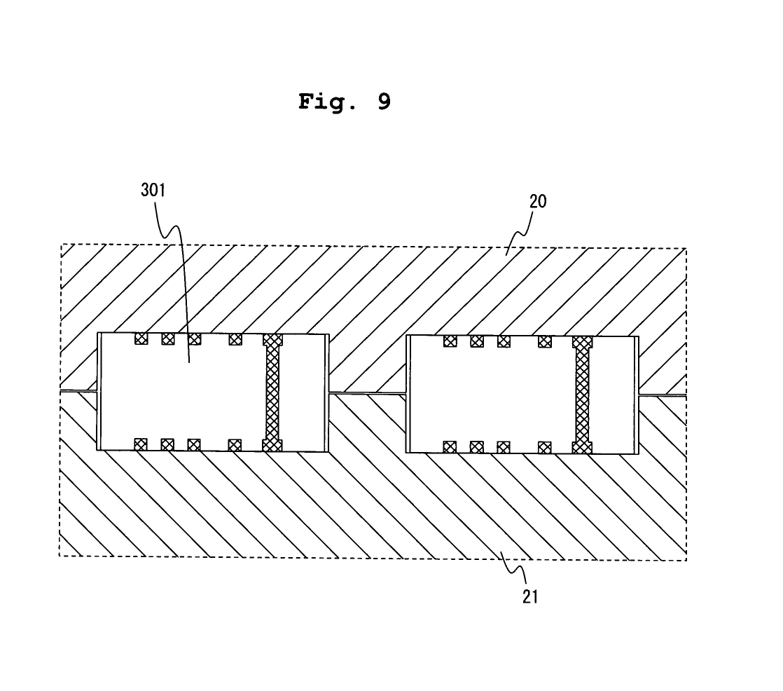

Subsequently, the mold 4′ was closed in the state in which the supercritical carbon dioxide was brought into contact with the surface of the plastic member 301. The openings of the recesses 302 and the through-holes 303 of the plastic members 301 were closed, and the supercritical carbon dioxide was made to remain in only the recesses 302 and the through-holes 303 (state shown in FIG. 9, Step S63 shown in FIG. 11). In this embodiment, this state was retained for 10 minutes.

In this procedure, the supercritical carbon dioxide is made to remain in only the recesses 302 and the through-holes 303 of the plastic members 301. Accordingly, the supercritical carbon dioxide makes contact with surfaces which define the recesses 302 and the through-holes 302 of the plastic member 301, via the solution 304 applied to the surface of the plastic members 301. Accordingly, the surface of the plastic member 301 as the thermoplastic resin swells, the viscosity thereof is lowered, and the surface is softened. Simultaneously, the liquid permeative substance 304 (polyethylene glycol), which is coated on the surface of the plastic members 301, is dissolved in the supercritical carbon dioxide. The permeative substance 304 is permeated into the surfaces which define the recesses 302 and the through-holes 303 of the plastic members 301, together with the supercritical carbon dioxide. When this method is used, the permeative substance can be uniformly permeated at a high concentration into only the surfaces which define the recesses 302 and the through-holes 303 of the plastic members 301.

In this embodiment, the steps (steps ranging from Steps S62 to S63 shown in FIG. 11) are performed in a short period of time (5 to 10 seconds in this embodiment) after the supercritical carbon dioxide is introduced into the mold 4′ and until the mold 4′ is closed to close the openings of the recesses 302 and the through-holes 303 of the plastic members 301. Therefore, the permeative substance is hardly permeated into the surface of each of the plastic members 301 which are different from the surfaces defining the recesses 302 and the through-holes 303 of the plastic member 301. However, if the period of time is long after the supercritical carbon dioxide is introduced into the mold 4′ and until the mold 4′ is closed, it is feared that the permeative substance, which is dissolved in the supercritical carbon dioxide, may be also permeated at a high concentration into the surface, of each of the plastic member 301, different from the surfaces defining the recesses 302 and the through-holes 303. Therefore, it is preferable that the steps, which are performed after the supercritical carbon dioxide is introduced into the mold 4′ and until the mold 4′ is closed, are performed in a period of time which is as short as possible.

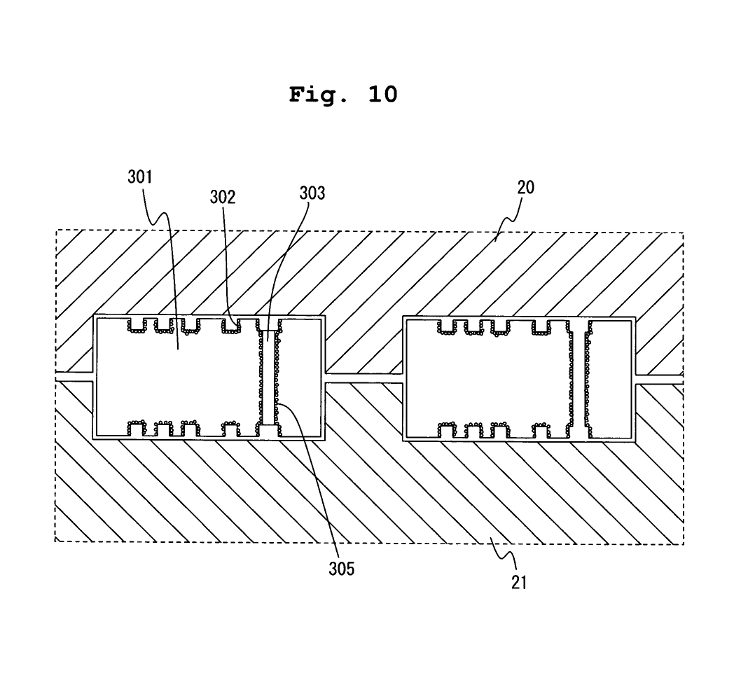

Subsequently, the power source of the heater of the mold 4′ was turned off. The cooling water was allowed to flow, and the mold 4′ was cooled to 40° C. When the internal pressure of the mold 4′ is lowered during the cooling, it is feared that foams may appear at the interior and the surface of the plastic member 301. Therefore, it is desirable that the external pressure is retained during the cooling. After that, the manual needle valve 8 was closed, and the valve 9 was simultaneously opened. The mold 4′ was open to the atmospheric air while recovering the permeative substance and the carbon dioxide to the recovery tank 5 (state shown in FIG. 10). After that, the plastic members 301, in which the permeative substance was permeated into the surfaces defining the recesses 302 and the through-holes 303, were taken out from the mold 4′.

Subsequently, the permeative substance 305 was removed from the plastic member 301 in which the permeative substance 305 (polyethylene glycol) was impregnated into only the surfaces defining the recesses 302 and the through-hole 303 by the method as described above (Step S64 shown in FIG. 11). Specifically, the plastic member 301 was immersed in pure water to perform the ultrasonic washing for 1 hour. Accordingly, the polyethylene glycol, which has been permeated into the surfaces defining the recesses 302 and the through-hole 303 of the plastic member 301, is disengaged to form the fine irregularities or convex and concave portions (pores) on the surfaces. That is, the physical shapes were selectively changed for only the surfaces defining the recesses 302 and the through-hole 303 of the plastic member 301 by the washing treatment as described above. In this embodiment, the surface of the plastic member 301 was modified as described above to obtain the plastic member 301 in which only the surfaces defining the recesses 302 and the through-hole 303 were modified.

### Method for Forming Plating Film

Subsequently, the electroless plating was applied in the same manner as in the first embodiment to the plastic member 301 manufactured by the surface modification method described above to form the plating film on the surface of the plastic member 301 (Steps S65 and S66 shown in FIG. 11). As a result, in this embodiment, the metal film was formed on only the surfaces defining the recesses 302 and the through-hole 303 of the plastic member 301. The plating film formed in this embodiment had no blister in the same manner as the plating films formed in the first to fourth embodiments. The adhesion strength based on the tape exfoliation test was satisfactory as well.

The surface roughness was measured for the plating film formed in this embodiment by using a stylus-type surface roughness measuring apparatus (produced by KLA-Tencor). As a result, the arithmetic mean deviation of the profile (Ra) was 25.6 nm, and the ten-point height of irregularities (Rz) was 179.8 nm. The values were extremely smaller than those of the plating film (Ra≈several μm to several tens μm) formed by the conventional plating method (method to perform the etching treatment). The satisfactory surface roughness (satisfactory smoothness) was obtained. That is, in this embodiment, the plastic molded article was successfully obtained, in which the electroless plating film having the high adhesion performance and the high smoothness was formed on the surface.

### Seventh Embodiment

In the seventh embodiment, an explanation will be made about an exemplary surface modification method wherein a plastic molded article (plastic member) is molded by the injection molding, simultaneously with which the permeative substance is permeated into the plastic member by using the pressurized fluid, and then the permeative substance is removed from the plastic member to perform the surface modification, and an exemplary method wherein the plating film (metal film) is formed on the surface of the plastic member obtained by the surface modification method.

In this embodiment, polycarbonate as a thermoplastic resin was used as the material for forming the plastic member, and polyethylene glycol having a molecular weight of 200 was used as the permeative substance. Supercritical carbon dioxide was used as the pressurized fluid.

### Molding Apparatus

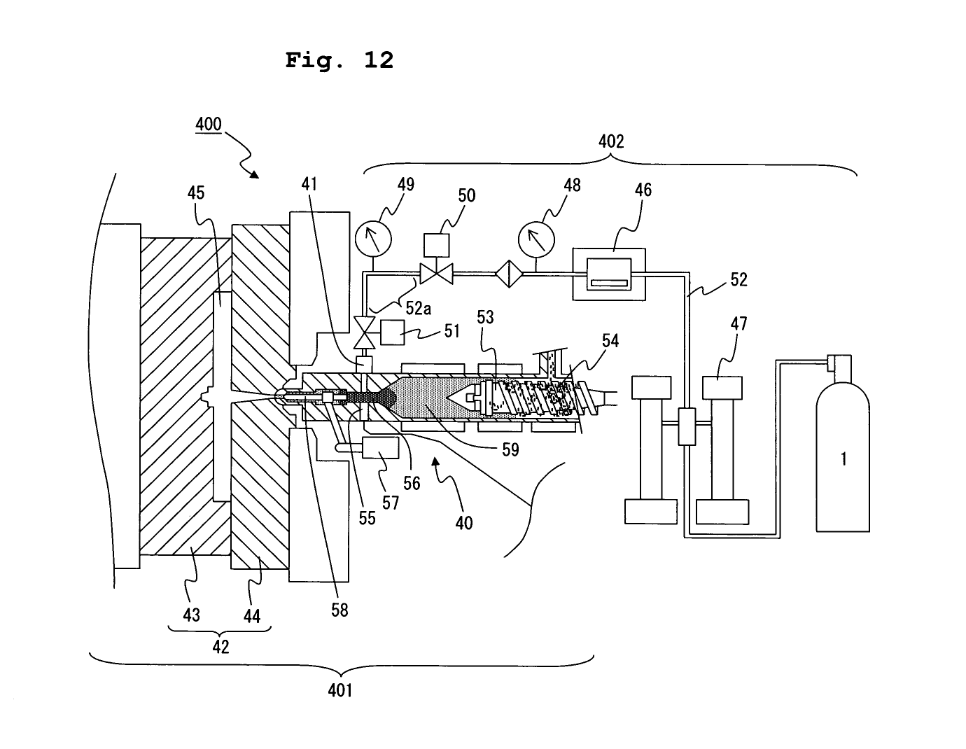

FIG. 12 is a schematic arrangement view of the molding apparatus used in this embodiment. As shown in FIG. 12, a molding apparatus 400 used in this embodiment includes an injection molding machine section 401 and a supercritical fluid-generating apparatus section 402.

As shown in FIG. 12, the injection molding machine section 401 is principally constructed of a plasticizing cylinder 40 which injects a melted resin, a movable mold 43, and a fixed mold 44. In a mold 42, the movable mold 43 abuts against the fixed mold 44, to thereby form a disk-shaped cavity 45 which has a spool at the center thereof. In this embodiment, as shown in FIG. 12, areas, of a surface of each of the movable mold 43 and the fixed mold 44, on the side of the cavity 45, which are different from a portion thereof (for example, the spool) corresponding to the center of the cavity 45, are flat surfaces (mirror surfaces). As shown in FIG. 12, a gas-introducing mechanism 41 is provided at a side portion of a flow front portion 56 in the heating cylinder 40 (plasticizing cylinder). The structures of the other components are the same as the structures of those of the conventional injection molding machine.

As shown in FIG. 12, a supercritical fluid-generating apparatus section 402 is principally constructed of a liquid carbon dioxide bomb 1, a continuous flow system 47 (E-260 produced by ISCO) which is constructed of two known syringe pumps, and a dissolving tank 46 in which the permeative substance is dissolved in the supercritical carbon dioxide. The respective constitutive components are connected to one another by a piping 52. As shown in FIG. 12, the dissolving tank 46 is connected to the gas-introducing mechanism 41 of the injection molding machine section 401 via air operate valves 50, 51.

### Injection Molding Method and Surface Modification Method

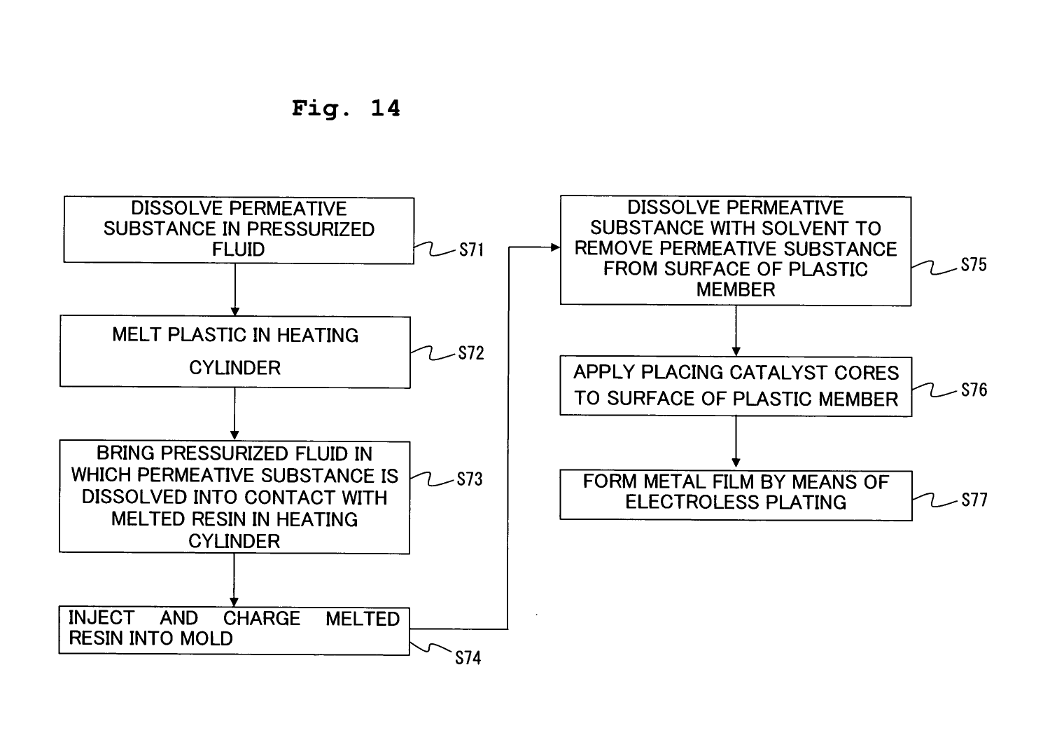

Next, an explanation will be made about a molding method and a surface modification method of this embodiment with reference to FIGS. 12 to 14. At first, the liquid carbon dioxide at 5 to 7 MPa, which is stored in the liquid carbon dioxide bomb 1, is introduced into the continuous flow system 47. The pressure is raised to generate the supercritical carbon dioxide (pressurized fluid). In the continuous flow system 47, the pressure of carbon dioxide is always raised and retained at 10 MPa as a predetermined pressure by at least one of the syringe pumps. Subsequently, the supercritical carbon dioxide was introduced from the continuous flow system 47 into the dissolving tank 46 to dissolve the permeative substance in the supercritical carbon dioxide (Step S71 shown in FIG. 14). The temperature of the dissolving tank 46 is raised to 40° C. The polyethylene glycol as the permeative substance is charged to the dissolving tank 46 so that the polyethylene glycol is in supersaturation. Therefore, in the dissolving tank 46, the permeative substance is always dissolved in the saturated state in the supercritical carbon dioxide introduced from the continuous flow system 47. In this situation, a pressure gauge 48 of the dissolving tank 46 indicated 10 MPa. The solubility of polyethylene glycol with respect to carbon dioxide is low. Therefore, in this embodiment, a carrier (Wet Support produced by ISCO) was used in order to increase the contact area of the supercritical carbon dioxide.

Subsequently, a screw 53 in the heating cylinder 40 was rotated in the same manner as in the conventional technique, and supplied resin pellets 54 were plasticized and melted (Step S72 shown in FIG. 14). The screw 53 was moved backwardly while extruding and weighing the melted resin at a front portion 59 in front of the screw 53, and the screw 53 was stopped at a predetermined weighing position. Subsequently, the screw 53 was further moved backwardly, and the internal pressure of the weighed melted resin was reduced. In this embodiment, it was confirmed that the internal pressure of the resin was lowered to not more than 4 MPa, with an internal pressure monitor 55 for the melted resin provided in the vicinity of the flow front portion 56 of the heating cylinder 40.

Subsequently, the supercritical carbon dioxide, in which the permeative substance was dissolved, was introduced via the gas-introducing mechanism 41 into the melted resin at the flow front portion 56 of the heating cylinder 40, and the supercritical carbon dioxide, in which the permeative substance was dissolved, was brought into contact with the melted resin (Step S73 shown in FIG. 14). Specifically, the supercritical carbon dioxide, in which the permeative substance was dissolved, was introduced as follows. At first, the first air operate valve 50 was opened, and the supercritical carbon dioxide, in which the permeative substance was dissolved, was introduced into the piping 52 between the second air operate valve 51 and the first air operate valve 50 so that the pressure at the pressure gauge 49 was raised. Subsequently, when the supercritical carbon dioxide in which the permeative substance was dissolved was introduced into the heating cylinder 40, then the second air operate valve 51 was opened in the state in which the first air operate valve 50 was closed, and the supercritical carbon dioxide, in which the permeative substance was dissolved, was introduced and permeated via the gas-introducing mechanism 41 into the melted resin in the reduced-pressure state in the heating cylinder 40. In this embodiment, the amount of introduction of the supercritical carbon dioxide was controlled by the internal volume of the piping 52a. The supercritical fluid, which is to be permeated into the melted resin, may be provided singly as in this embodiment. Alternatively, it is also allowable that a plurality of supercritical fluids are used.

Subsequently, the screw 53 was moved frontwardly by the back pressure force, and the screw 53 was returned to the charge start position. This operation allows the carbon dioxide and the permeative substance to diffuse into the melted resin at the flow front portion 56 in front of the screw 53. Subsequently, the air piston 57 was driven to open the shutoff valve 58, and the melted resin was injected and charged into the cavity 45 of the mold 42 defined by the movable mold 43 and the fixed mold 44 (Step S74 shown in FIG. 14).

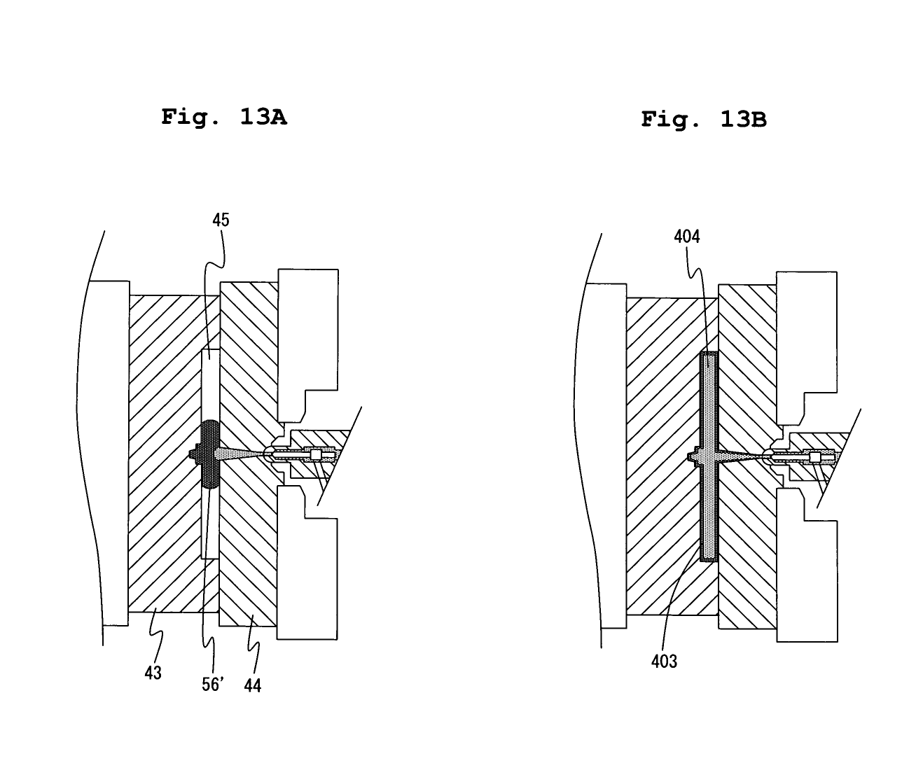

FIGS. 13A and 13B schematically show situations of the charging of the melted resin in the mold 42 during the injection and the charging. FIG. 13A schematically shows the initial charging state. In the initial charging state, a melted resin 56′ at the flow front portion 56 is charged, and the permeative substance and the carbon dioxide, which are permeated thereinto, are diffused into the cavity 45 while reducing the pressure. During this process, the melted resin 56′ at the flow front portion 56 is allowed to flow while making contact with the surface of the mold to form a skin layer 403 in accordance with the fountain effect during the charging operation.

Subsequently, when the injection charging is completed, as shown in FIG. 13B, the skin layer 403, which is impregnated with the permeative substance, is formed on the surface of the plastic member (molded article). A core layer 404, in which the permeative substance is scarcely permeated, is formed at the inner central portion of the molded article. Therefore, in the molding method of this embodiment, the permeative substance, which is permeated into the interior of the molded article, does not contribute to the surface function. Therefore, it is possible to reduce the amount of use of the permeative substance. When the holding pressure is raised for the melted resin pressure after the primary charging described above, it is possible to suppress the foaming of the molded article which would be otherwise caused by the gasification of carbon dioxide. In the molding method of this embodiment, the supercritical carbon dioxide is permeated into only the flow front portion in the plasticizing cylinder. Therefore, the absolute amount of carbon dioxide is small with respect to the total amount of the charge resin. Therefore, even when any counter pressure is not applied to the interior of the cavity 45 of the mold 42, the surface property of the plastic member is hardly deteriorated. In this embodiment, the plastic member was molded as described above, and the permeative substance was permeated into the surface thereof.

Subsequently, the plastic member, in which the permeative substance (polyethylene glycol) was impregnated into the surface thereof, was subjected to the ultrasonic washing for 1 hour in pure water, and the permeative substance, which was impregnated into the surface of the plastic member, was removed (Step S75 shown in FIG. 14). In accordance with the washing treatment, the fine irregularities or convex and concave portions (fine pores) were formed on the surface of the plastic member. That is, the surface shape of the plastic member was physically changed by the washing treatment. In this way, the surface modification was performed for the plastic member in this embodiment.

### Method for Forming Plating Film

Subsequently, the electroless plating was applied in the same manner as in the first embodiment to the plastic member manufactured by the surface modification method described above to form the plating film on the surface of the plastic member (Steps S76 and S77 shown in FIG. 14). As a result, the plating film formed in this embodiment had no blister in the same manner as the plating films formed in the first to fourth embodiments. The adhesion strength based on the tape exfoliation test was satisfactory as well.

The surface roughness was measured for the plating film formed in this embodiment, by using a stylus-type surface roughness measuring apparatus (produced by KLA-Tencor). As a result, the arithmetic mean deviation of the profile (Ra) was 15.2 nm, and the ten-point height of irregularities (Rz) was 105.8 nm. The values were extremely smaller than those of the plating film (Ra≈several μm to several tens μm) formed by the conventional plating method (method to perform the etching treatment). The satisfactory surface roughness (satisfactory smoothness) was obtained. That is, in this embodiment, the plastic member was successfully obtained, in which the electroless plating film having the excellent adhesion performance and the excellent smoothness was formed on the surface thereof.

### Eighth Embodiment

In the eighth embodiment, an explanation will be made about an exemplary surface modification method wherein a plastic member is molded by the injection molding, simultaneously with which the permeative substance is permeated into the plastic member by using the pressurized fluid, and then the permeative substance is removed from the plastic member to perform the surface modification, and an exemplary method wherein the plating film (metal film) is formed on the surface of the plastic member obtained by the surface modification method, in the same manner as in the seventh embodiment. However, in this embodiment, an explanation will be made about a method in which the plastic member having projections and recesses (convex and concave portions) on the surface is formed, only the recesses of the plastic member are subjected to the surface modification, and the plating film is formed on the recesses.

In this embodiment, polycarbonate as a thermoplastic resin was used as the material for forming the plastic member, and polyethylene glycol having a molecular weight of 200 was used as the permeative substance. Supercritical carbon dioxide was used as the pressurized fluid.

### Molding Apparatus

An apparatus, which was constructed in approximately the same manner as the molding apparatus used in the seventh embodiment (FIG. 12), was used as the molding apparatus used in this embodiment. In the molding apparatus of this embodiment, a stamper having a line-and-space concave/convex pattern was attached to a surface, of a fixed mold 43, on the side of the cavity 45. The molding apparatus had the same structure as that of the molding apparatus used in the seventh embodiment except for the above.

### Injection Molding Method and Surface Modification Method

At first, a plastic member, in which the permeative substance was permeated into the surface thereof, was manufactured in the same manner as in the seventh embodiment. Subsequently, the openings of the recesses of the plastic member were closed, and pure water heated to 80° C. was allowed to flow through only the recesses to remove only the permeative substance having been permeated into surfaces defining the recesses. As a result of the washing treatment, only the polyethylene glycol, which had been permeated into the surfaces defining the recesses of the plastic member, was disengaged, and fine irregularities or concave and convex portions (fine pores) were formed on the surfaces. That is, the physical shape was selectively changed, by the washing treatment, for only the surfaces defining the recesses of the plastic member. In this way, the plastic member subjected to the surface modification of this embodiment was obtained.

Various methods are conceivable as the washing treatment method for the recesses. However, in this embodiment, the washing treatment was performed for the recesses as follows. At first, a mold was prepared, which had two surfaces of a mirror-shaped mold surface and a mold surface onto which the stamper having the line-and-space concave/convex pattern was attached. The mold having the following structure was used as the mold. That is, the molded article was movable in the cavity between the mirror-shaped mold surface and the mold surface attached with the stamper having the concave/convex pattern. Subsequently, the plastic member, which had the recesses on the surface thereof and in which the permeative substance was permeated, was molded by using the mold surface attached with the stamper having the line-and-space concave/convex pattern (primary molding). Subsequently, the plastic member was moved so that the recesses of the plastic member were opposed to or facing the mirror-shaped mold surface. Subsequently, the plastic member was pressed with the mirror-shaped mold surface to close the openings of the recesses of the plastic member. Subsequently, pure water was allowed to flow through only the closed recesses to remove only the permeative substance permeated into the surfaces which defines the recesses. However, the method for closing the openings of the recesses of the plastic member is not limited to this. For example, the openings may be closed by the following method. At first, two surfaces of a mirror-shaped mold surface and a mold surface to be attached with a stamper having a concave/convex pattern are provided for a movable mold. The mold surface attached with the stamper having the concave/convex pattern is used to mold the plastic member which has the recesses on the surface and which is permeated with the permeative substance. Subsequently, the mirror-shaped mold surface of the movable mold is moved to the position opposed to or facing the surface of the plastic member. The plastic member is pressed with the mirror-shaped mold surface to close the openings of the recesses of the plastic member. Alternatively, the following method is also allowable. That is, a first mold and a second mold are individually prepared, the first mold having a mold surface attached with a stamper having a concave/convex pattern, and the second mold having a mirror-shaped mold surface. The first mold is used to mold the plastic member which has the recesses on the surface and which is permeated with the permeative substance. After that, the plastic member is moved to the second mold to close the openings of the recesses of the plastic member by the mirror-shaped mold surface.

### Method for Forming Plating Film

Subsequently, the electroless plating was applied in the same manner as in the first embodiment to the plastic member manufactured by the surface modification method described above to form the plating film on the surface of the plastic member. In this embodiment, only the surfaces defining the recesses of the plastic member are subjected to the surface modification, and the fine irregularities are formed on the surfaces. Therefore, in this embodiment, the plating film was formed on only the surfaces which defines the recesses of the plastic member. Further, the plating film formed in this embodiment had no blister in the same manner as the plating films formed in the first to fourth embodiments. The adhesion strength based on the tape exfoliation test was satisfactory as well.

The surface roughness was measured for the plating film formed in this embodiment by using a stylus-type surface roughness measuring apparatus (produced by KLA-Tencor). As a result, the arithmetic mean deviation of the profile (Ra) was 15.8 nm, and the ten-point height of irregularities (Rz) was 120.8 nm. The values were extremely smaller than those of the plating film (Ra≈several μm to several tens μm) formed on the plastic base material by the conventional plating method (method to perform the etching treatment). The satisfactory surface roughness (satisfactory smoothness) was obtained. That is, in this embodiment, the plastic member was successfully obtained, in which the electroless plating film having the excellent adhesion performance and the excellent smoothness was formed on the surface.

### Ninth Embodiment

In the ninth embodiment, an explanation will be made about an exemplary surface modification method wherein a plastic member is molded by the injection molding, simultaneously with which the permeative substance is permeated into the plastic member by using the pressurized fluid, and then the permeative substance is removed from the plastic member to perform the surface modification, and an exemplary method wherein the plating film (metal film) is formed on the surface of the plastic member obtained by the surface modification method. However, in this embodiment, two different types of permeative substances were dissolved in the pressurized fluid, and the two types of permeative substances were permeated into the surface of the plastic member. Those used as the two permeative substances were ε-caprolactam (first permeative substance) as a water-soluble polymer having a molecular weight of 113.16 and hexafluoroacetylacetonato palladium (II) (second permeative substance) as a metal complex. Polycarbonate as a thermoplastic resin was used as the material for forming the plastic member, and supercritical carbon dioxide was used as the pressurized fluid.

### Molding Apparatus

An apparatus, which was constructed in approximately the same manner as the molding apparatus used in the seventh embodiment (FIG. 12), was used as the molding apparatus used in this embodiment. In the molding apparatus of this embodiment, the two types of permeative substances described above were charged to the dissolving tank 46 so that both of the two types of permeative substances were in supersaturation. Those other than the above were constructed in the same manner as in the seventh embodiment.

### Injection Molding Method and Surface Modification Method

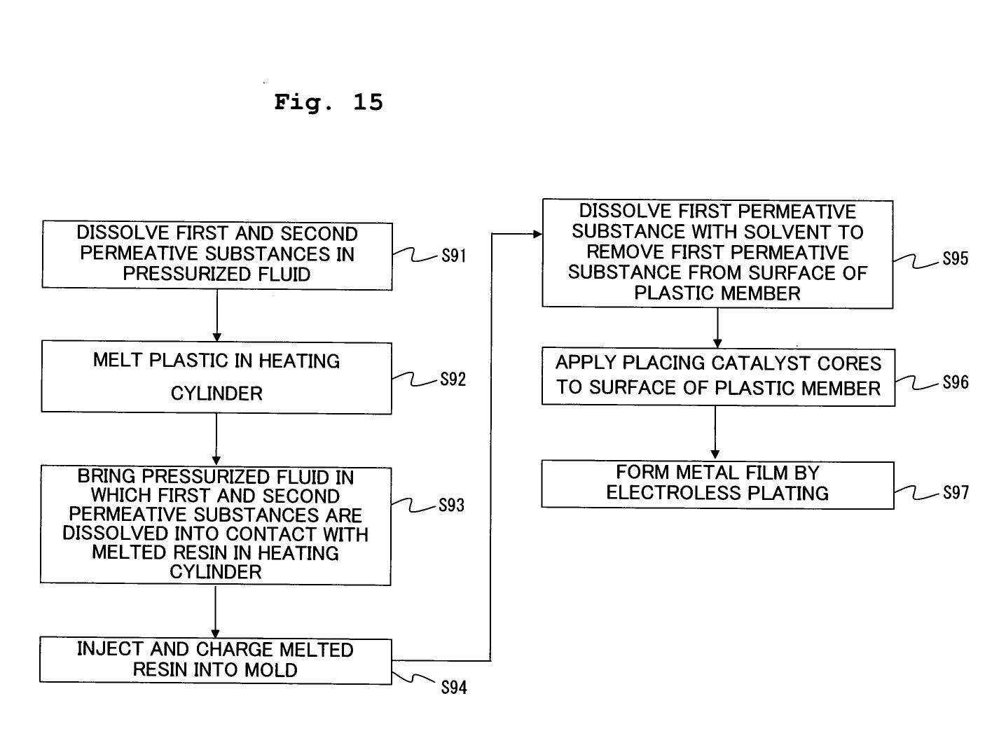

Next, the molding method and the surface modification method of this embodiment will be explained with reference to FIG. 15. At first, in the same manner as in the seventh embodiment, the supercritical carbon dioxide, in which the two types of permeative substances (first and second permeative substances) were dissolved, was introduced into the melted resin in the heating cylinder to manufacture the plastic member in which the two types of permeative substances were impregnated into the surface thereof (Steps S91 to S94 shown in FIG. 15). In the molding process, a greater part of the impregnated metal complex is reduced into metallic fine particles by the heat of the melted resin. Subsequently, the plastic member was ultrasonically washed for 1 hour in pure water (Step S95 shown in FIG. 15). In this washing treatment, ε-caprolactam (first permeative substance), which is the water-soluble polymer and which is included in the permeative substances permeated into the plastic member, is disengaged from the surface of the plastic member, and fine irregularities or convex and concave portions (fine pores) are formed on the surface. The metallic fine particles, which are the other permeated permeative substance, are scarcely removed by the washing treatment to retain a state in which the metallic fine particles are impregnated into the surface of the plastic member. In this embodiment, the surface modification was performed for the plastic member as described above.

### Method for Forming Plating Film

Subsequently, the electroless plating was applied in the same manner as in the first embodiment to the plastic member manufactured by the surface modification method described above to form the plating film on the surface of the plastic member (Steps S96 and S97 shown in FIG. 15). As a result, the plating film formed in this embodiment had no blister in the same manner as the plating films formed in the first to fourth embodiments. The adhesion strength based on the tape exfoliation test was satisfactory as well. In this embodiment, the fine irregularities were not only formed on the surface of the plastic member, but the metallic fine particles to serve as the catalyst cores for the plating film were also impregnated into the surface of the plastic member. Therefore, the plating film, which was more excellent in the adhesion performance, was successfully formed owing to the presence of the placing catalyst cores and the anchoring effect brought about by the fine irregularities.

The surface roughness was measured for the plating film formed in this embodiment by using a stylus-type surface roughness measuring apparatus (produced by KLA-Tencor). As a result, the arithmetic mean deviation of the profile (Ra) was 18.8 nm, and the ten-point height of irregularities (Rz) was 129.0 nm. The values were extremely smaller than those of the plating film (Ra≈several μm to several tens μm) formed by the conventional plating method (method to perform the etching treatment). The satisfactory surface roughness (satisfactory smoothness) was obtained. That is, in this embodiment, the plastic member was successfully obtained, in which the electroless plating film having the excellent adhesion performance and the excellent smoothness was formed on the surface.

### Tenth Embodiment

In the tenth embodiment, an explanation will be made about an exemplary surface modification method for a plastic member wherein a plastic sheet, which has the permeative substance at least on the surface thereof, is manufactured by the extrusion molding, the plastic member is thereafter manufactured by performing the insert (in-mold) molding by using the plastic sheet, and then the permeative substance is removed; and an exemplary method wherein the plating film (metal film) is formed on the surface of the plastic member obtained by the surface modification method.

Any arbitrary resin material may be used for the plastic sheet or the sheet made of plastic provided that the resin material is any thermoplastic resin capable of being subjected to the extrusion molding. However, in this embodiment, polycarbonate was used. Any arbitrary material may be used to be permeated into the plastic sheet. However, in this embodiment, polyethylene glycol was used as the permeative substance. In this embodiment, liquid supercritical carbon dioxide was used as the pressurized fluid.

### Molding Apparatus

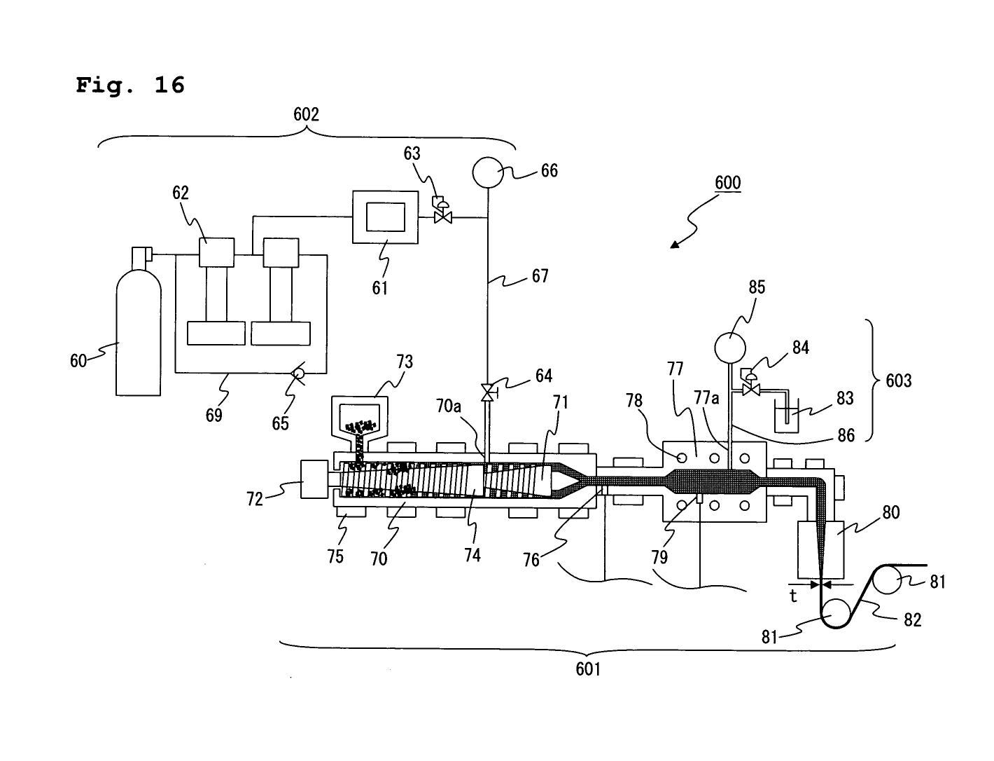

At first, an explanation will be made about the molding apparatus used to manufacture the plastic sheet. FIG. 16 shows a schematic arrangement view of the molding apparatus used in this embodiment. As shown in FIG. 16, a molding apparatus 600 used in this embodiment is mainly constructed of an extrusion molding machine section 601, a carbon dioxide supply section 602, and a carbon dioxide discharge section 603.

As shown in FIG. 16, the extrusion molding machine section 601 principally includes a plasticizing melting cylinder 70 (hereinafter referred to as “heating cylinder” as well), a hopper 73 which supplies resin pellets into the heating cylinder 70, a motor 72 which rotates a screw 71 disposed in the heating cylinder 70, a cooling jacket 77, a die 80 which performs the extrusion while thinning the wall thickness of the melted resin and expanding the melted resin in a fan-like form, and a cooling roller 81. A single screw having a vent structure section 74 to serve as a pressure-reducing section was used as the screw 71.

The structure and the system of the extrusion die 80 are arbitrary, and may be appropriately designed depending on, for example, the shape and the way of use of the molded article to be manufactured. However, in this embodiment, a T die for molding the film was used as the extrusion die 80. In the molding apparatus 600 of this embodiment, the plastic sheet 82, which is extruded from the T die 80, is wound, for example, by the cooling roller 81. In this embodiment, a gap t at the die extrusion port of the T die 80 was set to 0.5 mm.

In the molding apparatus 600 of this embodiment, as shown in FIG. 16, a carbon dioxide-introducing port 70a was provided in the vicinity of the vent mechanism section 74 of the single screw 71 at which the melted resin was subjected to the pressure reduction. In the molding apparatus 600 of this embodiment, as shown in FIG. 16, the monitors for measuring the internal pressure of the resin were provided at a connecting portion (monitor 76) at which the heating cylinder 70 and the cooling jacket 77 are connected and in the cooling jacket 77 (monitor 79).

As shown in FIG. 16, the carbon dioxide supply section 602 principally includes a carbon dioxide bomb 60, a syringe pump 62, a dissolving tank 61, a back pressure valve 63, a valve 64, a pressure gauge 66, and a piping 67 for connecting these constitutive components. As shown in FIG. 16, the downstream side (secondary side) of the valve 64 is connected via the piping 67 to the carbon dioxide-introducing port 70a of the heating cylinder 70, and is communicated with the flow passage for the melted resin in the heating cylinder 70. The place or position, at which the carbon dioxide is to be introduced, is not limited this, and may be provided at any arbitrary position provided that the position is in the area ranging from the screw 71 to the T die 80.

As shown in FIG. 16, the carbon dioxide discharge section 603 principally includes an extraction vessel 83 which discharges the carbon dioxide, a back pressure valve 84, a pressure gauge 85, and a piping 86 connecting these constitutive components. As shown in FIG. 16, the upstream side (primary side) of the back pressure valve 84 is connected to the carbon dioxide discharge port 77a of the cooling jacket 77 via the piping 86, and is communicated with the flow passage for the melted resin in the cooling jacket 77.

In the extrusion molding machine section 601 of this embodiment, any form, which is the same as or equivalent to the form of each of the mechanisms of any known extrusion molding machine, may be used for each of the mechanisms including, for example, the screw 71, the heating cylinder 70, and the die 80.

### Method for Molding Plastic Sheet

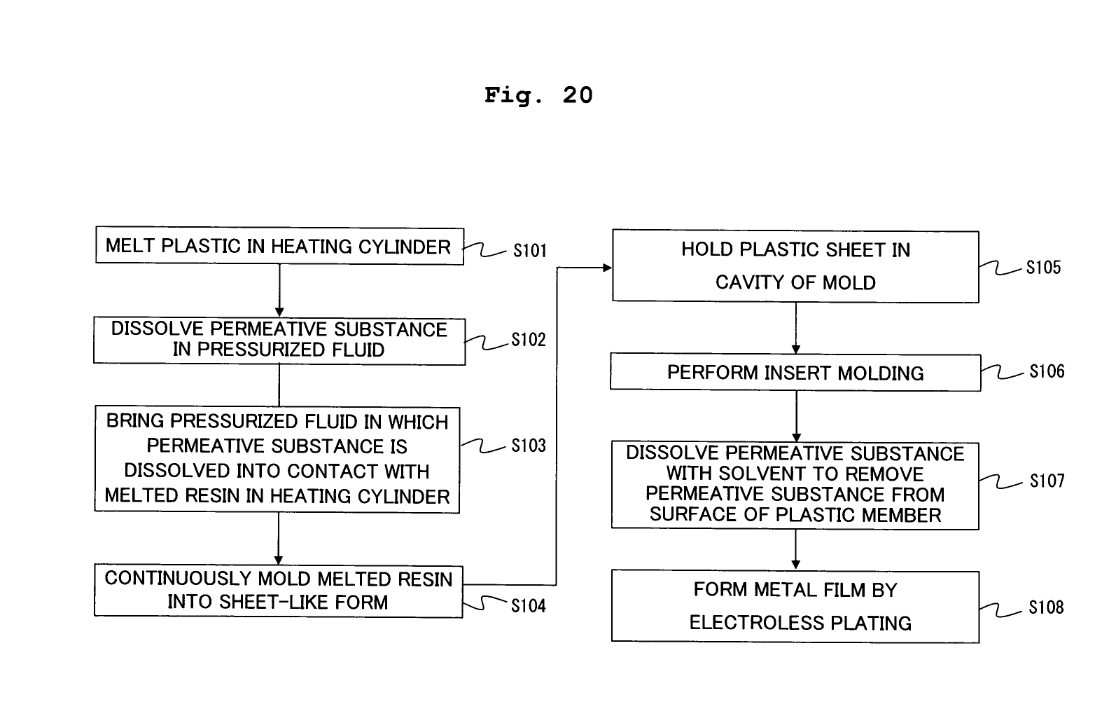

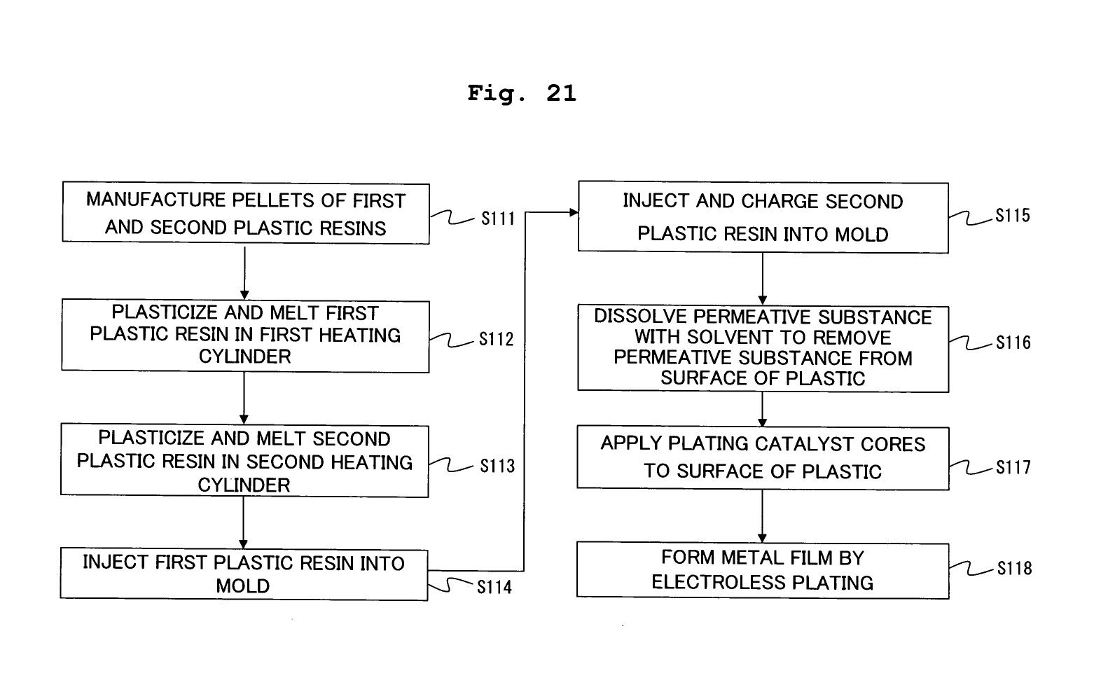

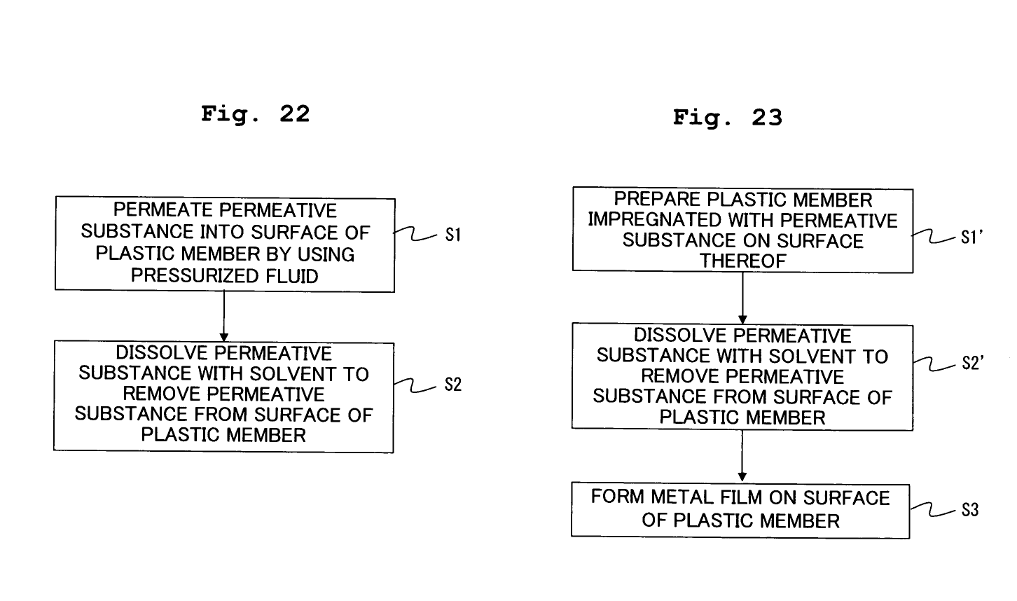

Next, an explanation will be made with reference to FIGS. 16 and 20 about the method for molding the plastic sheet in this embodiment. At first, pellets of the resin material (polycarbonate) were supplied in a sufficient amount to the hopper 73 of the extrusion molding machine section 601. The resin material was plasticized and melted by rotating the screw 71 by the motor 72, and the melted resin was fed to the forward end of the heating cylinder 70 (Step S101 shown in FIG. 20). During this process, the temperature of the heating cylinder 70 was regulated to 280° C. by a band heater 75.

Subsequently, the pressurized carbon dioxide (pressurized fluid) was allowed to flow in the dissolving tank 61 in which the permeative substance was previously charged, and thus the permeative substance was dissolved in the pressurized carbon dioxide (Step S102 shown in FIG. 20). Specifically, the permeative substance was dissolved in the pressurized carbon dioxide as follows. At first, the liquid carbon dioxide, which was supplied from the carbon dioxide bomb 60, was subjected to the pressure increase and the pressure adjustment by the syringe pump 62, and the pressure was adjusted so that the pressure gauge 66 indicated 15 MPa. The pressure-raised carbon dioxide was allowed to flow in the dissolving tank 61 which was temperature-regulated to 40° C. and in which the permeative substance was charged to provide the supersaturation state. The permeative substance was dissolved in the pressurized carbon dioxide.

Subsequently, the valve 64 was opened, and the pressurized carbon dioxide, in which the permeative substance was dissolved, was introduced into the vent structure section 74 of the heating cylinder 70 via the piping 67 and the introducing port 70a. The permeative substance was permeated by bringing the permeative substance into contact with the melted resin together with the pressurized carbon dioxide (Step S103 shown in FIG. 20). During this process, the flow rate of the pressurized carbon dioxide was controlled by the syringe pump 62, and the pressurized carbon dioxide dissolved with the permeative substance was introduced at a constant flow rate while controlling the pressure of the pressurized carbon dioxide by the back pressure valve 63. During this process, the pressurized carbon dioxide and the permeative substance (polyethylene glycol), which were injected into the melted resin at the vent structure section 74, were kneaded into the resin in accordance with the rotation of the screw 71.

Subsequently, the melted resin was extruded from the heating cylinder 70 while making the adjustment so that the pressure of the melted resin kneaded with the pressurized carbon dioxide and the permeative substance was raised to 20 MPa as indicated by the monitor 76 for the internal pressure of the resin.

Subsequently, the melted resin, which was extruded from the heating cylinder 70, was allowed to pass through the cooling jacket 77. The cooling jacket 77 is cooled to 200° C. by temperature-regulating water allowed to flow through a cooling water passage 78 provided in the cooling jacket 77. In the molding apparatus 600 of this embodiment, as shown in FIG. 16, the cross-sectional area of the flow passage for the melted resin in the cooling jacket 77 is larger than the cross-sectional area of the flow passage for the melted resin at the connecting portion between the heating cylinder 70 and the cooling jacket 77. Therefore, when the melted resin passes through the cooling jacket 77, the pressure is reduced simultaneously with the cooling. In this embodiment, when the melted resin passes through the cooling jacket 77, the resin internal pressure monitor 79 of the pressure-reducing section indicated 10 MPa.

Subsequently, the melted resin, which was extruded from the cooling jacket 77, was allowed to pass through the T die 80. The resin 82, which was extruded from the T die 80, was wound, for example, by the cooling roller 81, and the rein 82 was continuously molded into the film-like form (sheet form) (Step S104 shown in FIG. 20). In this embodiment, the rein 82 was thinned by an unillustrated drawing apparatus to manufacture a plastic sheet having a thickness of 0.1 mm. In this way, the plastic sheet, in which the polyethylene glycol was dispersed in the surface and the interior thereof, was obtained.

### Insert Molding

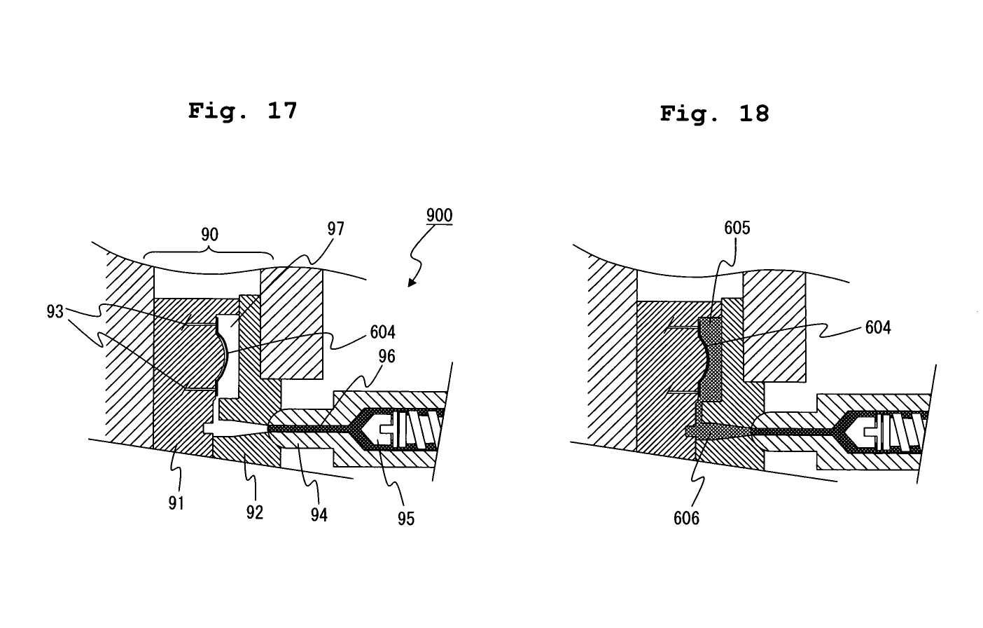

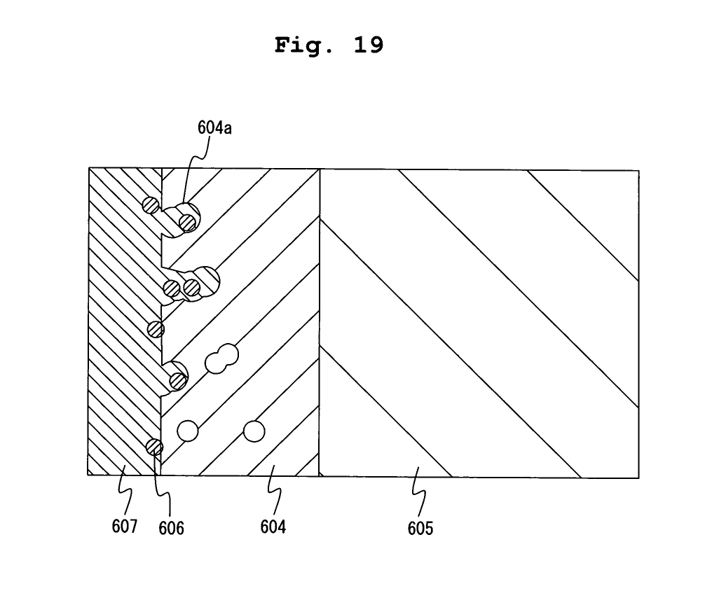

Subsequently, an explanation will be made with reference to FIGS. 17 and 18 about a method for manufacturing the plastic member by the insert (in-mold) molding by using the plastic sheet manufactured by the extrusion molding as described above. An injection molding machine 900 used in the insert molding of this embodiment had the structure which was the same as or equivalent to that of the conventional one.

At first, as shown in FIG. 17, the plastic sheet 604, which was manufactured by the extrusion molding as described above, was held on a surface of a movable mold 91 of a mold 90, the surface being on the side of a cavity 97 (Step S105 shown in FIG. 20). In this embodiment, a movable mold 91 was used, in which a surface on the side of the cavity 97 had a mirror curved surface shape. The plastic sheet 604 was held on the surface having the mirror curved surface shape. The cavity 97 in the mold 90 is the space defined by the fixed mold 92 and the movable mold 91. In this embodiment, the plastic sheet 604 was held by attracting the plastic sheet 604 onto the surface of the movable mold 91 by using a vacuum circuit 93 of the movable mold 91. In this procedure, as shown in FIG. 17, it is also allowable that the plastic sheet 604 is not completely attached or adhered tightly to the surface of the movable mold 91. It is also allowable that any gap is partially formed between the plastic sheet 604 and the surface of the movable mold 91. In this embodiment, various types of known adhesive layers may be provided on the surface of the resin film 604 in order to improve the adhesion performance between the plastic sheet 604 and the mold surface and/or the resin material to be injected during the insert molding.

Subsequently, the plasticized and melted resin 96 was injected and charged into the cavity 97 via a spool 95 of the injection molding machine 900 by the screw 95 of the injection molding machine 900 in the state in which the plastic sheet 604 was held in the cavity 97 of the mold 90 (insert molding, Step S106 shown in FIG. 20). During this process, as shown in FIG. 18, the plastic sheet 604 is adhered to the mold surface with the injected resin (gap disappears between the plastic sheet 604 and the mold surface), and the plastic sheet 604 is molded to have a predetermined shape (mirror shape). In this way, in this embodiment, the plastic member was obtained, in which the plastic sheet 604 and the molded article base material 605 were integrated into one body.

In this procedure, the plastic sheet 604 is plastically deformed or melted by the melted resin in some cases. However, the quality of the metal film on the surface of the molded article is not affected thereby at all. In this embodiment, the plastic sheet 604, which has the elasticity to some extent, is subjected to the insert molding. Therefore, any crack does not appear in the film held in the mold, which would be otherwise caused when the metal film is subjected to the insert molding as performed in the conventional technique.

In the method for producing the plastic member of this embodiment, any resin material may be used as the charging resin material to be subjected to the injection molding during the insert (in-mold) molding. For example, it is possible to use synthetic fiber such as those based on polyester, polypropylene, polymethyl methacrylate, polycarbonate, amorphous polyolefin, polyetherimide, polyethylene terephthalate, liquid crystal polymer, ABS resin, polyamideimide, biodegradable plastic such as polylactic acid, nylon resin, and composite materials thereof. It is also possible to use resin materials kneaded, for example, with various inorganic fillers including, for example, glass fiber, carbon fiber, and nanocarbon. The type of the charging resin material may be the same as or different from that of the material for the plastic sheet. However, it is preferable to use the same material in order to enhance the adhesion performance with respect to the material for the plastic sheet. In this embodiment, the same material as the material for the plastic sheet, i.e., polycarbonate was injected and charged by the insert molding. However, a polycarbonate material in which 30% of glass fiber is added and which had a deflection temperature under load (ISO 75-2) of 148° C. was used.

In the method for producing the plastic member of this embodiment, the permeation amount and the permeation depth of the permeative substance can be controlled for the plastic member after the insert molding by controlling, for example, the film thickness of the plastic sheet impregnated with the permeative substance.

The surface roughness was measured for the plastic member obtained by the insert molding in this embodiment described above by using a stylus-type surface roughness measuring apparatus (produced by KLA-Tencor). The arithmetic mean deviation of the profile (Ra) was 5 nm, and the ten-point height of irregularities (Rz) was 8 nm.

Subsequently, the plastic member, in which the plastic sheet 604 and the molded article base material 605 were integrated into one body, was taken out from the injection molding machine 900. After that, the plastic member was ultrasonically washed for 30 minutes in an ethanol solvent to remove the polyethylene glycol having been dispersed in the vicinity of the surface of the plastic sheet (Step S107 shown in FIG. 20). As a result of this step, fine pores were formed at portions from which the polyethylene glycol was removed, and fine irregularities were formed on the surface of the plastic member. In this embodiment, the surface modification was performed for the plastic member as described above.

As described above, in the method for modifying the surface of the plastic member of this embodiment, the low molecular weight component (polyethylene glycol in this embodiment), which is different from the material for each of the plastic sheet and the molded article base material, is removed by the solvent from the plastic sheet. Therefore, the resin molded article, in which the fine pores are formed on at least the surface of the molded article, is obtained. The timing of the process is arbitrary to remove the low molecular weight component from the plastic sheet. The removing process may be performed either before or after the insert molding. The size of the fine pore can be regulated within a range of several nm order to micron order depending on the molecular weight of the low molecular weight component (permeative substance) and the condition under which the low molecular weight component is extracted and removed from the plastic sheet.

The surface roughness was measured in the same manner as in the first embodiment for the plastic member manufactured as described above in which the fine pores were formed on the surface. As a result, the arithmetic mean deviation of the profile (Ra) was 15 nm, and the ten-point height of irregularities (Rz) was 130 nm. The surface roughness was increased as compared with the plastic member before removing the permeative substance, i.e., after performing the insert molding. This indicates the fact that the low molecular weight component (polyethylene glycol), which had been dispersed on the surface of the plastic member, was removed, and the fine pores were formed. However, considering the fact that the surface of the molded article is roughened to an extent of several μm to several tens μm in the case of the etching treatment with chromic acid and/or permanganic acid performed in the conventional plating step, it has been revealed that the satisfactory surface roughness (satisfactory smoothness) is obtained in the case of the plastic member subjected to the surface modification in this embodiment as compared with any molded article roughened by the conventional etching treatment.

### Method for Forming Plating Film

Subsequently, in this embodiment, the electroless copper plating was applied in the same manner as in the first embodiment to the plastic member from which the polyethylene glycol had been removed to form the plating film (Step S108 shown in FIG. 20). The ultrasonic vibration was applied in order to facilitate the immersion of the plating film and the catalyst cores onto the plastic sheet in the step of applying the catalyst and the conditioner. As a result, the plating film formed in this embodiment had no blister in the same manner as the plating films formed in the first to fourth embodiments. The adhesion strength was satisfactory as well, which was based on the cross-hatch tape exfoliation test.

FIG. 19 shows a magnified schematic sectional view illustrating those disposed in the vicinity of the resin film of the plastic member in which the plating film is formed on the surface thereof as described above. In the plastic member manufactured in this embodiment, the permeative substance (polyethylene glycol), which is dispersed in the vicinity of the surface of the plastic sheet, is removed. Therefore, as shown in FIG. 19, fine pores 604a are partially formed on the surface of the plastic sheet 604 formed on the molded article base material 605. It is considered that the catalyst cores and the plating film 607 are immersed in the fine pores in accordance with the electroless plating, the anchoring effect is obtained by the aid of the fine pores 604a on the surface of the plastic sheet 604, and the firm adhesion strength of the plating film is obtained. That is, in the case of the plastic member formed with the plating film of this embodiment, the firm anchoring effect can be obtained in the state in which the surface is maintained to be as smooth as possible. Further, in the method for forming the plating film of the plastic member of this embodiment, the plating film can be easily formed on the rein material which has been incapable of being sufficiently roughened by any conventional etching, including, for example, cycloolefin polymer, non-plating grade of polycarbonate, and liquid crystal polymer. On the other hand, in the method for forming the plating film of this embodiment, a surfactant may be used so that the colloid of the palladium catalyst is easily adsorbed to the molded article base material, in the same manner as in the conventional technique.

### Eleventh Embodiment

In the eleventh embodiment, an explanation will be made about an exemplary method for modifying the surface of a plastic member without using the pressurized fluid and an exemplary method for forming the plating film on the surface of the plastic member. In this embodiment, polyethylene glycol as a water-soluble polymer (molecular weight: 200) was used as the permeative substance, and polycarbonate was used as the material for forming the plastic member. An explanation will be made below with reference to FIG. 21 about the procedure of this embodiment ranging from the method for molding the plastic member and the surface modification method to the method for forming the plating film.

### Molding Method and Surface Modification Method

At first, in this embodiment, the polycarbonate as the material for forming the plastic member and the polyethylene glycol as the permeative substance were kneaded in a known extrusion molding machine to manufacture pellets (first plastic resin). Specifically, the materials were supplied to the extrusion molding machine while the mixing ratio of the polyethylene glycol with respect to the polycarbonate was 30%, and the resin was extruded from a die provided at the forward end of the nozzle while melting and kneading the resin with the screw. The obtained molded article was cooled in a cooling bath, followed by being granulated with a pelletizer. In this procedure, any modification may be applied, for example, such that the terminal group is modified with an additive to improve the affinity in order to homogeneously knead the polycarbonate and the polyethylene glycol. In this embodiment, pellets (second plastic resin), which were composed of polycarbonate containing no polyethylene glycol, were manufactured by using a known extrusion molding machine (Step S111 shown in FIG. 21). In the present invention, any arbitrary material for forming the plastic member is allowable provided that the material is a thermoplastic resin capable of being subjected to the extrusion molding.

Subsequently, the plastic member was molded by the known sandwich molding by using the two types of pellets obtained by the method described above. A sandwich molding apparatus used in this embodiment is a known sandwich molding machine including two heating cylinders and a mold communicated with forward end nozzles thereof, wherein the melted resin is injected into the mold from one heating cylinder among the two heating cylinder (hereinafter referred to as “first heating cylinder” as well), and then the melted resin is injected and charged from the other heating cylinder (hereinafter referred to as “second heating cylinder” as well) to perform the molding. In the sandwich molding of this embodiment, the plastic member was molded as follows.

At first, pellets of the polycarbonate (first plastic resin) containing the permeative substance were supplied into the first heating cylinder, and the pellets were plasticized and melted (Step S112 shown in FIG. 21). On the other hand, pellets of the polycarbonate (second plastic resin) containing no permeative substance were supplied into the second heating cylinder, and the pellets were plasticized and melted (Step S113 shown in FIG. 21). Subsequently, the melted resin of polycarbonate containing the permeative substance was injected from the first heating cylinder into the mold (Step S114 shown in FIG. 21). Subsequently, the injection passage for the melted resin was switched into the second heating cylinder, and the melted resin of polycarbonate containing no permeative substance was injected and charged from the second heating cylinder into the mold (Step S115 shown in FIG. 21). As a result, the plastic member was obtained, which had a core layer composed of the polycarbonate containing no permeative substance and a skin layer composed of the polycarbonate containing the permeative substance formed on the core layer. In this embodiment, the plastic member, in which the permeative substance was impregnated into the surface, was manufactured as described above. The method for molding the plastic member is not limited to the sandwich molding. It is also allowable to use, for example, the insert molding and the two-color molding.

The plastic member, which was manufactured by the sandwich molding as described above, was ultrasonically washed for 1 hour in pure water (Step S116 shown in FIG. 21). Accordingly, the polyethylene glycol, which had been permeated into the surface (skin layer) of the plastic member, was disengaged, and the fine irregularities or convex and concave portions (fine pores) were formed on the surface of the plastic member. That is, the surface shape of the plastic member was changed by the washing treatment. In this embodiment, the surface modification was performed for the plastic member as described above.

### Method for Forming Plating Film

Subsequently, the electroless plating was applied in the same manner as in the first embodiment to the plastic member manufactured by the surface modification method described above to form the plating film on the surface of the plastic member (Steps S117 and S118 shown in FIG. 21). As a result, the plating film formed in this embodiment had no blister in the same manner as the plating films formed in the first to fourth embodiments. The adhesion strength based on the tape exfoliation test was satisfactory as well.

The surface roughness was measured for the plating film formed in this embodiment by using a stylus-type surface roughness measuring apparatus (produced by KLA-Tencor). As a result, the arithmetic mean deviation of the profile (Ra) was 16.2 nm, and the ten-point height of irregularities (Rz) was 125.8 nm. The values were extremely smaller than those of the plating film (Ra≈several μm to several tens μm) formed on the plastic base material by the conventional plating method (method to perform the etching treatment). The satisfactory surface roughness (satisfactory smoothness) was obtained. That is, in this embodiment, the plastic member was successfully obtained, in which the electroless plating film having the excellent adhesion performance and the excellent smoothness was formed on the surface.

In the first to fifth embodiments and in the seventh to tenth embodiments, the examples have been explained, in which the permeative substance is dissolved in the pressurized fluid in the dissolving tank. However, the present invention is not limited to these. For example, it is also allowable to use a storage container such as a bomb which is previously charged with the pressurized fluid in which the permeative substance was dissolved. The pressurized fluid, in which the permeative substance is dissolved, may be directly supplied (introduced) from the storage container to the plastic member (or the melted resin).

### Twelfth Embodiment

In the twelfth embodiment, an explanation will be made about an exemplary surface modification method for a plastic member wherein a plastic sheet, which has the permeative substance at least on the surface thereof, is manufactured, the plastic member is manufactured by performing the insert (in-mold) molding by using the plastic sheet, and then the permeative substance is removed; and an exemplary method wherein the plating film (metal film) is formed on the surface of the plastic member obtained by the surface modification method, in the same manner as in the tenth embodiment. However, the method for manufacturing the plastic sheet having the permeative substance on the surface, which was used in this embodiment, was different from the method used in the tenth embodiment. In this embodiment, the supercritical carbon dioxide was used as the extraction solvent for the permeative substance when the permeative substance was removed.

### Method for Manufacturing Plastic Sheet

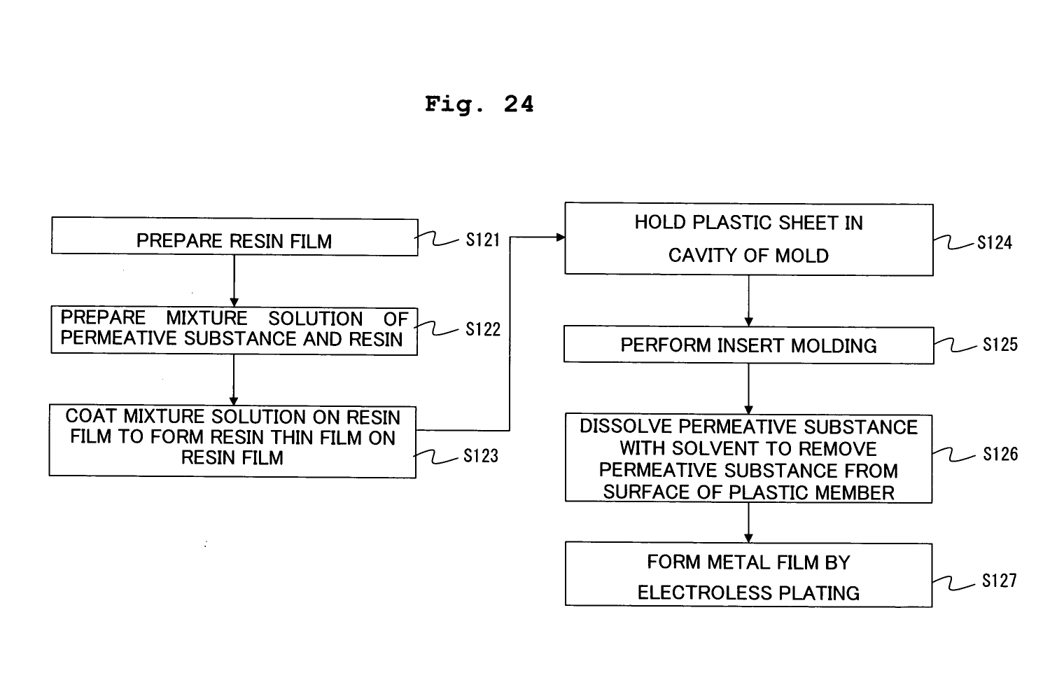

The method for manufacturing the plastic sheet of this embodiment will be explained with reference to FIG. 24. At first, a film-like resin base material (resin film), which contained no permeative substance, was prepared (Step S121 shown in FIG. 24). In this embodiment, a polycarbonate film having a thickness of 100 μm was used as the resin film. Any arbitrary material may be used as the resin film provided that the material is a thermoplastic resin. In this embodiment, the plastic member is manufactured by the insert molding as described later on. Therefore, it is desirable that the material, which is melted or semi-melted during the insert molding, is used as the resin film. As explained in the tenth embodiment, even when the resin film is hardly adhered to the mold surface before the molding, for example, for such a reason that the mold surface shape is bent, then the resin film is melted or semi-melted by bringing the resin film into contact with the charged melted resin upon the insert molding, and thus the mold surface shape can be completely traced by the resin film.

Subsequently, a mixture solution was prepared, which contained the permeative substance and the same resin material as that of the resin film (Step S122 shown in FIG. 24). In this embodiment, carboxylate perfluoropolyether, which was a fluorine compound having the carboxyl group at the terminal, was used as the permeative substance. Pellets of polycarbonate were used as the resin material. Dichloromethane was used as the solvent of the mixture solution. In this embodiment, 10% by weight of the permeative substance (oily fluorine compound) was mixed with the resin material in the solvent in which polycarbonate (resin material) was dissolved to prepare the mixture solution of the polycarbonate and the permeative substance.

Subsequently, the mixture solution was coated on one surface of the resin film by the casting method, and a resin thin film (resin film or membrane) having a thickness of about 0.5 μm, in which the permeative substance was dispersed therein, was formed on the resin film (Step S123 shown in FIG. 24). It is desirable that the resin thin film, in which the permeative substance is dispersed, has a film thickness in a range of 0.01 to 10 μm. When the film thickness is thinner than 0.01 μm, then the film thickness is too thin, and it is difficult to obtain the anchoring effect when the plating film is formed. On the other hand, when the film thickness is thicker than 10 μm (if the film thickness is too thick), it takes a long time to extract the permeative substance, which is uneconomic.

In this embodiment, the plastic sheet, in which the permeative substance was dispersed in the vicinity of the surface, was manufactured as described above. When the plastic sheet is manufactured by using the casting method as described above, then the resin thin film, in which the permeative substance is dispersed, can be made thinner, and it is possible to more easily adjust, for example, the permeation amount and the distribution of the permeative substance.

### Insert Molding

Subsequently, the plastic member was molded by the insert molding in the same manner as in the tenth embodiment by using the plastic sheet manufactured as described above in which the permeative substance was dispersed in the vicinity of the surface. In this embodiment, the same apparatus as that used in the tenth embodiment (with the mold and the injection molding machine shown in FIG. 17) was used for the insert molding.

In this embodiment, at first, the plastic sheet was inserted into the mold. After that, the plastic sheet was pressed against the surface of the movable mold by using a Teflon block (not shown) having the same curved surface as the cavity surface shape of the fixed mold, and the plastic sheet was held while making tight contact with the movable mold (Step S124 shown in FIG. 24). In this procedure, the plastic sheet was held on the movable mold so that the resin thin film, which contained the permeative substance and which was formed on the resin film, was opposed to or facing the movable mold.

Subsequently, the melted resin of ABS-containing polycarbonate resin was injected and charged into the cavity to mold the plastic member (insert molding, Step S125 shown in FIG. 24). After that, the plastic member was taken out from the mold in the same manner as in the tenth embodiment. In this embodiment, the plastic member made of the polycarbonate resin was obtained as described above, in which the plastic sheet having the permeative substance dispersed in the vicinity of the surface and the molding base material composed of the ABS-containing polycarbonate resin were integrated into one body.

### Extraction Method and Extraction Apparatus for Permeative Substance

Subsequently, the permeative substance was extracted from the plastic member molded as described above. In this embodiment, the permeative substance is extracted after the insert molding. However, the permeative substance dispersed on the surface of the plastic sheet may be removed with the solvent before performing the insert molding. However, when the plastic sheet (or the resin thin film) containing the permeative substance is formed of the thermoplastic resin, the plastic sheet is melted and thermally deformed by the melted resin injected and charged during the insert molding. Therefore, when the plastic sheet, from which the permeative substance is previously removed before the insert molding, is used, it is feared that the fine pores brought about after the extraction of the permeative substance may be deformed and/or disappear during the insert molding. Therefore, when the plastic sheet containing the permeative substance is formed of the thermoplastic resin as in this embodiment, it is desirable that the permeative substance is removed after performing the insert molding.

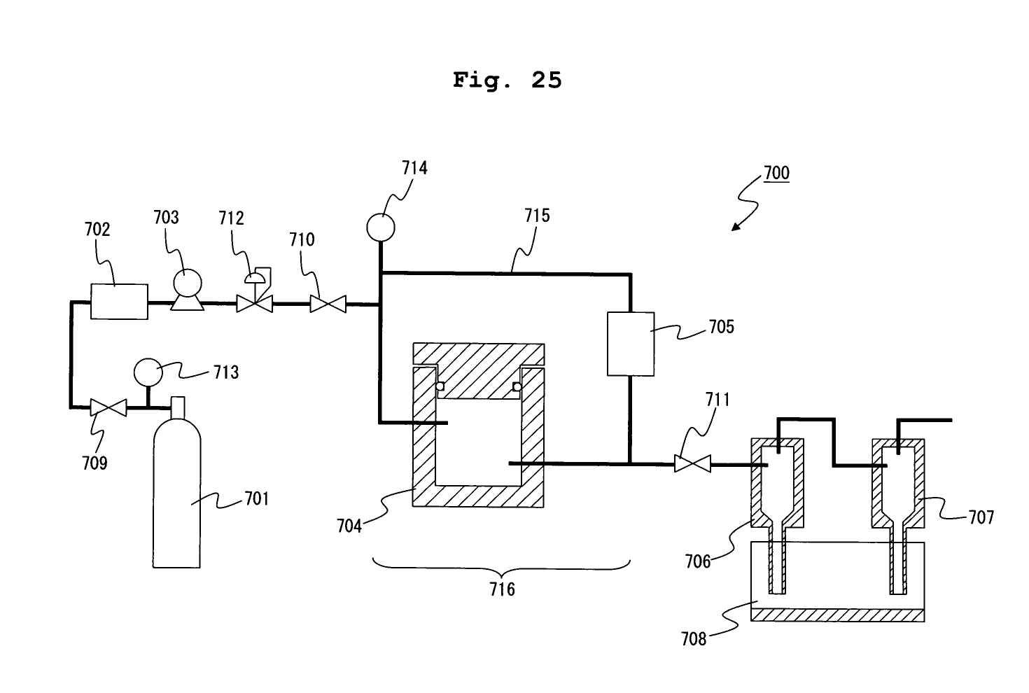

An explanation will now be made about the extraction apparatus for the permeative substance used in this embodiment in order to extract the permeative substance, before explaining the extraction method for the permeative substance. FIG. 25 shows a schematic arrangement view of the extraction apparatus for the permeative substance used in this embodiment.

As shown in FIG. 25, an extraction apparatus 700 for the permeative substance is mainly constructed of a liquid carbon dioxide bomb 701, a buffer tank 702, a high pressure pump 703, a high pressure container 704 for accommodating the plastic member, a circulation pump 705, two recovery tanks 706, 707 recovering the gas discharged, for example, from the high pressure container 704, a recovery tank 708 recovering the permeative substance, and a piping 715 connecting the constitutive components. As shown in FIG. 25, the piping 715 is provided with valves 709 to 711 controlling the flow of the extraction solvent (pressurized carbon dioxide) in the extraction apparatus 700, a pressure-reducing valve 712, and pressure gauges 713, 714 at predetermined positions. In the extraction apparatus 700 of this embodiment, the piping 715 is connected so that the extraction solvent is circulated between the high pressure container 704 and the circulation pump 705 (circulation system 716 shown in FIG. 25).

In this embodiment, the permeative substance, which was dispersed in the surface of the plastic member, was extracted (removed) as follows by using the extraction apparatus 700 shown in FIG. 25. At first, a plurality of plastic members manufactured by the molding method described above were placed in the high pressure container 704.

Subsequently, the internal temperature of the high pressure container 704 was temperature-regulated to 40° C. with unillustrated temperature-regulating water. That is, in this embodiment, the temperature was set to 40° C. when the permeative substance was extracted. When at least one of the materials for forming the plastic member and the plastic sheet is an amorphous thermoplastic resin, it is desirable that the extraction is performed at a temperature lower by at least not less than 20° C. than the glass transition temperature of the amorphous thermoplastic resin, when the permeative substance is dissolved and extracted with the pressurized carbon dioxide as described later on. If the permeative substance is extracted at a temperature higher than the above, it is feared that the plastic member may be deformed, because the amorphous thermoplastic resin swells due to the permeation of the pressurized carbon dioxide. When at least one of the materials for forming the plastic member and the plastic sheet is the amorphous thermoplastic resin, the resin is hardly deformed by the permeation of the pressurized carbon dioxide. However, it is desirable that the permeative substance is extracted at a temperature lower than the melting point of the resin. In any one of the cases described above, it is desirable that the extraction temperature for the permeative substance is not less than 10° C. If the extraction temperature is lower than 10° C., it is feared that the carbon dioxide may be solidified to form dry ice.

In this embodiment, both of the plastic member and the plastic sheet were formed of polycarbonate as the amorphous thermoplastic resin (glass transition temperature was about 145° C. for the both). However, the resin thin film, in which the permeative substance is dispersed, is formed on the surface of the plastic member. Therefore, the glass transition temperature is extremely low at the surface of the plastic member in some cases. However, actually, when the plastic member and the plastic sheet manufactured in this embodiment were exposed to the pressurized carbon dioxide at 40° C. for a predetermined period of time, it was confirmed that the surfaces of the plastic member and the plastic sheet were not deformed.

Subsequently, the liquid carbon dioxide was supplied from the liquid carbon dioxide bomb 701 to the buffer tank 702, and the liquid carbon dioxide was gasified in the buffer tank 702. Subsequently, the pressure of the gasified carbon dioxide was raised by the high pressure pump 703. In this procedure, the pressure was raised so that the pressure of the pressurized carbon dioxide, which was subjected to the pressure control by the pressure-reducing valve 712, was 15 MPa. After that, the valve 710 was opened to introduce the pressurized carbon dioxide into the interior of the high pressure container 704 and the whole of the circulation system 716 communicated with the high pressure container 704. In this situation, the interior of the high pressure container 704 is temperature-regulated to 40° C. Therefore, the pressurized carbon dioxide, which is introduced into the high pressure container 704, is in the supercritical state (supercritical carbon dioxide). In this embodiment, for example, the piping 715 in the circulation system 716 and the circulation pump 705 were at normal temperature without performing the temperature regulation. Therefore, the introduced pressurized carbon dioxide is the pressurized carbon dioxide in the liquid state at the normal temperature portions.

Subsequently, the circulation pump 705 was driven, and the supercritical carbon dioxide and the pressurized carbon dioxide at the normal temperature portions (hereinafter simply referred to as “pressurized carbon dioxide (extraction solvent)” as well) were circulated in the circulation system 716. The circulation state was maintained for 15 minutes. In accordance with this step, the permeative substance, which was dispersed in the vicinity of the surface, of the plastic member, on the side of the plastic sheet, was removed (extracted) by dissolving the permeative substance in the pressurized carbon dioxide (Step S126 shown in FIG. 24).

After the pressurized carbon dioxide was circulated for 15 minutes in the circulation system 716, the valve 711 was opened, and the pressure of the interior of the high pressure container 704 was reduced. The carbon dioxide, which was pressure-reduced and gasified, was discharged to the two recovery tanks 706, 707. The carbon dioxide discharged to the recovery tanks 706, 707, in which the permeative substance is dissolved, is separated into the permeative substance and the carbon dioxide gas in accordance with the principle of centrifugation in the recovery tanks 706, 707. The carbon dioxide gas, which is separated in the recovery tanks 706, 707, is discharged to the outside via the piping 715. The permeative substance is recovered by the recovery tank 708 provided at a position below or under the recovery tanks 706, 707. The permeative substance, which is recovered by the recovery tank 708, is reused in order to prepare the mixture solution with the resin again. In the method for extracting (removing) the permeative substance by using the pressurized carbon dioxide of this embodiment, it is easy to recover and reuse the permeative substance. Therefore, the method is economic.

Subsequently, the plastic member, in which the permeative substance had been extracted from the surface, was taken out from the high pressure container. When the surface state of the obtained plastic member was subjected to the SEM observation, it was confirmed that the fine holes or pores were formed on the surface, of the plastic member, on the side of the plastic sheet, and connection holes or pores in an ant nest state, in which a plurality of holes were connected to one another, were formed in the surface of the plastic member on the side of the plastic sheet. The connection holes had an average pore diameter of about 100 nm.

### Formation of Plating Film

Subsequently, the plating film was formed on the surface of the plastic member manufactured as described above in which the connection holes having the complicated shape were formed. Specifically, the treatments of the conditioning (application of the surfactant), the application of the catalyst, the activation of the catalyst, and the electroless plating were applied to the plastic member in the same manner as in the first embodiment to form the electroless plating film having a thickness of 1 μm on the surface of the plastic member (on the plastic sheet) in which the connection holes were formed (Step S127 shown in FIG. 24). The formed plating film had glossiness. According to this fact, it was revealed that the surface roughness of the plastic member was satisfactory (small) on the side of the plastic sheet.

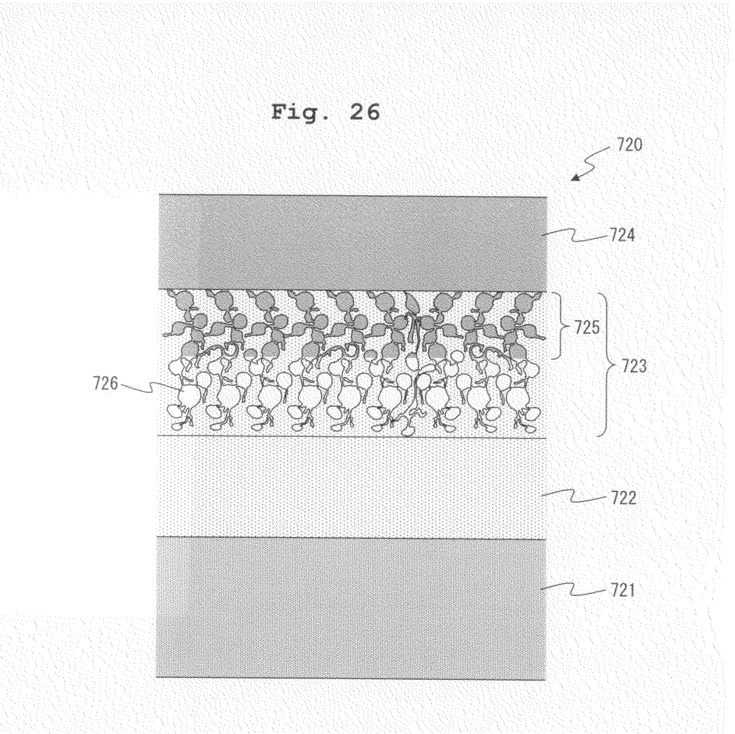

FIG. 26 shows a schematic sectional view of the plastic member in which the plating film was formed on the surface thereof, manufactured in this embodiment. As shown in FIG. 26, a plastic member 720 of this embodiment has such a structure that a resin film 722 of the plastic sheet, a resin thin film 723 from which the permeative substance is removed, and a plating film 724 are stacked in this order on a molding base material 721 molded by the insert molding. The resin film 722 and the molding base material 721 are integrated into one body by the insert molding. The plating film grows while entering parts of connection holes 726 of the resin thin film 723. That is, a plating permeation layer 725, into which parts of the plating film 724 are permeated, is formed in the resin thin film 723. Although not shown in FIG. 26, the catalyst fine particles of Pd which serve as the catalyst cores of the plating film are dispersed at the interior (connection holes) of the plating permeation layer 725 in the plating treatment described above. The plating film glows by using the Pd catalyst fine particles as the cores. Therefore, the plating film 724 formed in this embodiment grows from the interior of the resin thin film 723. When the diameters of the connection holes are minute, the plating film is not permeated into the whole of the resin thin film 723 as shown in FIG. 26. However, the permeation thickness of the plating film can be adjusted by appropriately adjusting the diameters of the connection holes.

As described above, in the plastic member provided with the plating film manufactured in this embodiment, the plating film is formed in such a state that the plating film is partially permeated or impregnated into the plastic member. Therefore, the physical anchoring effect is obtained, and the plating film, which is more excellent in the adhesion performance, is formed. Further, the holes (irregularities), which are formed on the surface of the plastic member, have the extremely small size as well. Therefore, the plating film, which is excellent in the smoothness, is obtained.

An adhesion test was actually performed for the plastic member provided with the plating film manufactured in this embodiment. Specifically, a heat cycle test, which was composed of 20 cycles between temperatures of −40° C. and 85° C., was performed for the plastic member provided with the plating film manufactured in this embodiment. As a result, no film blister appeared on the plating film. According to this fact, it has been revealed that the plating film is adhered to the resin surface by the strong anchoring effect in the plastic member of this embodiment.

In this embodiment, the oily fluorine compound was used as the permeative substance. However, any arbitrary material can be used as the permeative substance provided that the material is dissolvable in the extraction solvent. In particular, when the pressurized carbon dioxide including, for example, the liquid carbon dioxide and the supercritical carbon dioxide, which has the high permeability with respect to the plastic member and which is excellent in the extraction ability, is used as the extraction solvent as in this embodiment, those usable as the permeative substance may include, for example, various surfactants which are dissolvable in the pressurized carbon dioxide, fluorine-based low molecular weight polymers, and inorganic fillers such as calcium carbonate which are dissolvable in acid.

When the pressurized carbon dioxide is used as the extraction solvent, those usable as the permeative substance may include organic substances which are dissolvable in the pressurized carbon dioxide. Those usable as the organic substance as described above may include, for example, block copolymer of polyethylene oxide (PEO)-polypropylene oxide (PPO), block copolymer of PEO-polybutylene oxide (PBO), octaethylene glycol monododecyl ether, and pentaethylene glycol n-octyl ether.

Further, when the pressurized carbon dioxide is used as the extraction solvent, the surfactant containing fluorine, which has the high solubility with respect to the pressurized carbon dioxide, may be also used as the permeative substance. Those usable as the surfactant containing fluorine may include, for example, various types of fluorinated polyalkylene glycol, carboxylate perfluoropolyether (chemical structural formula: F—(CF₂CF(CF₃)O)ₙ—CF₂CF₂COOH (produced by Dupon, trade name: Kritox), perfluoropolyether carboxylic acid ammonium salt (chemical structural formula: F—(CF(CF₃)CF₂O)ₙ—CF(CF₃)COO—NH₄⁺ (produced by DAIKIN, C2404 ammonium salt), perfluoroalkyl analog of sulfosuccinic acid ester salt (AOT), and various surfactants having perfluoropolyether (PFPE) group. Further, for example, a fluorine-based high molecular weight compound (hexafluoropropylene epoxide, produced by Dupon, Kritox GPL207) and silicone oil may be used as the permeative substance.

### Thirteenth Embodiment

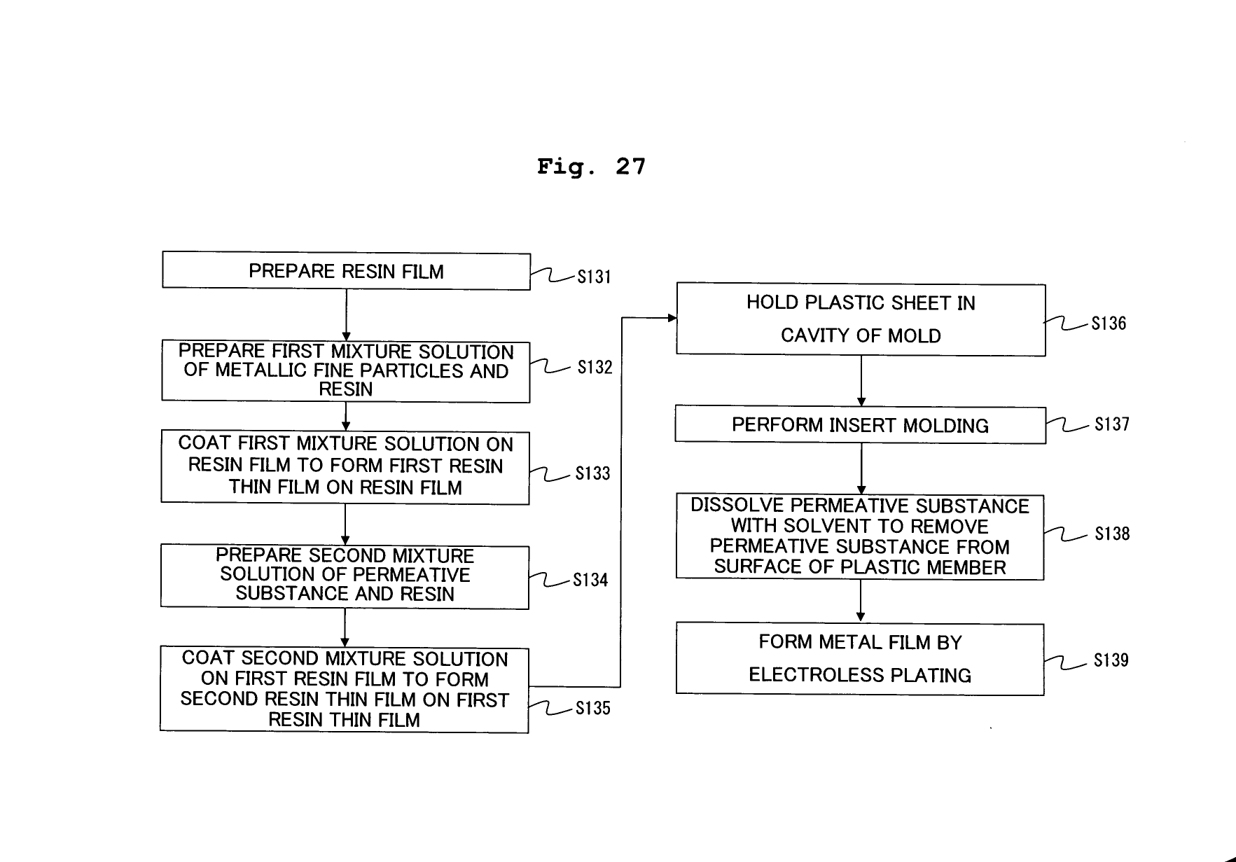

In the twelfth embodiment, the metallic fine particles, which serve as the catalyst cores of the plating film, are dispersed in the plastic sheet (resin thin film) at the stage of the plating treatment. However, the metallic fine particles may be previously dispersed in the plastic sheet. An example thereof will be explained in the thirteenth embodiment. Specifically, a resin thin film (second thin film), in which the plating catalyst cores of palladium were dispersed, was provided below a resin thin film (first resin thin film) in which the permeative substance was dispersed (the connection holes were to be formed). A series of steps ranging from the production of the plastic member to the formation of the plating film in this embodiment will be explained below with reference to FIG. 27.

At first, in the same manner as in the twelfth embodiment, a resin film made of polycarbonate having a thickness of 100 μm was prepared (Step S131 shown in FIG. 27). Subsequently, a mixture solution (first mixture solution) was prepared, which contained the same resin material as that of the resin film and a metal complex (Step S132 shown in FIG. 27). In this embodiment, hexafluoroacetylacetonato palladium (II) complex was used as the metal complex. The same resin material and the same solvent of the mixture solution as those of the twelfth embodiment were used. In this embodiment, the metal complex, which was in an amount of 1% by weight with respect to the resin material, was mixed with the solvent in which the polycarbonate (resin material) was dissolved to prepare the first mixture solution of the polycarbonate and the metal complex. In this embodiment, Pd was used as the metal element of the metallic fine particles to serve as the plating catalyst cores. However, other than the above, it is possible to use, for example, platinum, nickel, and copper.

Subsequently, the first mixture solution was coated on one surface of the resin film by the casting method, and the first resin thin film (first resin film or membrane) having a thickness of about 0.5 μm, in which the metal complex was dispersed therein, was formed (Step S133 shown in FIG. 27).

Subsequently, a mixture solution (second mixture solution) was prepared, which contained the same resin material as that of the resin film and the permeative substance in the same manner as in the twelfth embodiment (Step S134 shown in FIG. 27). In this embodiment, the permeative substance, the resin material, and the solvent of the mixture solution, which were the same as those of the twelfth embodiment, were used. Subsequently, the second mixture solution was coated on the first resin thin film by the casting method, and the second resin thin film (second resin film or membrane) having a thickness of about 1 μm, in which the permeative substance was dispersed therein, was formed (Step S135 shown in FIG. 27).

Subsequently, the plastic sheet, in which the first and second resin thin films were formed on the resin film, was heated for 5 hours in a temperature environment of 100° C. In accordance with this treatment, a part of the metal complex distributed in the first resin thin film was thermally decomposed and reduced, which was fixed or immobilized (part of the metal complex was converted into the metallic fine particles). In this embodiment, the plastic sheet, in which the permeative substance and the metallic fine particles were dispersed therein, was manufactured as described above.

Subsequently, the plastic sheet obtained as described above was held in the mold of the injection molding machine in the same manner as in the twelfth embodiment to perform the insert molding (Steps S136 and S137 shown in FIG. 27). The resin used in this embodiment (material for forming the molding base material), which was injected and charged into the mold in the insert molding, was the same as that used in the twelfth embodiment. In this embodiment, the plastic member was molded as described above.

Subsequently, the permeative substance was extracted from the plastic member with the pressurized carbon dioxide (solvent) in accordance with the same method as that used in the twelfth embodiment by using the extraction apparatus used in the twelfth embodiment (FIG. 25) for the plastic member manufactured as described above (Step S138 shown in FIG. 27). In accordance with this treatment, the connection holes were formed in the first resin thin film. Subsequently, the electroless plating of nickel-phosphorus plating was applied to the plastic member to form the plating film on the surface, of the plastic member, on the side of the plastic sheet. During this process, the plating solution is permeated into the first resin thin film via the connection holes formed in the first resin thin film, and the plating solution arrives at the second resin thin film. The plating solution makes contact with the metallic fine particles of Pd dispersed in the second resin thin film, and the plating film grows by using the metallic fine particles as the cores. Therefore, in the method for forming the plating film of this embodiment, the plating film grows from the inside of the plastic sheet, more specifically, from the vicinity of the interface between the first and second resin thin films. Therefore, the greater anchoring effect is obtained, and the adhesion performance is further enhanced between the plastic member and the plating film. In this embodiment, the plastic member, in which the plating film was formed on the surface thereof, was obtained as described above.

In the method for forming the plating film of this embodiment, it is unnecessary to perform the catalyst-applying step after the insert molding as performed in the twelfth embodiment. Therefore, in the method of this embodiment, the plating film can be immediately formed after forming the first resin thin film having the connection holes (after extracting the permeative substance). Therefore, the process can be simplified, and the mass productivity is improved.

In the case of the plastic member (plastic sheet) manufactured by the production method of this embodiment, the concentration or density of the catalyst cores is lowered at the outermost surface, of the plastic member, on the side of the plastic sheet (on the outermost surface of the first resin thin film in which the connection holes are formed), and the catalyst cores are dispersed in the sufficient amount at the inside. Therefore, when the plating treatment is performed, then the plating film hardly grows at the outermost surface of the plastic member on the side of the plastic sheet, and the plating film is successfully allowed to grow reliably from the inside of the plastic member. In the production method of this embodiment, a gradient layer (plating film permeation layer), in which the resin and the plating metal film exist in the mixed manner, can be reliably formed. It is possible to efficiently form the plating film which is excellent in the adhesion performance. Further, in the method for producing the plastic member of this embodiment, for example, even when the Cu plating, in which the reaction is caused at a low temperature approximate to room temperature, is applied, then the plating reaction is not caused on the surface, and the plating film is successfully allowed to grow from the inside of the plastic member, because the concentration of the catalyst cores is low at the outermost surface of the plastic member on the side of the plastic sheet.

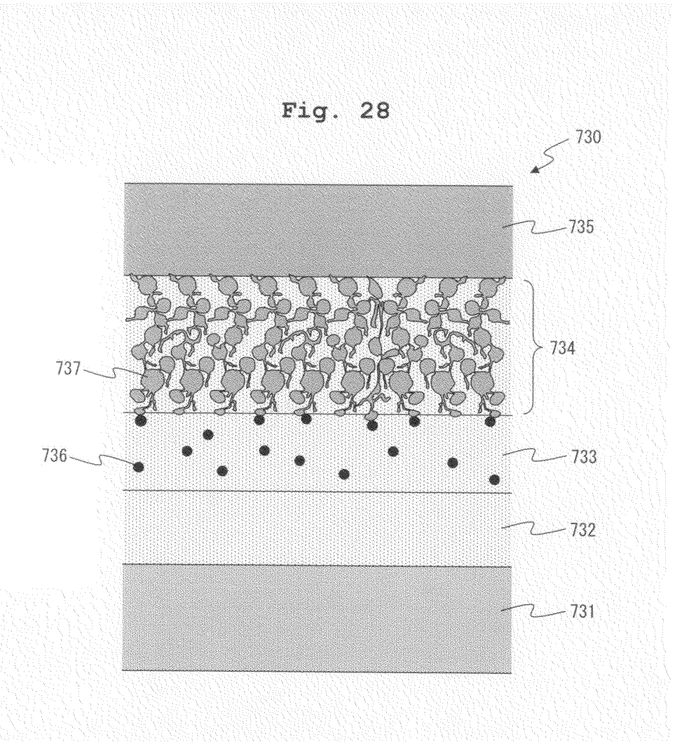

FIG. 28 shows a schematic sectional view of the plastic member in which the plating film is formed on the surface as manufactured in this embodiment. As shown in FIG. 28, a plastic member 730 of this embodiment has such a structure that a resin film 732 of the plastic sheet, a second resin thin film 733 in which metallic fine particles 736 are dispersed, a first resin thin film 734 from which the permeative substance is removed and connection holes 737 are formed therein, and a plating film 735 are stacked in this order on a molding base material 731 molded by the insert molding. The resin film 732 and the molding base material 731 are integrated into one body by the insert molding. The plating film 735 grows via the connection holes 736 of the first resin thin film 734 from the metallic fine particles 736 existing in the vicinity of a surface, of second resin thin film 733, on the side of the first resin thin film 734. In this state, the plating film 735 is partially permeated into the plastic member. Therefore, in this embodiment, the thickness of the plating film permeation layer is approximately the same as the thickness of the first resin thin film 734.

The reliability of the plating film was evaluated for the plastic member provided with the plating film manufactured as described above, in the same manner as in the twelfth embodiment. As a result, any problem was not caused, which would be otherwise caused, for example, such that the plating film would cause any blister.

### Fourteenth Embodiment

In the thirteenth embodiment, the step of extracting the permeative substance and the permeation of the plating solution into the plastic member are the distinct steps to be performed. However, these steps may be performed simultaneously. In the fourteenth embodiment, an explanation will be made about an example of such a procedure.

In this embodiment, at first, the plastic sheet was manufactured, wherein the second resin film in which the metallic fine particles were dispersed and the first resin film in which the permeative substance was dispersed were formed on the resin film in the same manner as in the thirteenth embodiment. Subsequently, the plastic sheet was held in the mold to perform the insert molding in the same manner as in the twelfth embodiment, and the plastic sheet and the molding base material were integrated into one body to manufacture the plastic member.

Subsequently, the steps of extracting the permeative substance and forming the plating film were performed as follows by using the extraction apparatus used in the twelfth embodiment (FIG. 25). At first, the plastic member, which was manufactured as described above, was installed in the high pressure container 704 which was temperature-regulated at 40° C. Simultaneously, a nickel-phosphorus plating solution, which was mixed with methanol (alcohol) at a ratio of 40% by volume, was introduced into the high pressure container 704, and the plastic member was immersed in the plating solution. Subsequently, the pressurized carbon dioxide having a pressure of 10 MPa was introduced into the high pressure container 704, and the pressurized carbon dioxide was allows to remain therein in the same manner as in the twelfth embodiment. In accordance with this step, the plating solution is permeated into the plastic member together with the pressurized carbon dioxide. During this process, the mixture solution of the plating solution and the pressurized carbon dioxide is permeated into the plastic member while extracting the permeative substance in the first resin thin film. The reaction temperature of the plating solution used in this embodiment is not less than 65° C. Therefore, the plating reaction is not caused in the step performed in the high pressure container 704 temperature-regulated at 40° C.

Subsequently, the temperature of the high pressure container 704 was raised to 80° C. (temperature to cause the plating reaction) by unillustrated temperature-regulating water. As a result, the pressure of the high pressure container 704 was raised to 15 MPa. In accordance with this step, the plating solution was brought into contact with the metallic fine particles originating from Pd dispersed in the second resin thin film, and the plating film was allowed to glow from the inside of the plastic member. In this embodiment, the plating film was formed on the surface of the plastic member on the side of the plastic sheet as described above. As a result, the plastic member, which had the same or equivalent structure (FIG. 28) as that of the twelfth embodiment, was also obtained in this embodiment. The plating film grows from the inside of the plastic member. More specifically, the plating film grows from the vicinity of the interface between the first and second resin thin films. The plating film, which was excellent in the adhesion performance, was successfully formed.

The reliability of the plating film was also evaluated for the plastic member provided with the plating film manufactured in this embodiment, in the same manner as in the twelfth embodiment. As a result, any problem such as the blister of the plating film was not caused.

When the pressurized carbon dioxide, which is, for example, in the supercritical state, is mixed with the plating solution as in this embodiment, then the surface tension of the plating solution is lowered, and the plating solution is easily permeated into the plastic member. Therefore, the plating solution is also easily permeated into the first resin thin film in which the fine connection holes are formed. The plating solution more easily arrives at the second resin thin film in which the metallic catalyst fine particles are dispersed. As a result, the plating film quickly grows from the second resin thin film. Therefore, the plating velocity is raised, which is highly efficient.

When the pressurized carbon dioxide, which is, for example, in the supercritical state, is mixed with the plating solution as in this embodiment, pH (hydrogen ion exponent) of the plating solution is lowered by the carbon dioxide. Therefore, when the plating solution is an alkali plating bath, it is feared that the plating solution may be neutralized, and the plating reaction may not be caused. Therefore, when the pressurized carbon dioxide is mixed with the plating solution as in this embodiment, it is desirable that an acidic plating bath of, for example, palladium or nickel-phosphorus is used as the plating solution.

When the pressurized carbon dioxide, which is, for example, in the supercritical state, is mixed with the plating solution, it is desirable that the alcohol component is added to the plating solution as in this embodiment. In this case, alcohol plays a role of the surfactant to enhance the mixing performance between the plating solution and the carbon dioxide, and to lower the surface tension of the plating solution so that the plating solution is easily permeated into the resin.

### Fifteenth Embodiment

The twelfth to fourteenth embodiments are illustrative of the case in which the permeative substance is extracted after the insert molding to form the fine connection holes on the surface of the plastic member. However, in the fifteenth embodiment, an explanation will be made about an example in which the permeative substance is extracted before the insert molding to form the fine connection holes. When the material for forming the resin thin film in which the permeative substance is to be dispersed is formed of a material which is hardly deformed thermally, the extraction treatment for the permeative substance can be performed before the insert molding.

In the thirteenth and fourteenth embodiments, the resin thin film in which the permeative substance was dispersed and the resin thin film in which the metallic fine particles were dispersed were formed distinctly. However, in this embodiment, an explanation will be made about an example in which the permeative substance and the metallic fine particles are dispersed in one resin thin film.

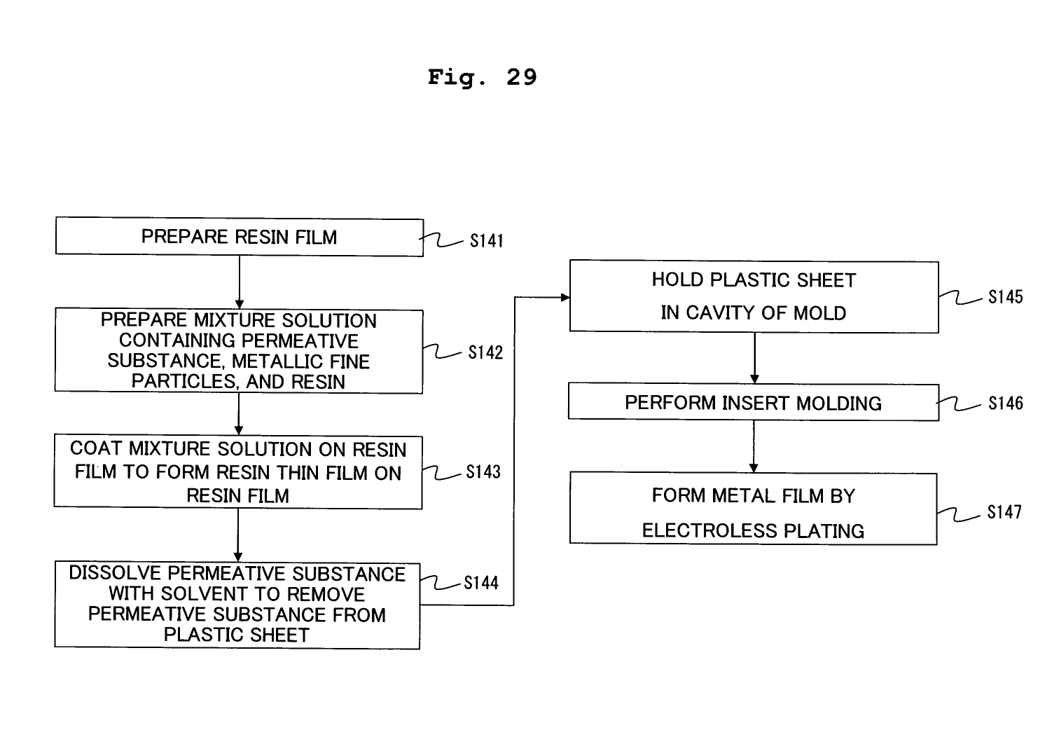

In this embodiment, an epoxy thermosetting resin of two-liquid curing type, which is a highly heat resistant resin material, was used as the material for forming the resin thin film in which the permeative substance and the metallic fine particles were to be dispersed. Liquid polyethylene glycol having an average molecular weight of 200 was used as the permeative substance. Hexafluoroacetylacetonato palladium (II) complex was used as the metal complex to be mixed with the resin material and the permeative substance, in the same manner as in the thirteenth embodiment. An explanation will be made below with reference to FIG. 29 about the method for producing the plastic member of this embodiment.

At first, a lengthy resin film made of polycarbonate having a thickness of 100 μm was prepared (Step S141 shown in FIG. 29). Subsequently, a mixture solution containing the permeative substance, the metal complex, and the epoxy thermosetting resin was prepared (Step S142 shown in FIG. 29). Specifically, the polyethylene glycol (permeative substance) was mixed at a ratio of 30% by weight with respect to the epoxy resin adhesive. Further, the epoxy resin adhesive, with which the palladium metal complex was mixed at a ratio of 1% by weight, was dissolved in a mixed solvent of N-Methyl-2-pyrrolidone and toluene as the solvent thereof to prepare a mixture solution containing the permeative substance, the metal complex, and the epoxy thermosetting resin.

Subsequently, the mixture solution was coated on the resin film by the casting method to form a resin thin film having a thickness of 1 μm in which the permeative substance and the metal complex were dispersed at the inside of the resin film (Step S143 shown in FIG. 29). Subsequently, the resin film was heated for 10 hours at a temperature of 120° C. to thermally cure the epoxy resin adhesive. In accordance with the heating treatment, the metal complex was thermally decomposed and reduced, and the catalyst cores of the plating were fixed or immobilized. In this way, the lengthy plastic sheet was manufactured, in which the permeative substance and the metallic fine particles were dispersed in the highly heat resistant resin thin film.

Subsequently, the lengthy plastic sheet was wound while interposing an aluminum mesh sheet as a separator, which was charged into the high pressure container 704 of the extraction apparatus 700 shown in FIG. 25. Subsequently, in the same manner as in the twelfth and thirteenth embodiments, the pressurized carbon dioxide was introduced into the high pressure container 704, and the permeative substance was extracted (Step S144 shown in FIG. 29). In accordance with this step, the connection holes were formed over a thickness of about 1 μm of the resin thin film made of the epoxy resin formed on one side surface of the plastic sheet.

Subsequently, the plastic sheet, in which the connection holes were formed on the surface, was held in the mold in the same manner as in the twelfth embodiment to perform the insert molding (inject and charge the polycarbonate resin), and thus the plastic member was molded (Steps S145 and S146 shown in FIG. 29). During this process, the fine connection holes formed in the resin thin film are neither thermally deformed nor closed by the temperature and the pressure of the injected and charged melted resin, because the resin thin film of the plastic sheet is formed of the highly heat resistant material in this embodiment. In this embodiment, the plastic member, in which the fine connection holes were formed in the vicinity of the surface, was manufactured as described above.

Subsequently, the electroless plating film was formed on the surface, of the plastic member, on the side of the plastic sheet manufactured as described above by using the pressurized carbon dioxide in the same manner as in the fourteenth embodiment (Step S147 shown in FIG. 29). In this embodiment, the permeative substance is extracted before the insert molding. Therefore, the process for forming the plating film does not include the step of extracting the permeative substance. In this embodiment, the plastic member provided with the plating film was obtained as described above.

The adhesion performance of the plating film was also investigated for the plastic member manufactured in this embodiment. As a result, the satisfactory adhesion performance was obtained. That is, the following fact has been revealed. When the resin thin film, in which the connection holes are formed, is formed of the highly heat resistant material as in this embodiment, even when the permeative substance is extracted to form the connection holes before the insert molding, then the connection holes are hardly deformed during the insert molding, and the anchoring effect can be obtained to obtain the adhesion performance between the plastic member and the plating film.

Further, the following advantage is also obtained by the method for extracting the permeative substance before the insert molding as performed in this embodiment. When the permeative substance is removed by using the pressurized carbon dioxide in the supercritical state or the like after the insert molding as performed in the twelfth and thirteenth embodiments, it is necessary that the molded article itself should be inserted into the high pressure container. Therefore, the number of the molded articles capable of being processed at once is limited. Further, when the molded article having a large size is processed, then the processing is difficult, and it is necessary to increase the internal volume of the high pressure container, which is expensive. On the contrary, when the permeative substance is removed in the film-like form (in the state of the plastic sheet) before the insert molding as performed in this embodiment, then the number of the plastic sheets to be processed at once is increased, and the foregoing problem is solved. In particular, when the pressurized carbon dioxide in the supercritical state or the like is used as the solvent to remove the permeative substance as in this embodiment, the lengthy plastic sheet can be collectively processed even in the rolled state, because the pressurized carbon dioxide is excellent in the diffusibility and the permeability. It is possible to process the large areal size. Therefore, it is possible to provide the process which is excellent in the throughput and the cost.

In this embodiment, the epoxy thermosetting type resin was used as the material for forming the resin thin film for internally forming the connection holes. However, any arbitrary material may be used as the material for forming the resin thin film provided that the material is not greatly deformed plastically by the application of the heat and the load during the insert molding. It is desirable that the material has the heat resistance against at least not less than 100° C., more desirably not less than 150° C., and much more desirably not less than 200° C. (deflection temperature under load). It is possible to use, for example, photo-curable resin such as epoxy, thermosetting resin such as polyimide and silicone, and thermoplastic resin such as polyetherimide, polyamideimide, polyphenylene sulfide, polybutylene terephthalate, and polyphthalamide.

It is preferable to use the material in which the adhesion surface of the resin film with respect to the molding melted resin or the resin film itself is melted or semimelted during the insert molding as the material for forming the resin film of the plastic sheet in order that the adhesion performance with respect to the injection molding melted resin composed of the thermoplastic resin is improved and the complicated surface shape of the mold is traced. Specifically, it is desirable to use the thermoplastic resin. Even when the resin thin film, which is formed on the resin film, is a film which is hardly thermally deformed, the mold shape can be traced during the molding by thinning the resin thin film.

In this embodiment, the thin film made of the highly heat resistant resin was formed, which had the connection holes on the surface on one side of the resin film. However, the thin films made of the highly heat resistant resin may be formed on the both surfaces of the resin film. When the resin thin film, which has the connection holes hardly deformed plastically even when the resin thin film is exposed to the high temperature and the high pressure, is provided at the adhesion surface of the resin film with respect to the insert molding resin material, then the melted resin is charged via the connection holes into the thin film made of the highly heat resistant resin during the insert molding, and the adhesion performance can be secured between the resin film and the molding base material.

According to the surface modification method of the present invention, the fine irregularities of an order of submicron to nanometer can be formed on the surface of the plastic member by using the pressurized fluid for various types of plastics. Therefore, for example, when the surface modification method of the present invention is used as the pretreatment process for the electroless plating, the method is suitable as a clean pretreatment process for the electroless plating in which the cost is low.

According to the method for forming the metal film of the present invention, the metal film, which is excellent in the smoothness and the adhesion performance, can be formed on the surfaces of various types of plastic members without using any harmful etchant unlike the conventional plating method. Therefore, the method for forming the metal film of the present invention is suitable as the clean method for forming the metal film in which the cost is low and which is applicable to all of the fields. Further, the method for forming the metal film of the present invention is also easily applicable to a molded article having a large areal size and a complicated shape.

According to the surface modification method of the present invention and the method for forming the plastic member, the fine pores or holes can be formed on the surface of the plastic member. Therefore, these methods can be used for the following ways of use. For example, a biodegradable plastic such as polylactic acid is used for the material for the plastic member, the methods can be applied to provide a regenerative medical device in which cells are cultivated in fine pores. When the size of the fine pore is not more than about 100 nm which is sufficiently smaller than the wavelength of the visible light, it is possible to reduce the refractive index of the molded article surface by increasing the porosity. Further, when the gradient is provided for the porosity distribution from the surface to the inside of the plastic member, it is possible to suppress the surface reflectance. In this case, it is necessary that the porosity of the surface needs be increased as compared with that inside of the plastic member. However, in the method for removing the permeative substance of the surface modification method of the present invention, a larger amount of the low molecular weight component is extracted (removed) at positions located nearer to the surface. Therefore, it is possible to more easily control the gradient of the porosity distribution ranging from the surface to the inside of the plastic member.

What is claimed is:

1. A surface modification method for modifying a surface of a plastic member, comprising:
permeating a permeative substance into the surface of the plastic member by using a pressurized fluid; and
bringing a solvent into contact with the plastic member so that the permeative substance is dissolved in the solvent to remove the permeative substance from the surface of the plastic member.

2. The surface modification method according to claim 1, wherein the permeation of the permeative substance into the surface of the plastic member by using the pressurized fluid includes:
dissolving the permeative substance in the pressurized fluid; and
bringing the pressurized fluid, in which the permeative substance is dissolved, into contact with the plastic member to permeate the permeative substance into the surface of the plastic member.

3. The surface modification method according to claim 1, wherein the permeation of the permeative substance into the surface of the plastic member by using the pressurized fluid includes:
coating, on the surface of the plastic member, a solution in which the permeative substance is dissolved; and
bringing the pressurized fluid into contact with the plastic member, on which the permeative substance is coated, to permeate the permeative substance into the surface of the plastic member.

4. The surface modification method according to claim 2, wherein the plastic member has a recess; and when the permeative substance is permeated into the surface of the plastic member, the pressurized fluid is made to remain in the recess by closing an opening defined on the surface of the plastic member by the recess in a state in which the pressurized fluid is brought into contact with the plastic member to permeate the permeative substance into a surface defining the recess of the plastic member.

5. The surface modification method according to claim 1, wherein the surface modification method is a surface modification method using an injection molding machine provided with a mold and a heating cylinder which injects a melted resin of the plastic member into the mold; and
the permeation of the permeative substance into the surface of the plastic member by using the pressurized fluid includes: introducing the pressurized fluid, in which the permeative substance is dissolved, into a flow front portion of the melted resin in the heating cylinder; and injecting and charging the melted resin into a cavity of the mold.

6. The surface modification method according to claim 5, wherein a concave/convex pattern is formed on a surface, of the mold, on a side of the cavity;
the melted resin is injected and charged into the cavity of the mold to form the plastic member which has a recess on the surface and in which the permeative substance is permeated into a surface of the recess; and
when the permeative substance is dissolved in the solvent to remove the permeative substance from the surface of the plastic member, the solvent is brought into contact with only the surface of the recess to remove the permeative substance which is permeated into the recess.

7. The surface modification method according to claim 1, wherein the surface modification method is a surface modification method using an extrusion molding machine; and
the permeation of the permeative substance into the surface of the plastic member by using the pressurized fluid includes: bringing the pressurized fluid, in which the permeative substance is dissolved, into contact with a melted resin of the plastic member in the extrusion molding machine to permeate the permeative substance into the melted resin; and extrusion-molding the melted resin.

8. The surface modification method according to claim 1, wherein the pressurized fluid has a pressure in a range of 5 to 25 MPa.

9. The surface modification method according to claim 1, wherein the pressurized fluid is carbon dioxide.

10. The surface modification method according to claim 1, wherein the plastic member is formed of one of a thermoplastic resin, a thermosetting resin, and a photo-curable resin.

11. The surface modification method according to claim 1, wherein the permeative substance is a water-soluble polymer or a water-soluble monomer.

12. The surface modification method according to claim 1, wherein the permeative substance is polyethylene glycol.

13. The surface modification method according to claim 1, wherein the permeative substance has a molecular weight in a range of 50 to 2,000.

14. The surface modification method according to claim 1, wherein the permeative substance includes a first permeative substance and a second permeative substance, and the first permeative substance is removed when the permeative substance is removed from the surface of the plastic member.

15. A method for forming a metal film on a surface of a plastic member, comprising:
preparing a plastic member in which a permeative substance is impregnated into a surface thereof;
bringing a solvent into contact with the plastic member so that the permeative substance is dissolved in the solvent to remove the permeative substance from the surface of the plastic member; and
forming the metal film on the surface of the plastic member from which the permeative substance is removed.

16. The method for forming the metal film according to claim 15, wherein the formation of the metal film on the surface of the plastic member from which the permeative substance is removed includes:
applying plating catalyst cores to the surface of the plastic member from which the permeative substance is removed; and
forming, by an electroless plating method, the metal film on the surface of the plastic member to which the plating catalyst cores are applied.

17. The method for forming the metal film according to claim 15, wherein the preparation of the plastic member in which the permeative substance is impregnated into the surface thereof includes permeating the permeative substance into the surface of the plastic member by using a pressurized fluid.

18. The method for forming the metal film according to claim 15, wherein the plastic member, in which the permeative substance is impregnated into the surface thereof, is manufactured by using an injection molding machine provided with a mold; and
the preparation of the plastic member in which the permeative substance is impregnated into the surface thereof includes: preparing a plastic sheet in which the permeative substance is impregnated into a surface thereof; holding the plastic sheet in the mold of the injection molding machine; and injecting and charging a melted resin in the injection molding machine into the mold, in which the plastic sheet is held, to mold the plastic member.

19. The method for forming the metal film according to claim 18, wherein the plastic sheet is manufactured by using an extrusion molding machine; and
the preparation of the plastic sheet in which the permeative substance is impregnated into the surface thereof includes: bringing a pressurized fluid, in which the permeative substance is dissolved, into contact with a melted resin in the extrusion molding machine to permeate the permeative substance into the melted resin; and extrusion-molding the melted resin to mold the plastic sheet.

20. The method for forming the metal film according to claim 18, wherein the preparation of the plastic sheet in which the permeative substance is impregnated into the surface thereof includes:
preparing a plastic film;
preparing a mixture solution containing the permeative substance and a plastic resin; and
coating the mixture solution on the plastic film to form, on the plastic film, a resin film in which the permeative substance is dispersed.

21. The method for forming the metal film according to claim 15, wherein the plastic member, in which the permeative substance is impregnated into the surface thereof, is manufactured by using an injection molding machine provided with a mold; and
the preparation of the plastic member in which the permeative substance is impregnated into the surface thereof includes:
preparing a plastic film;
preparing a first mixture solution containing metallic fine particles and a first plastic resin;
preparing a second mixture solution containing the permeative substance and a second plastic resin;
coating the first mixture solution on the plastic film to form on the plastic film a first resin film in which the metallic fine particles are dispersed;
coating the second mixture solution on the first resin film to form on the first resin film a second resin film in which the permeative substance is dispersed;
holding, in the mold of the injection molding machine, the plastic film in which the first and second resin films are formed; and
injecting and charging a melted resin in the injection molding machine into the mold, in which the plastic film is held, to mold the plastic member.

22. The method for forming the metal film according to claim 15, wherein the preparation of the plastic member in which the permeative substance is impregnated into the surface thereof includes: preparing a plastic film; preparing a mixture solution containing the permeative substance, metallic fine particles, and a plastic resin; and coating the mixture solution on the plastic film to form on the plastic film a resin film in which the permeative substance and the metallic fine particles are dispersed; and
the method for forming the metal film is a method for forming the metal film using an injection molding machine provided with a mold, the method for forming the metal film further including, after removing the permeative substance, holding, in the mold of the injection molding machine, the plastic film on which the resin film is formed; and injecting and charging a melted resin in the injection molding machine into the mold, in which the plastic film is held, to mold the plastic member.

23. The method for forming the metal film according to claim 15, wherein the method for forming the metal film is a method for forming the metal film using an injection molding machine provided with a mold and first and second heating cylinders which inject a melted resin of the plastic member into the mold; and
the preparation of the plastic member in which the permeative substance is impregnated into the surface thereof includes: preparing a first plastic resin which contains the permeative substance and a second plastic resin which does not contain the permeative substance; plasticizing and melting the first plastic resin in the first heating cylinder; plasticizing and melting the second plastic resin in the second heating cylinder; injecting the melted first plastic resin into the mold; and injecting and charging the melted second plastic resin into the mold to mold the plastic member, after injecting the first plastic resin.

24. The method for forming the metal film according to claim 15, wherein the permeative substance includes a first permeative substance and a second permeative substance, and the first permeative substance is removed when the permeative substance is removed from the surface of the plastic member.

25. The method for forming the metal film according to claim 24, wherein the first permeative substance is a water-soluble polymer or a water-soluble monomer.

26. The method for forming the metal film according to claim 24, wherein the first permeative substance has a molecular weight in a range of 50 to 2,000.

27. A method for producing a plastic member, comprising:
preparing a plastic member in which a permeative substance is impregnated into a surface thereof; and
bringing a solvent into contact with the plastic member so that the permeative substance is dissolved in the solvent to remove the permeative substance from the surface of the plastic member.
